(19) United States
(12) Patent Application Publication
(10) Pub. No.: US 2016/0284151 A1
(43) Pub. Date: Sep. 29, 2016

(54) COIN-ROLL EJECTING DEVICE AND MONEY CHANGER

(71) Applicant: GLORY LTD., Himeji-shi (JP)

(72) Inventors: Takashi FUJIMURA, Kakogawa-shi (JP); Keiji NAGASAKA, Himeji-shi (JP); Youhei KAMADA, Himeji-shi (JP); Hisayuki UTSUMI, Himeji-shi (JP); Yasushi YOKOTA, Himeji-shi (JP); Jason Ammar NADER, Himeji-shi (JP); Wataru IHARA, Himeji-shi (JP)

(73) Assignee: GLORY LTD., Himeji-shi (JP)

(21) Appl. No.: 15/172,220

(22) Filed: Jun. 3, 2016

Related U.S. Application Data
(63) Continuation of application No. PCT/JP2014/081828, filed on Dec. 2, 2014.

(30) Foreign Application Priority Data
Dec. 4, 2013 (JP) 2013-250972
Dec. 4, 2013 (JP) 2013-250973
Apr. 28, 2014 (JP) 2014-092407

(51) Int. Cl. G07D 1/00; G07D 1/04

(52) U.S. Cl. CPC G07D 1/00; G07D 1/04

(57) ABSTRACT

An ejecting mechanism (319) included in a coin-roll ejecting device (300) includes a rotating member (320, 360) that rotates around a rotation axis that extends horizontally and orthogonally to a direction of inclination of a storing unit (310) and has at least two notches (324, 364) each receiving one roll of coins stored in the storing unit (310), a driving unit (321) that rotates the rotating member (320, 360) around the rotation axis, and a rotating position detecting unit (350) that detects a rotating position of the rotating member (320, 360).

### CROSS-REFERENCE TO RELATED APPLICATIONS

This application is a continuation of International Patent Application No. PCT/JP2014/081828 filed on Dec. 2, 2014, which claims the benefit of JP2013-250972 filed on Dec. 4, 2013; JP2013-250973 filed on Dec. 4, 2013; and JP2014-092407 filed on Apr. 28, 2014, the entire contents of which are incorporated herein by reference.

### BACKGROUND OF THE INVENTION

1. Field of the Invention

The present invention relates to a coin-roll ejecting device capable of ejecting a roll of coins stored inside a body thereof to the outside of the body and a money changer for performing a money change process.

2. Description of the Related Art

Various types of coin-roll ejecting devices that can eject a roll of coins stored inside a body thereof to the outside of the body are known in the art. Such coin-roll ejecting devices are disclosed, for example, in Japanese Patent No. 3857001, Japanese Patent Application Laid-Open No. 2002-109607, U.S. Pat. No. 7,111,754, U.S. Pat. No. 7,571,833, and the like.

### SUMMARY OF THE INVENTION

The coin-roll ejecting device disclosed in Japanese Patent No. 3857001 has a problem that, because the rolls of coins are aligned in a row in each of a plurality of storing units that are arranged one above the other in a vertical direction, only a small number of the rolls of coins can be stored in the storing units, moreover, a replenishment work of replenishing rolls of coins into the storing units takes time. The coin-roll ejecting device disclosed in Japanese Patent Application Laid-Open No. 2002-109607 has a problem that, because a coin-roll refilling unit is attached to the back of the device body, the depth of the coin-roll ejecting device is increased, and, a replenishment work of replenishing the roll of coins is difficult. Moreover, in the coin-roll ejecting devices disclosed in Japanese Patent No. 3857001 and Japanese Patent Application Laid-Open No. 2002-109607, because a lifting unit that can freely move up and down is arranged with respect to the storing units, and an ejecting lever for withdrawing the roll of coins from the storing units is arranged in the lifting unit, to increase the capacity of storing the rolls of coins of the entire device, it is necessary to decrease the distance between the storing units that are arranged one above the other in the vertical direction. If the distance between the storing units is decreased, it is necessary to move the storing unit that stores therein the rolls of coins that are not ejection objects to avoid a situation in which the ejecting lever interferes with the rolls of coins that are not the ejection objects. When this configuration is adopted, the production costs of the device disadvantageously increases, and the speed of ejecting the rolls of coins from the storing unit decreases. Moreover, in such coin-roll ejecting devices, the roll of coins may not be surely ejected from the storing unit by the ejecting lever depending on the diameter and the length of the roll of coins.

Moreover, in the coin-roll ejecting devices disclosed in U.S. Pat. No. 7,111,754 and U.S. Pat. No. 7,571,833, the capacity of storing the rolls of coins is large; however, downsizing of the device is difficult. Also, handling of the rolls of coins may become difficult when the diameter and the length of the roll of coins changes when the denomination of the roll of coins to be stored is changed. Furthermore, in such coin-roll ejecting devices, there is a problem that the replenishment work of the roll of coins is difficult. As in the coin-roll ejecting device disclosed in U.S. Pat. No. 7,111,754, when a rotating member having one or more notches for receiving the rolls of coins formed in an outer peripheral surface thereof is used as an ejecting mechanism for ejecting the roll of coins from the storing unit, when rolls of coins of a predetermined number are ejected by the rotating member from the storing unit, some rolls of coins may disadvantageously remain in the notches of the rotating member.

The present invention was made in view of the above discussion. One object of the present invention is to provide a coin-roll ejecting device in which a rotating position detecting unit that detects a rotating position of a rotating member is provided, and when a roll of coins remains in a notch of the rotating member when the predetermined number of the rolls of coins are ejected by the rotating member from a storing unit, the roll of coins in the notch of the rotating member can be returned to the storing unit by rotating the rotating member by a driving unit based on the rotating position of the rotating member detected by the rotating position detecting unit.

A coin-roll ejecting device of the present invention includes a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; a first detecting unit that detects the roll of coins ejected from the storing unit; and a controlling unit that controls the ejecting mechanism, and the ejecting mechanism includes a rotating member that rotates around a rotation axis that extends horizontally and orthogonally to the direction of inclination of the storing unit and has at least two notches each receiving one roll of coins stored in the storing unit, a driving unit that rotates the rotating member around the rotation axis, and a rotating position detecting unit that detects a rotating position of the rotating member.

In the above coin-roll ejecting device, the rotating member may include at least three notches.

In the above coin-roll ejecting device, in the ejecting mechanism, the driving unit may be capable of rotating the rotating member in both of a forward direction and a reverse direction, the forward direction is a direction in which the rotating member ejects the roll of coins from the storing unit, and the reverse direction is the reverse of the forward direction, and the controlling unit may control a direction of rotation of the rotating member based on the rotating position of the rotating member detected by the rotating position detecting unit and detection information obtained in the first detecting unit.

In the above coin-roll ejecting device, the controlling unit may rotate the rotating member in the reverse direction, when the first detecting unit detects that the rolls of coins of a predetermined number are ejected by the rotating member and when the rotating position detecting unit detects that the rotating member is positioned in a first predetermined position during ejecting the roll of coins from the storing unit by the ejecting mechanism in such a manner that the rotating member is rotated in the forward direction, and the controlling unit may stop the rotation of the rotating member when the rotating position detecting unit detects that the rotating member is positioned in a second predetermined position.

In the above coin-roll ejecting device, the controlling unit may rotate the rotating member in the reverse direction, when the rotating position detecting unit does not detect that the rotating member is positioned in the first predetermined position for a predetermined time during ejecting the roll of coins from the storing unit by the ejecting mechanism in such a manner that the rotating member is rotated in the forward direction, and the controlling unit may stop the rotation of the rotating member when the rotating position detecting unit detects that the rotating member is positioned in a second predetermined position.

The above coin-roll ejecting device may further include a second detecting unit that detects whether a roll of coins is received in the notch of the rotating member in the ejecting mechanism.

In the above coin-roll ejecting device, a shape and a position of each of the notches on the rotating member may be set such that, when one of the notches of the rotating member is positioned at an ejecting position of the rotating position, which is a position at which the rotating member is ready to eject the roll of coins, other leading notch of this notch is positioned at a position at which it is not able to receive the roll of coins from the storing unit.

In the above coin-roll ejecting device, the driving unit may be capable of changing a rotating speed of the rotating member.

In this case, the controlling unit may judge, based on the rotating position of the rotating member detected by the rotating position detecting unit and the detection information obtained in the first detecting unit, whether an ejection defect that the roll of coins are not able to be ejected normally from the storing unit has occurred, and the controlling unit may cause, when number of times that the ejection defect occurred in one of a predetermined time, predetermined ejection cycles, a predetermined ejection number exceeds a predetermined number, the driving unit to adjust the rotating speed of the rotating member to reduce the rotating speed of the rotating member.

In the above coin-roll ejecting device, the notches of the rotating member may be formed such that, when one of the notches of the rotating member is positioned at a storing position of the rotating position, which is a position at which the rotating member is ready to receive the roll of coins from the storing unit, an inner wall of this notch and the bottom surface of the storing unit are positioned substantially on one line.

In the above coin-roll ejecting device, a length of the rotating member along the rotation axis may be larger than ½ of a maximum length in a longitudinal direction of the roll of coins that is to be ejected.

In the above coin-roll ejecting device, an outer surface of the rotating member, to which the rolls of coins stored in the storing unit contact, may be configured such that a distance between the outer surface and the rotation axis is capable to be changed.

In this case, the rotating member may have a substantially polygonal shape in a side cross-unit, and the notches are formed near vertices of the polygon.

In the above coin-roll ejecting device, a gate member may be arranged above the rotating member to prevent a situation where the roll of coins stored in the storing unit does not enter into the notches of the rotating member whereby the roll of coins is ejected from above the rotating member.

In this case, the gate member may be freely movable so as to unevenly push and move the rolls of coins stored in the storing unit along the longitudinal direction of the roll of coins.

Further, the gate member may be swingable around a swing shaft that extends substantially horizontally.

Alternatively, the gate member may be swingable around a swing shaft that extends substantially vertically.

Alternatively, the gate member may include a plurality of gate elements capable of independently moving back and forth toward the rolls of coins stored in the storing unit.

Further, the gate member may be movable following a rotation motion of the rotating member.

Further, the gate member may have a configuration that allows mounting a mounting member capable of contacting the rolls of coins stored in the storing unit.

In the above coin-roll ejecting device, an angle of inclination of the bottom surface of the storing unit with respect to the horizontal plane may be within a range of 8 degrees to 20 degrees, and a maximum static friction coefficient of the bottom surface of the storing unit with respect to the roll of coins may be within a range of 0.01 to 0.15.

In the above coin-roll ejecting device, the storing unit may include a pair of side walls that constitutes a storing area for the rolls of coins, and at least one of the pair of the side walls may constitute a door that is opened when replenishing the rolls of coins in the storing unit or taking out the rolls of coins from the storing unit.

In this case, the side wall that constitutes the door may have a configuration that allows an operator to see inside the storing unit.

Further, a storing area width adjusting member that allows adjusting a width of the storing area of the storing unit may be detachably attached to at least one of the pair of the side walls, several types of the storing area width adjusting members may be prepared corresponding to a longitudinal length of the roll of coins, and the width of the storing area of the storing unit may be adjustable by attaching an appropriate one of the storing area width adjusting members to the side wall.

In the above coin-roll ejecting device, several types of the rotating members having the notches of various shapes may be prepared corresponding to diameters of the rolls of coins, and the rotating member may be changed depending on a diameter of the rolls of coins that are to be stored in that storing unit.

A coin-roll ejecting device of the present invention has a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; and a lifting unit that includes a coin-roll accommodating member that accommodates the roll of coins ejected by the ejecting mechanism from the storing unit and that is movable in the vertical direction.

In the above coin-roll ejecting device, the ejecting mechanism may include a rotating member that rotates around a rotation axis that extends horizontally and orthogonally to the direction of inclination of the storing unit and has a notch that receives one roll of coins stored in the storing unit, and a driving unit that rotates the rotating member around the rotation axis, and a gate member may be arranged above the rotating member to prevent a situation where the roll of coins stored in the storing unit does not enter into the notch of the rotating member whereby the roll of coins is ejected from above the rotating member.

In this case, the gate member may be freely movable so as to unevenly push and move the rolls of coins stored in the storing unit along a longitudinal direction of the roll of coins.

Further, the gate member may be swingable around a swing shaft that extends substantially horizontally.

Alternatively, the gate member may be swingable around a swing shaft that extends substantially vertically.

Alternatively, the gate member may include a plurality of gate elements capable of independently moving back and forth toward the rolls of coins stored in the storing unit.

Further, the gate member may be movable following a rotation motion of the rotating member.

In the above coin-roll ejecting device, the storing unit may include a pair of side walls that constitutes a storing area for the rolls of coins, and at least one of the pair of the side walls may constitute a door that is opened when replenishing the rolls of coins in the storing unit or taking out the rolls of coins from the storing unit.

The above coin-roll ejecting device may further include a housing that accommodates the storing unit and the lifting unit; and a housing door arranged in a front surface or a back surface of the housing, and the storing unit and the lifting unit are capable of being pulled integrally from the housing after opening the housing door.

The above coin-roll ejecting device may further include a housing that accommodates the storing unit and the lifting unit; and a housing door arranged in a front surface or a back surface of the housing, and when pulling the storing unit from the housing after opening the housing door, the lifting unit is capable of being evacuated to a position in which the lifting unit does not hinder a pulling operation of the storing unit in the vertical direction.

The above coin-roll ejecting device may further include a housing that accommodates the storing unit and the lifting unit; and a housing door arranged in a side surface of the housing, and by opening both the housing door and the side wall that constitutes the door, it is possible to replenish the rolls of coins in the storing unit or take out the rolls of coins from the storing unit.

The above coin-roll ejecting device may further include a shutter for opening and closing a coin-roll ejection opening that allows taking out of the roll of coins stored in the coin-roll accommodating member of the lifting unit when the lifting unit is at an up position.

A coin-roll ejecting device of the present invention includes a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction, the ejecting mechanism includes a rotating member that rotates around a rotation axis that extends horizontally and orthogonally to the direction of inclination of the storing unit and having a notch that receives one roll of coins stored in the storing unit, and a driving unit that rotates the rotating member around the rotation axis, and a gate member is arranged above the rotating member to prevent a situation where the roll of coins stored in the storing unit does not enter into the notch of the rotating member whereby the roll of coins is ejected from above the rotating member, and the gate member unevenly pushes and moves the rolls of coins stored in the storing unit along a longitudinal direction of the roll of coins.

A money changer according to still another aspect of the present invention is a money changer that performs a money change process and includes a dispensing money denomination specifying unit that specifies a denomination of money to be dispensed, and a controlling unit that switches between whether to specify the denomination by the dispensing money denomination specifying unit before depositing the money or to specify the denomination by the dispensing money denomination specifying unit after depositing the money.

The above money changer may further include an input unit that inputs a type of the money change process, and the controlling unit may switch between whether to specify the denomination by the dispensing money denomination specifying unit before depositing the money or to specify the denomination by the dispensing money denomination specifying unit after depositing the money based on the type of the money change process inputted by the input unit.

In the above money changer, the type of the money change process to be inputted by that the input unit may be an ordinary money change process in which a denomination of the dispensed money has a lower value than a denomination of the deposited money and a reverse money change process in which a denomination of the dispensed money has a higher value than a denomination of the deposited money.

In the above configuration, the controlling unit may perform a control to specify the denomination by the dispensing money denomination specifying unit before depositing the money when the type of the money change process inputted by the input unit is the ordinary money change process, and the controlling unit may perform a control to specify the denomination by the dispensing money denomination specifying unit after depositing the money when the type of the money change process inputted by the input unit is the reverse money change process.

The above money changer may further include a setting unit that performs setting of whether to specify the denomination by the dispensing money denomination specifying unit before depositing the money or to specify the denomination by the dispensing money denomination specifying unit after depositing the money.

In the above configuration, the above money changer may further include an input unit that inputs a type of the money change process. The type of the money change process to be inputted by the input unit may be an ordinary money change process in which a denomination of the dispensed money has a lower value than a denomination of the deposited money, and a reverse money change process in which a denomination of the dispensed money has a higher value than a denomination of the deposited money. The setting unit may perform, for each of the ordinary money change process and the reverse money change process, setting of whether to specify the denomination by the dispensing money denomination specifying unit before depositing the money or to specify the denomination by the dispensing money denomination specifying unit after depositing the money.

In the above money changer, whether to specify the denomination by the dispensing money denomination specifying unit before depositing the money or to specify the denomination by the dispensing money denomination specifying unit after depositing the money may be selected for each of the money change process.

The above money changer, when in a standby state, or when beginning the money change process, may accept both of an operation of depositing money and an operation of specifying a denomination by the dispensing money denomination specifying unit. When the operation of depositing money is accepted earlier, the controlling unit may perform the control of specifying the denomination by the dispensing money denomination specifying unit after the money is deposited. On the other hand, when the operation of specifying the denomination by the dispensing money denomination specifying unit is accepted earlier, the controlling unit may perform the control of specifying the denomination by the dispensing money denomination specifying unit before the money is deposited.

In the above money changer, when the denomination is not specified by the dispensing money denomination specifying unit, the money may be dispensed in a denomination combination that will minimize the number of money to be dispensed or in a previously set denomination combination.

The above money changer may further include a customer information receiving unit that receives customer information, and based on the customer information received by the customer information receiving unit, the controlling unit may perform the control of whether to specify the denomination by the dispensing money denomination specifying unit before depositing money or to specify the denomination by the dispensing money denomination specifying unit after depositing money.

The above money changer may further include at least two devices among a banknote depositing and dispensing device that stores therein a deposited banknote and dispenses a banknote that has been stored inside a body, a coin depositing and dispensing device that stores therein a deposited coin and dispenses a coin that has been stored inside the body, and a coin-roll dispensing device that dispenses a roll of coins that has been stored inside the body.

A money changer according to still another aspect of the present invention is a money changer that performs a money change process and includes a dispensing money denomination specifying unit that specifies a denomination of money to be dispensed, and the dispensing money denomination specifying unit may specify the denomination both of before depositing the money and after depositing the money.

A money changer according to still another aspect of the present invention is a money changer that accepts deposition of valuable media apart from the money, and includes a valuable media storing unit that stores therein the deposited valuable media, a dispensing money denomination specifying unit that specifies a denomination of money to be dispensed, and a controlling unit that switches between whether to specify the denomination by the dispensing money denomination specifying unit before depositing the valuable media or to specify the denomination by the dispensing money denomination specifying unit after depositing the valuable media.

A coin-roll ejecting device according to another aspect of the present invention includes a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; and a lifting unit that includes a coin-roll accommodating member that accommodates the roll of coins ejected by the ejecting mechanism from the storing unit and that is movable in the vertical direction.

In the above coin-roll ejecting device, a plurality of the storing units may be arranged one above the other in the vertical direction.

The above coin-roll ejecting device may include a shutter for opening and closing a coin-roll ejection opening that allows taking out of the roll of coins accommodated in the coin-roll accommodating member of the lifting unit when the lifting unit is at an up position.

In the above coin-roll ejecting device, the storing unit may include a pair of side walls that constitutes a storing area for the rolls of coins, and at least one of the pair of the side walls may constitute a door that is opened when replenishing the rolls of coins in the storing unit or taking out the rolls of coins from the storing unit.

In the above coin-roll ejecting device, the side wall that constitutes the door may be configured such that an operator can see inside the storing unit through the side wall.

In the above coin-roll ejecting device, a storing area width adjusting member that allows adjusting a width of the storing area of the storing unit may be detachably attached to at least one of the pair of the side walls, several types of the storing area width adjusting members may be prepared previously depending on a longitudinal length of the roll of coins, and the width of the storing area of the storing unit may be changed by attaching an appropriate one of the storing area width adjusting members to the side wall.

In the above coin-roll ejecting device, an angle of inclination of the bottom surface of the storing unit with respect to the horizontal plane may be within a range of 8 degrees to 20 degrees, and a maximum static friction coefficient of the bottom surface of the storing unit with respect to the roll of coins may be within a range of 0.01 to 0.15.

In the above coin-roll ejecting device, the ejecting mechanism may include a rotating member that rotates around a rotation axis that extends horizontally and orthogonally to the direction of inclination of the storing unit and has at least two notches each receiving one roll of coins stored in the storing unit, and a driving unit that rotates the rotating member around the rotation axis.

In the above coin-roll ejecting device, the rotating member may include at least three notches.

In the above coin-roll ejecting device, the ejecting mechanism may include a rotating position detecting unit that detects a rotating position of the rotating member.

In the above coin-roll ejecting device, a length of the rotating member along the rotation axis may be larger than ½ of a maximum length in a longitudinal direction of the roll of coins that is to be ejected.

In the above coin-roll ejecting device, a gate member may be arranged above the rotating member to prevent a situation where the roll of coins stored in the storing unit does not enter into the notches of the rotating member whereby the roll of coins is ejected from above the rotating member.

In the above coin-roll ejecting device, the gate member may be swingable around a swing shaft that extends horizontally following a rotation motion of the rotating member.

In the above coin-roll ejecting device, the gate member may have a configuration that allows detachably mounting a mounting member capable of contacting the rolls of coins stored in the storing unit.

In the above coin-roll ejecting device, several types of the rotating members having the notches of various shapes may be prepared corresponding to diameters of the rolls of coins, and the rotating member may be replaced depending on a diameter of the rolls of coins that are to be stored in that storing unit.

The above coin-roll ejecting device may further include a housing that accommodates the storing unit and the lifting unit; and a housing door arranged in a front surface or a back surface of the housing, and the storing unit and the lifting unit may be capable of being pulled integrally from the housing after opening the housing door.

The above coin-roll ejecting device may further include a housing that accommodates the storing unit and the lifting unit; and a housing door arranged in a front surface or a back surface of the housing, and when pulling the storing unit from the housing after opening the housing door, the lifting unit may be capable of being evacuated to a position in which the lifting unit does not hinder a pulling operation of the storing unit in the vertical direction.

The above coin-roll ejecting device may further include a housing that accommodates the storing unit and the lifting unit; and a housing door arranged in a side surface of the housing, and by opening both the housing door and the side wall that constitutes the door, it is possible to replenish the rolls of coins in the storing unit or take out the rolls of coins from the storing unit.

A coin-roll ejecting device according to another aspect of the present invention includes a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; and a lifting unit that includes a coin-roll accommodating member that accommodates the roll of coins ejected by the ejecting mechanism from the storing unit and that is movable in the vertical direction, the ejecting mechanism includes a rotating member that rotates around a rotation axis that extends horizontally and orthogonally to the direction of inclination of the storing unit and has at least two notches each receiving one roll of coins stored in the storing unit, and a driving unit that rotates the rotating member around the rotation axis; and several types of the rotating members having the notches of various shapes is prepared corresponding to diameters of the rolls of coins, and the rotating member is replaced depending on a diameter of the rolls of coins that are to be stored in that storing unit.

In the above coin-roll ejecting device, the rotating member may include at least three notches.

In the above coin-roll ejecting device, when replacing the rotating member, the rotating member and the driving unit may be replaced integrally.

In the above coin-roll ejecting device, when replacing the rotating member, only the rotating member may be replaced by independently removing from the ejecting mechanism that includes the driving unit and other components.

In the above coin-roll ejecting device, the rotating member may be configured such that dimensions of the notch are adjustable.

In the above coin-roll ejecting device, the storing unit may include a pair of side walls that constitutes a storing area for the rolls of coins, and a storing area width adjusting member that allows adjusting a width of the storing area of the storing unit may be detachably attached to at least one of the pair of the side walls, several types of the storing area width adjusting members may be prepared corresponding to a longitudinal length of the roll of coins, and the width of the storing area of the storing unit may be changed by attaching an appropriate one of the storing area width adjusting members to the side wall.

In the above coin-roll ejecting device, the storing area width adjusting member may be provided in a movable manner in the storing unit.

In the above coin-roll ejecting device, at least one of the pair of the side walls may constitute a door that is opened when replenishing the rolls of coins in the storing unit or taking out the rolls of coins from the storing unit.

In the above coin-roll ejecting device, the storing area width adjusting member may be detachably attached to a side wall opposite to the side wall that constitutes the door.

In the above coin-roll ejecting device, the side wall that constitutes the door may be configured such that an operator is capable of seeing inside the storing unit through the side wall.

In the above coin-roll ejecting device, with respect to the dimensions of the notches of the several types of the rotating members, a ratio of a width of the notch to a diameter of the roll of coins may be within a range of 1.0 and 1.7.

In the above coin-roll ejecting device, with respect to the dimensions of the notches of the several types of the rotating members, a ratio of a depth of the notch to a diameter of the roll of coins may be within a range of 0.8 and 1.5.

The above coin-roll ejecting device may include a shutter for opening and closing a coin-roll ejection opening that allows taking out of the roll of coins accommodated in the coin-roll accommodating member of the lifting unit when the lifting unit is at an up position.

In the above coin-roll ejecting device, an angle of inclination of the bottom surface of the storing unit with respect to the horizontal plane may be within a range of 8 degrees to 20 degrees, and a maximum static friction coefficient of the bottom surface of the storing unit with respect to the roll of coins may be within a range of 0.01 to 0.15.

In the above coin-roll ejecting device, the ejecting mechanism may include a rotating position detecting unit that detects a rotating position of the rotating member.

In the above coin-roll ejecting device, a length of the rotating member along the rotation axis may be larger than ½ of a maximum length in a longitudinal direction of the roll of coins that is to be ejected.

In the above coin-roll ejecting device, a gate member may be arranged above the rotating member to prevent a situation where the roll of coins stored in the storing unit does not enter into the notches of the rotating member whereby the roll of coins is ejected from above the rotating member.

In the above coin-roll ejecting device, the gate member may be swingable around a swing shaft that extends horizontally following a rotation motion of the rotating member.

In the above coin-roll ejecting device, the gate member may have a configuration that allows detachably mounting a mounting member capable of contacting the rolls of coins stored in the storing unit.

The above coin-roll ejecting device may further include a housing that accommodates the storing unit and the lifting unit; and a housing door arranged in a front surface or a back surface of the housing, and the storing unit and the lifting unit may be capable of being pulled integrally from the housing after opening the housing door.

The above coin-roll ejecting device may further include a housing that accommodates the storing unit and the lifting unit; and a housing door arranged in a front surface or a back surface of the housing, and when pulling the storing unit from the housing after opening the housing door, the lifting unit may be capable of being evacuated to a position in which the lifting unit does not hinder a pulling operation of the storing unit in the vertical direction.

The above coin-roll ejecting device may further include a housing that accommodates the storing unit and the lifting unit; and a housing door arranged in a side surface of the housing, and by opening both the housing door and the side wall that constitutes the door, it is possible to replenish the rolls of coins in the storing unit or take out the rolls of coins from the storing unit.

A coin-roll ejecting device according to another aspect of the present invention includes a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; and a lifting unit that includes a coin-roll accommodating member that accommodates the roll of coins ejected by the ejecting mechanism from the storing unit and that is movable in the vertical direction, and the storing unit includes a pair of side walls that constitutes a storing area for the rolls of coins, and a storing area width adjusting member that allows adjusting a width of the storing area of the storing unit is detachably attached to at least one of the pair of the side walls, several types of the storing area width adjusting members are prepared corresponding to a longitudinal length of the roll of coins, and the width of the storing area of the storing unit is changed by attaching an appropriate one of the storing area width adjusting members to the side wall.

### BRIEF DESCRIPTION OF THE DRAWINGS

FIG. 1 is a perspective view of an external appearance of a money changer according to an embodiment of the present invention.

FIG. 2 is a perspective view of a configuration in a state in which an upper door and a lower door, which are arranged on a front surface of an outer housing of the money changer shown in FIG. 1, are opened.

FIG. 3 is a schematic configuration diagram of an overall configuration of the money changer shown in FIGS. 1 and 2.

FIG. 4 is a side view of an internal configuration of a loose-coin depositing and dispensing device included in the money changer shown in FIG. 1 and the like.

FIG. 5 is a front view of the internal configuration of the loose-coin depositing and dispensing device shown in FIG. 4.

FIG. 6 is a side view of an internal configuration of a conventional loose-coin depositing and dispensing device as a comparative example.

FIG. 7 is a top view of a configuration of a coin depositing mechanism included in the loose-coin depositing and dispensing device shown in FIGS. 4 and 5.

FIG. 8 is a longitudinal cross-sectional view of the coin depositing mechanism along an arrow A-A shown in FIG. 7 and depicts a state before inclining a first coin-supplying unit.

FIG. 9 is a longitudinal cross-sectional view of the coin depositing mechanism along the arrow A-A shown in FIG. 7 and depicts a state after inclining the first coin-supplying unit.

FIG. 10 is a longitudinal cross-sectional view of the coin depositing mechanism along an arrow B-B shown in FIG. 7.

FIG. 11 is a longitudinal cross-sectional view of the coin depositing mechanism along an arrow C-C shown in FIG. 7.

FIG. 12 is a functional block diagram of the loose-coin depositing and dispensing device shown in FIG. 4 and the like.

FIG. 13 is a side view of an internal configuration of a loose-banknote depositing and dispensing device included in the money changer shown in FIG. 1 and the like.

FIG. 14 is a side view of an internal configuration of a coin-roll ejecting device included in the money changer shown in FIG. 1 and the like.

FIG. 15 is a side view of a detailed configuration of a plurality of storing units and a lifting unit included in the coin-roll ejecting device shown in FIG. 14.

FIG. 16A is a perspective view of a configuration of an ejecting mechanism included in each of the storing units of the coin-roll ejecting device shown in FIG. 14 and the like.

FIG. 16B is a side view of a situation in which a bridge phenomenon of rolls of coins has occurred near the ejecting mechanism in the storing unit of the coin-roll ejecting device shown in FIG. 14 and the like.

FIG. 16C is another perspective view of a configuration of the ejecting mechanism included in each of the storing units of the coin-roll ejecting device shown in FIG. 14 and the like.

FIG. 16D is still another perspective view of a configuration of the ejecting mechanism included in each of the storing units of the coin-roll ejecting device shown in FIG. 14 and the like.

FIG. 16E is a perspective view of a situation in which a roll of coins is pushed by a mounting member mounted on a gate member of the ejecting mechanism shown in FIG. 16D.

FIG. 16F is a top view of another variation of the ejecting mechanism included in each of the storing units of the coin-roll ejecting device shown in FIG. 14 and the like.

FIG. 16G is a top view of still another variation of the ejecting mechanism included in each of the storing units of the coin-roll ejecting device shown in FIG. 14 and the like.

FIG. 16H is a top view of still another variation of the ejecting mechanism included in each of the storing units of the coin-roll ejecting device shown in FIG. 14 and the like.

FIG. 17 is a side view of the ejecting mechanism shown in FIG. 16A.

FIG. 18 is another side view of the ejecting mechanism shown in FIG. 16A.

FIG. 19 is a side view of the coin-roll ejecting device shown in FIG. 14 and the like indicating an operation performed by the ejecting mechanism when ejecting a roll of coins stored in the storing unit.

FIG. 20 is another side view of the coin-roll ejecting device shown in FIG. 14 and the like indicating an operation performed by the ejecting mechanism when ejecting a roll of coins stored in the storing unit.

FIG. 21 is still another side view of the coin-roll ejecting device shown in FIG. 14 and the like indicating an operation performed by the ejecting mechanism when ejecting a roll of coins stored in the storing unit.

FIG. 22 is still another side view of the coin-roll ejecting device shown in FIG. 14 and the like indicating an operation performed by the ejecting mechanism when ejecting a roll of coins stored in the storing unit.

FIG. 23 is a perspective view of a configuration of the storing units and the lifting unit included in the coin-roll ejecting device shown in FIG. 14 and the like in a state in which a door of one of the storing units is open.

FIG. 24 is a structural diagram of a configuration of the door included in the coin-roll ejecting device shown in FIG. 23.

FIG. 25 is a perspective view of a configuration of a first storing area width adjusting member used to adjust a width of a storing area of each of the storing units in the coin-roll ejecting device shown in FIG. 14 and the like.

FIG. 26 is a perspective view of a configuration of a second storing area width adjusting member used to adjust a width of a storing area of each of the storing units in the coin-roll ejecting device shown in FIG. 14 and the like.

FIG. 27 are views of configurations of other variations of rotating members usable in the ejecting mechanism included in the storing unit of the coin-roll ejecting device shown in FIG. 14 and the like.

FIG. 28 is a side view of an internal configuration of other variation of a coin-roll ejecting device usable in the money changer shown in FIG. 1 and the like.

FIG. 29 are views of configurations of other variations of rotating members usable in the ejecting mechanism included in the storing unit of the coin-roll ejecting device shown in FIG. 28.

FIG. 30 is a functional block diagram of a detailed configuration of a controlling device of the money changer shown in FIG. 3.

FIG. 31 is a view depicting various patterns of a timing of denomination specification of money to be dispensed from the money changer shown in FIG. 1 and the like.

FIG. 32 is a table indicating an example of a relation between a pattern of emitted color and a light display of a pair of light emitting diodes arranged on the left and right in the money changer shown in FIG. 1 and the like and a state of the money changer.

FIG. 33 is another schematic configuration diagram of an overall configuration of the money changer according to the embodiment of the present invention.

### DETAILED DESCRIPTION OF THE INVENTION

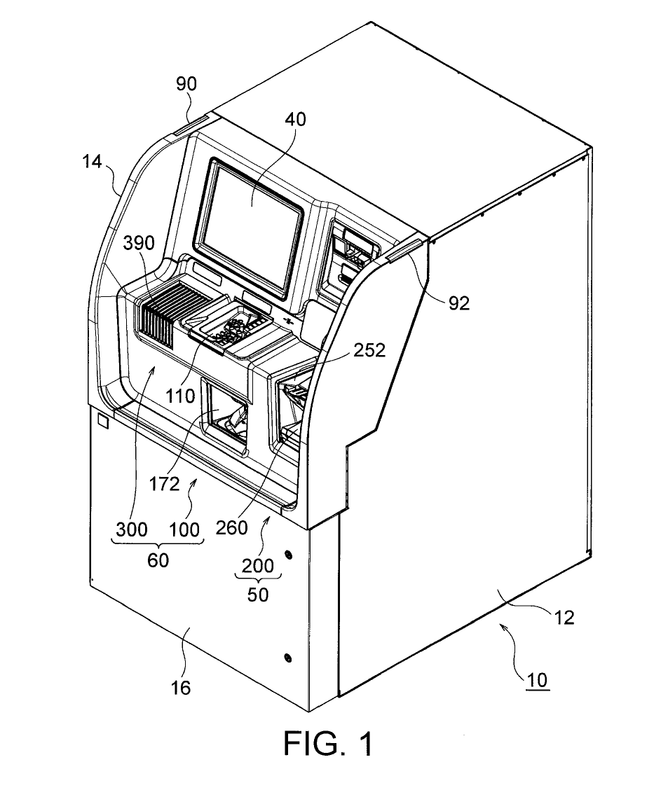

Exemplary embodiments of the present invention are explained below with reference to the drawings. FIGS. 1 to 33 are views of a configuration of a money changer according to the present embodiment. The money changer according to the present embodiment is installed in a lobby of a financial institution and the like. A customer can himself operate the money changer to perform a money change process. More particularly, the money changer according to the present embodiment performs each of the following processes as the money change process: an ordinary money change process and a reverse money change process. In the ordinary money change process, a denomination of the dispensed money has a lower value than a denomination of the deposited money. In the reverse money change process, a denomination of the dispensed money has a higher value than a denomination of the deposited money. When performing such a money change process, it is possible to configure the money changer according to the present embodiment such that money of a value less a handling charge for performing the money change of the deposited money is dispensed. Moreover, the money changer according to the present embodiment can provide following services: dispense new version banknotes of the same value as the total value, or of a value less a handling charge for performing the money change, of deposited old version banknotes; dispense fit banknotes of the same value as the total value, or of a value less a handling charge for performing the money change, of deposited unfit banknotes; and dispense brand-new banknotes (so-called new banknotes) of the same value as the total value, or of a value less a handling charge for performing the money change, of deposited circulated banknotes.

### Overall Configuration of Money Changer

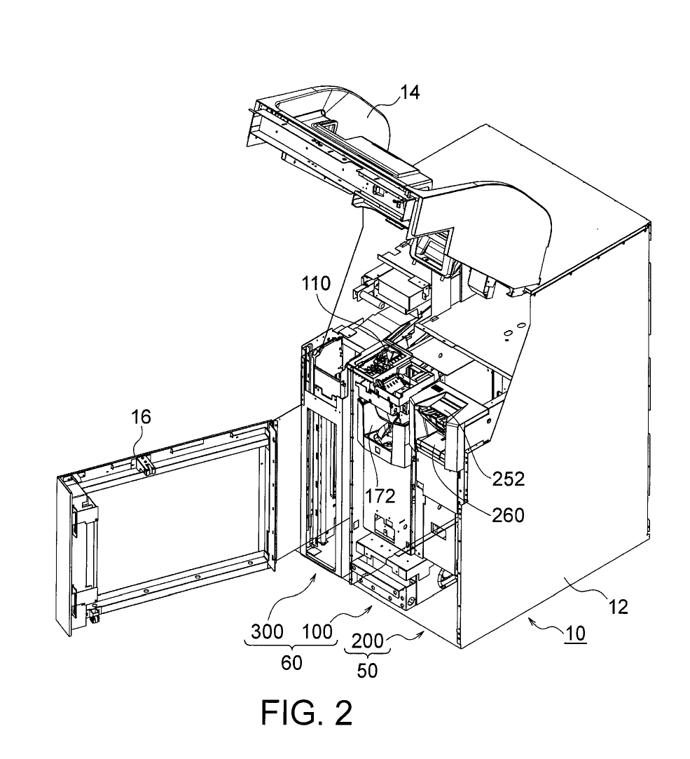

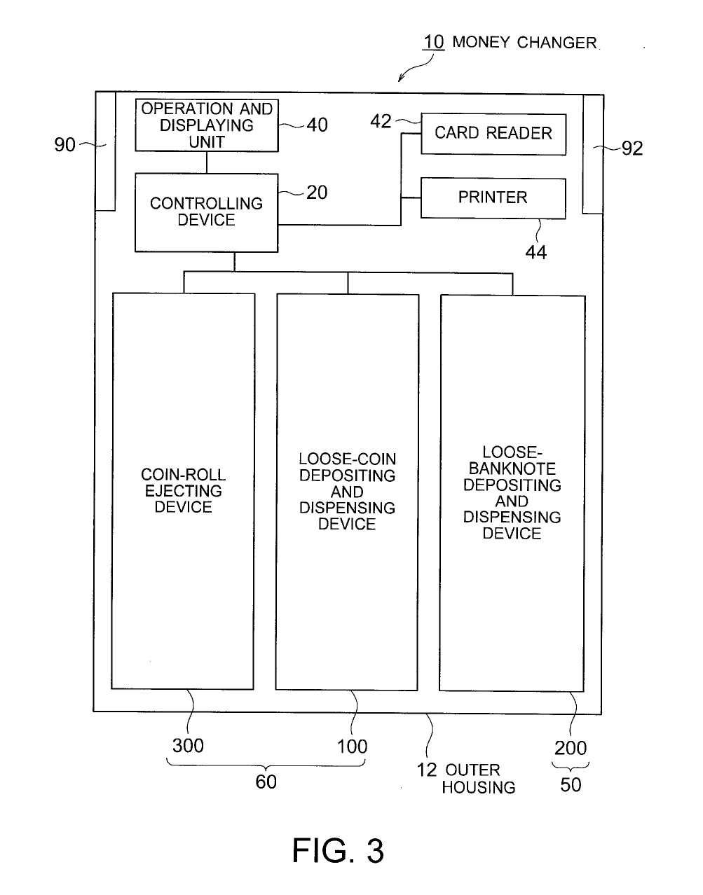

At first, an overall configuration of the money changer according to the present embodiment is explained by referring to FIGS. 1 to 3. FIG. 1 is a perspective view of an external appearance of the money changer according to the embodiment of the present invention. FIG. 2 is a perspective view of a configuration in a state in which an upper door and a lower door, which are arranged on a front surface of an outer housing of the money changer shown in FIG. 1, are opened. FIG. 3 is a schematic configuration diagram that shows an overall configuration of the money changer shown in FIGS. 1 and 2.

As shown in FIGS. 1 and 2, a money changer 10 according to the present embodiment includes an outer housing 12 having a substantially cuboidal shape. Inside the outer housing 12, a loose-coin depositing and dispensing device 100, a loose-banknote depositing and dispensing device 200, and a coin-roll ejecting device 300 are arranged, side-by-side in a lateral direction. The loose-coin depositing and dispensing device 100, the loose-banknote depositing and dispensing device 200, and the coin-roll ejecting device 300 can be separately pulled horizontally and away from the outer housing 12 to remove them from the inside of the outer housing 12. In the present embodiment, a banknote processing system 50 that performs a money depositing process and a money dispensing process of banknotes is constituted by the loose-banknote depositing and dispensing device 200. Moreover, a coin processing system 60 that performs a money depositing process and a money dispensing process of coins is constituted by the loose-coin depositing and dispensing device 100 and the coin-roll ejecting device 300.

An upper door 14 and a lower door 16 are arranged on a front surface of the outer housing 12 of the money changer 10. As shown in FIG. 2, the upper door 14 can be opened upward from its closed state shown in FIG. 1. The lower door 16 can be opened laterally from its closed state shown in FIG. 1. Moreover, as a state notifying unit, light emitting diodes (LED) 90 and 92 are arranged in the left and right sides on an upper part of the upper door 14. The state notifying unit notifies to the outside of a state in which the money changer 10 is among a plurality of preset states with a light display. A configuration and an operation or effect of the light emitting diodes 90 and 92 will be explained later.

As shown in FIG. 3, the money changer 10 according to the present embodiment includes a controlling device 20 that is connected to the loose-coin depositing and dispensing device 100, the loose-banknote depositing and dispensing device 200, and the coin-roll ejecting device 300. The controlling device 20 controls these devices 100, 200, and 300. How the controlling device 20 controls the devices 100, 200, and 300 will be explained later. As shown in FIG. 1, the upper door 14 of the money changer 10 includes an operation and displaying unit 40 constituted by, for example, a touch panel. The operation and displaying unit 40 is connected to the controlling device 20 (see FIG. 3). The operation and displaying unit 40 displays information relating to a processing state, an inventory amount, and the like of the money in each of the devices 100, 200, and 300. Moreover, an operator can input various commands into the controlling device 20 by operating the operation and displaying unit 40. In the money changer 10, instead of providing the operation and displaying unit 40 constituted by the touch panel and the like, a displaying unit constituted by a monitor and the like and an operating member constituted by a keyboard, an operation key, and the like may be provided separately.

As shown in FIG. 3, a card reader 42, a printer 44, and the like are connected to the controlling device 20 of the money changer 10. The card reader 42 authenticates the operator by performing reading of an ID card and the like possessed by the operator. The printer 44 functions as a printing unit that prints on a receipt and the like the information relating to the processing state, the inventory amount, and the like of the money in each of the devices 100, 200, and 300, or information about the money change process performed by the operator. A card insertion opening from which the card can be inserted into the card reader 42, and a receipt ejection opening from which the receipt can be ejected from the printer 44 are arranged in the upper door 14 and the like of the money changer 10.

Although not illustrated, a small rack can be arranged on a front surface of the money changer 10. When such a rack is present, the operator, who may be a customer and the like, who wants to perform the money change process by using the money changer 10, can temporarily place his bag or cash on the rack. This is very convenient to the operator as he can then operate the money changer 10 with both the hands.

### Configuration of Loose-Coin Depositing and Dispensing Device

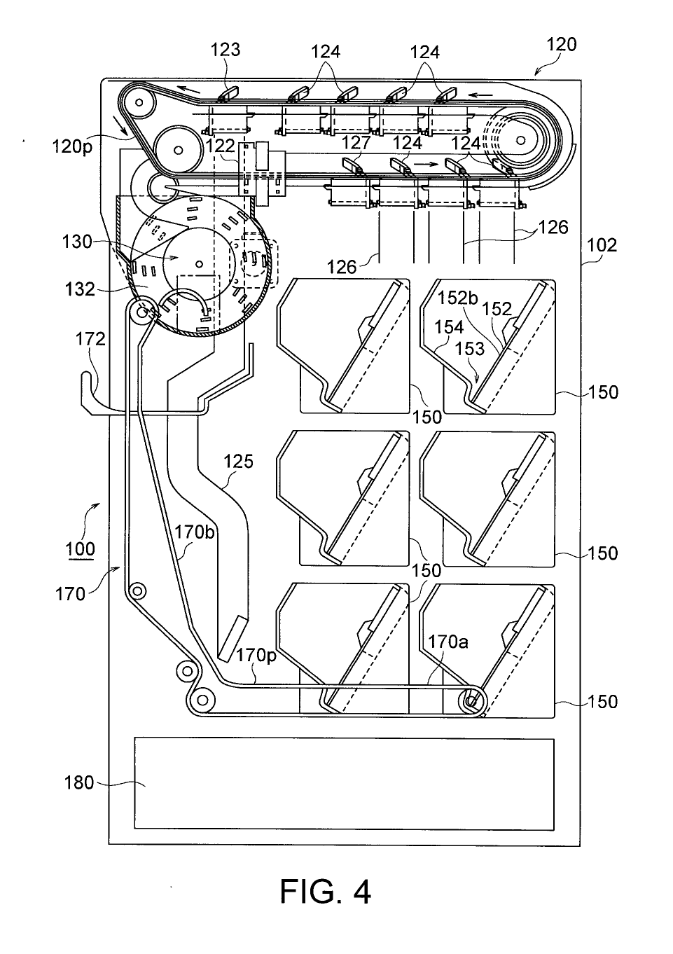

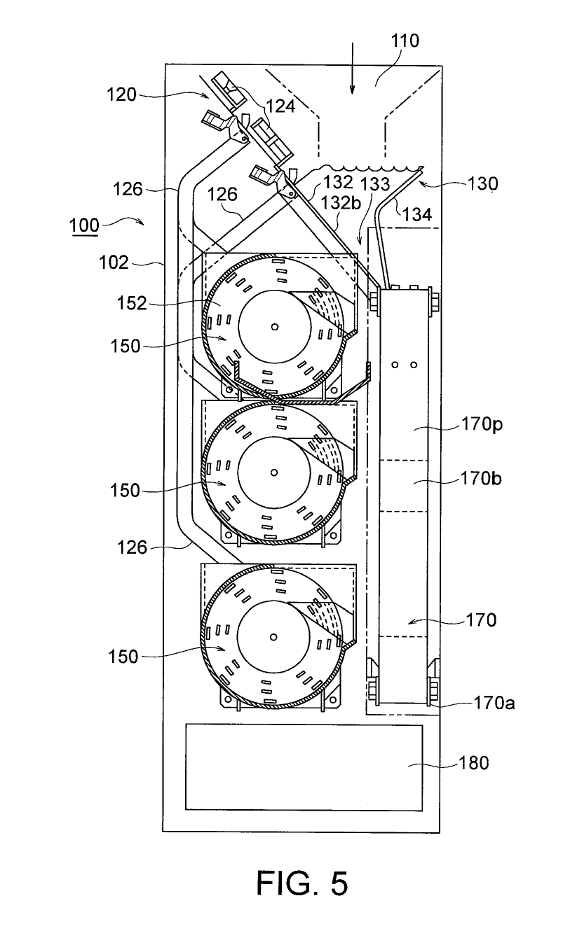

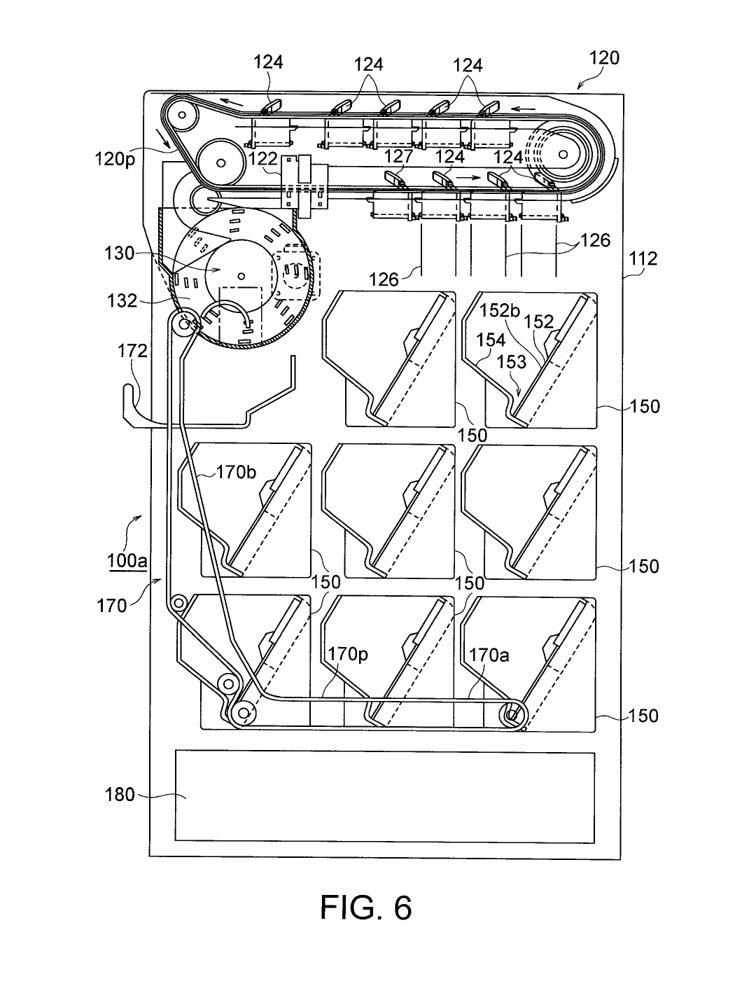

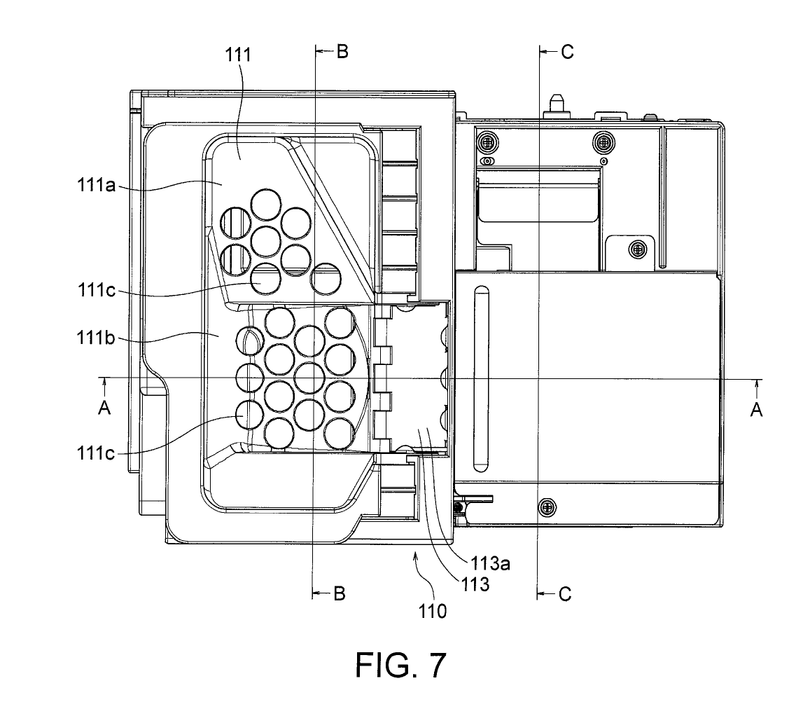

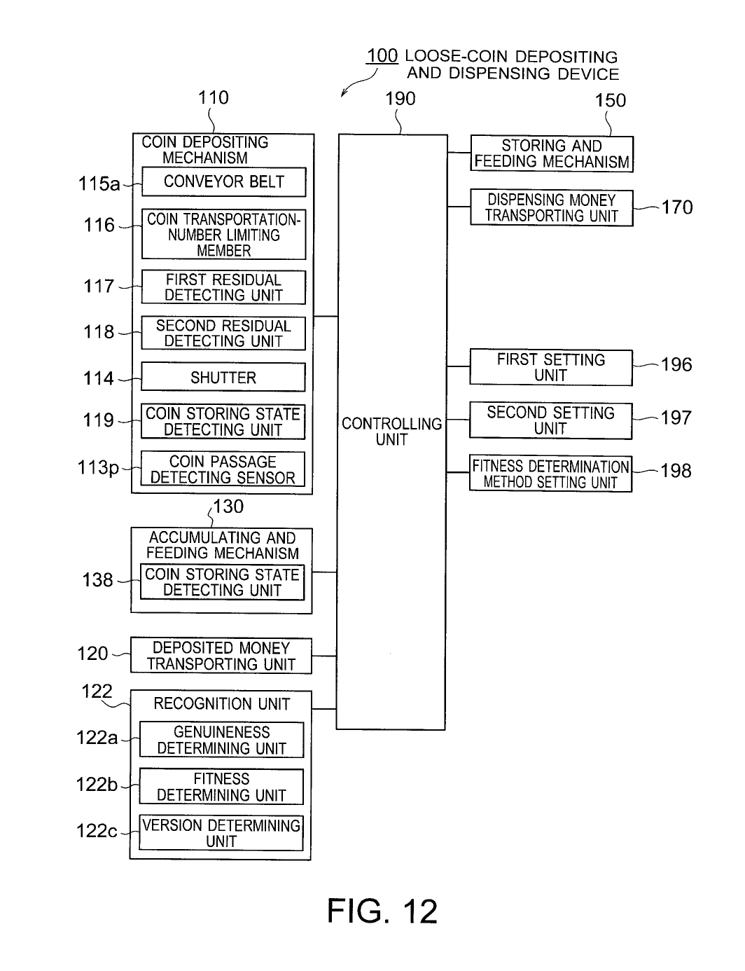

A configuration of the loose-coin depositing and dispensing device 100 included in the money changer 10 according to the present embodiment is explained below by referring to FIGS. 4 to 12. FIG. 4 is a side view of an internal configuration of the loose-coin depositing and dispensing device 100 included in the money changer 10 shown in FIG. 1 and the like. FIG. 5 is a front view of the internal configuration of the loose-coin depositing and dispensing device 100 shown in FIG. 4. FIG. 6 is a side view of an internal configuration of a conventional loose-coin depositing and dispensing device 100a as a comparative example. FIGS. 7 to 11 are top views or longitudinal cross-sectional views of a configuration of a coin depositing mechanism 110 included in the loose-coin depositing and dispensing device 100 shown in FIGS. 4 and 5. FIG. 12 is a functional block diagram of the loose-coin depositing and dispensing device 100 shown in FIG. 4 and the like.

As shown in FIGS. 4 and 5, the loose-coin depositing and dispensing device 100 includes a housing 102 having a substantially cuboidal shape, the coin depositing mechanism 110 (see FIG. 5) that deposits a coin from outside of the housing 102 to the inside thereof, and an accumulating and feeding mechanism 130 that accumulates the coins that are deposited inside of the housing 102 by the coin depositing mechanism 110 and feeds the accumulated coins one by one. A detailed configuration of the coin depositing mechanism 110 will be explained later. The accumulating and feeding mechanism 130 includes a rotating disk 132 and a cover member 134. The rotating disk 132 is inclined by a predetermined angle with respect to the vertical direction, and it is rotatable while being in the inclined posture. The cover member 134 forms a coin accumulating space 133 for accumulating coins between itself and a surface 132b of the rotating disk 132.

A deposited money transporting unit 120 is arranged in an upper part in the housing 102. The deposited money transporting unit 120 transports one by one the coins fed by the accumulating and feeding mechanism 130. The deposited money transporting unit 120 includes a recognition unit 122 that recognizes a denomination, authentication, fitness, version (new or old), and the like of the coin transported by the deposited money transporting unit 120. More particularly, as shown in FIG. 12, the recognition unit 122 includes a genuineness determining unit 122a, a fitness determining unit 122b, and a version determining unit 122c. The genuineness determining unit 122a determines whether a coin deposited in the loose-coin depositing and dispensing device 100 is a genuine coin (a true coin) or a counterfeit coin (a fake coin). The fitness determining unit 122b determines whether a coin deposited in the loose-coin depositing and dispensing device 100 is a fit coin or an unfit coin. An unfit coin is a coin whose surface has been damaged by rust, dirt, and the like, a partially defective coin, a deformed coin, and the like. The version determining unit 122c determines whether a coin deposited in the loose-coin depositing and dispensing device 100 is a new version coin or an old version coin. The new version coin is a coin that is currently in circulation, and the old version coin is a coin that is currently not in circulation. Because counterfeit coins, unfit coins, and old version coins are not suitable for circulation in the market, it is desirable to store such coins inside the body of the loose-coin depositing and dispensing device 100 without dispensing them from the loose-coin depositing and dispensing device 100.

An endless belt 120p is installed in the deposited money transporting unit 120. The endless belt 120p is stretched over a plurality of pulleys. The endless belt 120p is caused to perform a cyclic shift in the counterclockwise direction in FIG. 4 by a motor attached to one of the pulleys. The endless belt 120p is provided with a plurality of protruding members (not shown) at a regular interval. One coin can be caught in one protruding member. Thus, the coins can be transported one by one on a conveying surface.

A plurality of (specifically six) storing and feeding mechanisms 150 is arranged below the deposited money transporting unit 120 in the housing 102. Each of the storing and feeding mechanisms 150 receives coins from the deposited money transporting unit 120 via chutes 126. Specifically, the deposited money transporting unit 120 includes a plurality of sorting members 124 that sort the coins to an appropriate chute 126 based on a recognition result of the coin obtained in the recognition unit 122. Moreover, the deposited money transporting unit 120 includes a reject sorting member 127 that sorts coins to be rejected. A coin that is determined by the genuineness determining unit 122a of the recognition unit 122 as being a counterfeit coin (a fake coin) is sent by the reject sorting member 127 to a later-explained coin ejection opening 172 via a chute (not shown) for reject coin. Moreover, separately from the coin ejection opening 172, although not shown, a returning unit (a reject unit) that returns a reject coin to the outside of the body can be arranged near the coin ejection opening 172. When such a configuration is adopted, a coin that is determined by the genuineness determining unit 122a of the recognition unit 122 as being a counterfeit coin is sent by the reject sorting member 127 to the returning unit via the chute for reject coin as a reject coin.

Each of the storing and feeding mechanisms 150 feeds the coins stored in the storing and feeding mechanism 150 one by one. More particularly, the storing and feeding mechanism 150 includes a rotating disk 152 and a cover member 154. The rotating disk 152 is inclined by a predetermined angle with respect to the vertical direction, and it is rotatable while being in the inclined posture. The cover member 154 forms a coin accumulating space 153 for accumulating coins between itself and a surface 152b of the rotating disk 152.

The loose-coin depositing and dispensing device 100 includes the coin ejection opening 172 for ejecting a coin outside of the housing 102. A dispensing money transporting unit 170 is arranged inside the housing 102. The dispensing money transporting unit 170 transports coins fed by the storing and feeding mechanisms 150 to the coin ejection opening 172. The dispensing money transporting unit 170 includes a first dispensing money transporting part 170a and a second dispensing money transporting part 170b. The first dispensing money transporting part 170a extends substantially horizontally below each of the storing and feeding mechanisms 150. The second dispensing money transporting part 170b transports a coin sent by the first dispensing money transporting part 170a to the coin ejection opening 172. The dispensing money transporting unit 170 is constituted by an endless belt 170p that is stretched over a plurality of pulleys. The endless belt 170p is caused to perform a cyclic shift in both of the clockwise direction and the counterclockwise direction in FIG. 4 by a motor attached to one of the pulleys. The endless belt 170p is provided with a plurality of protruding members (not shown) at a regular interval. One coin can be caught in one protruding member. Thus, the coins can be transported one by one by the endless belt 170p.

An overflow coin storing unit 180 is arranged below the dispensing money transporting unit 170 in the housing 102. The overflow coin storing unit 180 is constituted by, for example, a collection box and the like detachably attached to the housing 102. When the endless belt 170p performs the cyclic shift in the clockwise direction in FIG. 4, a coin is sent to the overflow coin storing unit 180 from the first dispensing money transporting part 170a included in the dispensing money transporting unit 170. When the overflow coin storing unit 180 is constituted by the collection box, the coins are stored in the collection box, and the coins can be collected together with the collection box from the housing 102 by pulling the collection box away from the housing 102.

In a conventional loose-coin depositing and dispensing device 100a shown in FIG. 6, eight storing and feeding mechanisms 150 are arranged in the housing 102 below the deposited money transporting unit 120. On the other hand, in the loose-coin depositing and dispensing device 100 according to the present embodiment, two storing and feeding mechanisms 150 arranged in the device front part (i.e., left side in FIG. 6) among the eight storing and feeding mechanisms 150 are removed, and an overflow chute 125 is arranged in the space that became available because of the removal of the two storing and feeding mechanisms 150. Moreover, as shown in FIG. 4, in the deposited money transporting unit 120, an overflow sorting member 123 that sorts coins to be sent to the overflow chute 125 is provided separately from the sorting members 124 that sort coins to be sent to each of the chutes 126 corresponding to each of the storing and feeding mechanisms 150. A lower end of the overflow chute 125 is positioned above the endless belt 170p of the dispensing money transporting unit 170. With this configuration, the coins sorted by the overflow sorting member 123 among the coins transported by the deposited money transporting unit 120 are sent on the endless belt 170p of the dispensing money transporting unit 170 via the overflow chute 125.

In the conventional loose-coin depositing and dispensing device 100a shown in FIG. 6, when the storing and feeding mechanism 150 corresponding to the denomination of the coin identified by the recognition unit 122 becomes full, transportation of the coin by the deposited money transporting unit 120 is stopped. Subsequently, some coins from this full storing and feeding mechanism 150 are fed to the endless belt 170p of the dispensing money transporting unit 170, and those coins are then sent to the overflow coin storing unit 180 by the endless belt 170p. The transportation of the coin by the deposited money transporting unit 120 is restarted when all the coins fed from the full storing and feeding mechanism 150 are sent to the overflow coin storing unit 180. However, in the conventional loose-coin depositing and dispensing device 100a, because it is necessary to temporarily stop the transportation of the coin by the deposited money transporting unit 120, the processing speed of the coins is low.

In contrast, in the loose-coin depositing and dispensing device 100 shown in FIG. 4 according to the present embodiment, the transportation of the coin by the deposited money transporting unit 120 is not stopped even when the storing and feeding mechanism 150 corresponding to the denomination of the coin identified by the recognition unit 122 becomes full. Instead, such a coin, of which the storing and feeding mechanism 150 corresponding to the denomination is full, is sorted by the overflow sorting member 123, and sent on the endless belt 170p of the dispensing money transporting unit 170 via the overflow chute 125. Subsequently, the coin sent on the endless belt 170p of the dispensing money transporting unit 170 via the overflow chute 125 is sent to the overflow coin storing unit 180 by the endless belt 170p. In the loose-coin depositing and dispensing device 100 according to the present embodiment, even if the storing and feeding mechanism 150 corresponding to the denomination of the coin identified by the recognition unit 122 becomes full, the coin can be sent to the overflow coin storing unit 180 without stopping the transportation of the coin by the deposited money transporting unit 120. This prevents a degradation of the processing speed of the coins.

The loose-coin depositing and dispensing device 100 includes a controlling unit 190 that controls the various components of the loose-coin depositing and dispensing device 100. A configuration of the controlling unit 190 will be explained by referring to FIG. 12. As shown in FIG. 12, the coin depositing mechanism 110, the accumulating and feeding mechanism 130, the deposited money transporting unit 120, the recognition unit 122, the storing and feeding mechanism 150, the dispensing money transporting unit 170, and the like of the loose-coin depositing and dispensing device 100 are connected to the controlling unit 190. The recognition result of the coin obtained in the recognition unit 122 is sent to the controlling unit 190. Moreover, the controlling unit 190 controls the coin depositing mechanism 110, the accumulating and feeding mechanism 130, the deposited money transporting unit 120, the storing and feeding mechanism 150, the dispensing money transporting unit 170, and the like, by sending a command signal to these components.

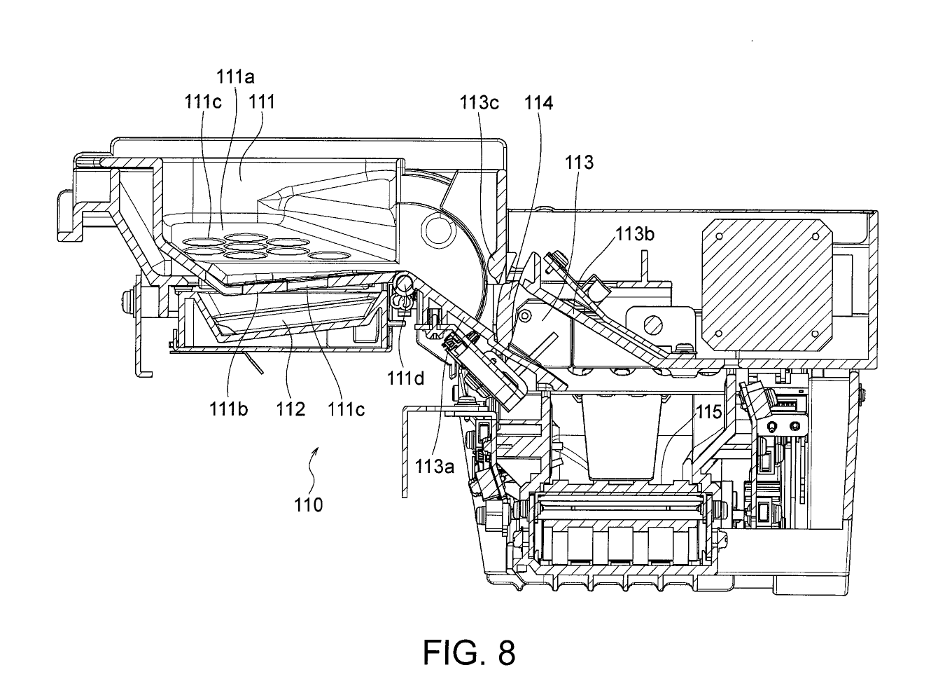

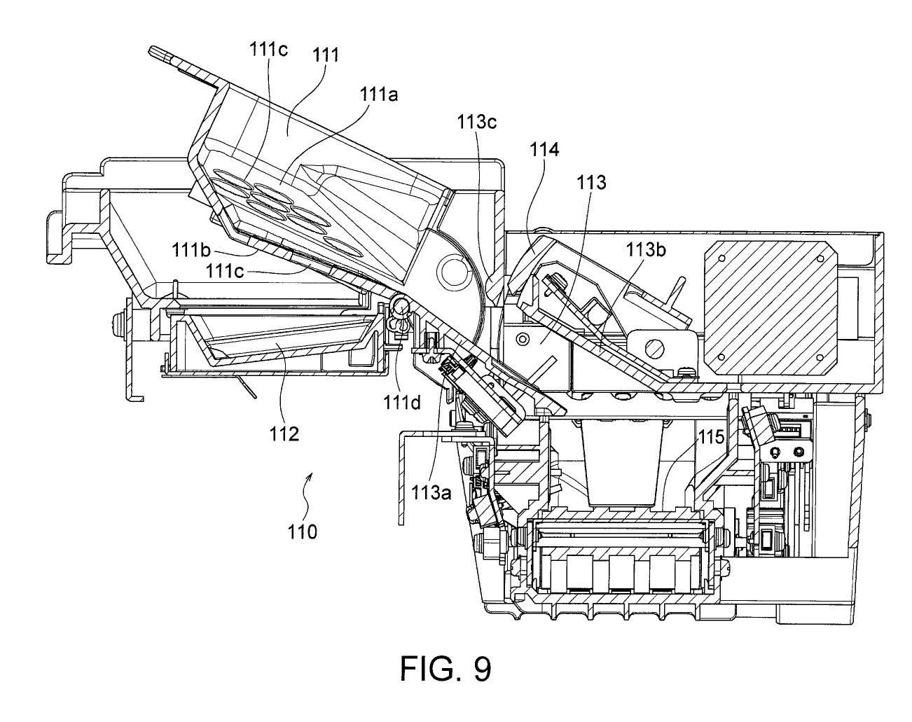

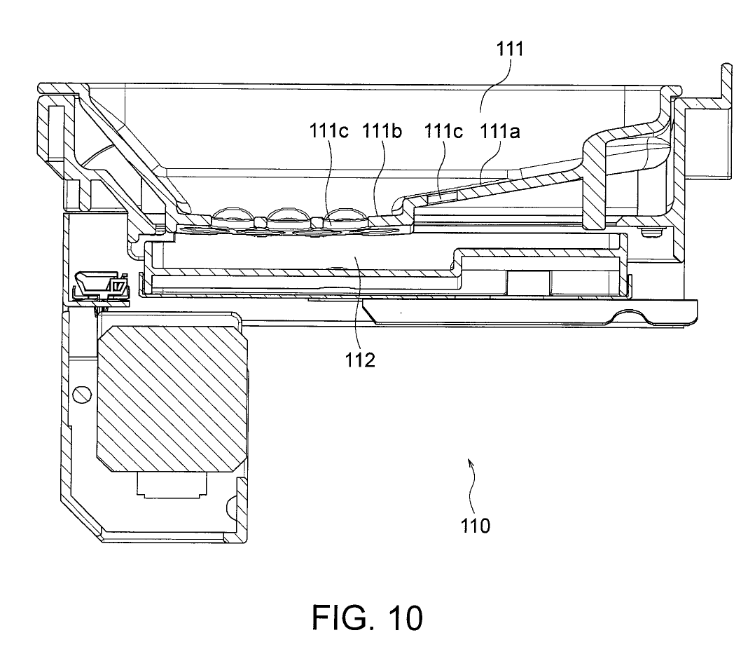

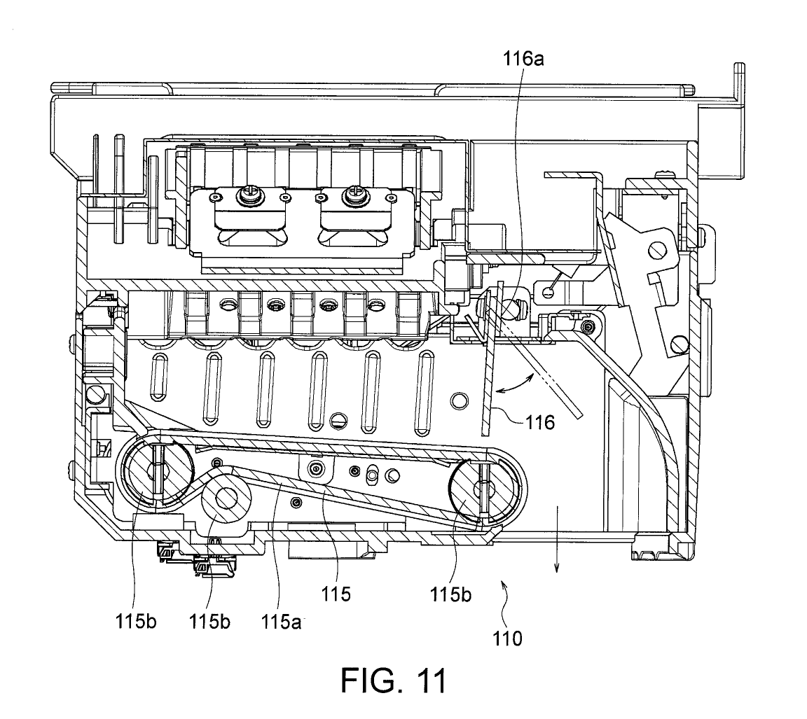

Now, a detailed configuration of the coin depositing mechanism 110 in the loose-coin depositing and dispensing device 100 will be explained by referring to FIGS. 7 to 11. FIG. 7 is a top view of a configuration of the coin depositing mechanism 110 included in the loose-coin depositing and dispensing device 100 shown in FIGS. 4 and 5. FIGS. 8 and 9 are longitudinal cross-sectional views of the coin depositing mechanism along an arrow A-A shown in FIG. 7. FIG. 10 is a longitudinal cross-sectional view of the coin depositing mechanism 110 along an arrow B-B shown in FIG. 7. FIG. 11 is a longitudinal cross-sectional view of the coin depositing mechanism 110 along an arrow C-C shown in FIG. 7.

As shown in FIGS. 7 to 11, the coin depositing mechanism 110 that deposits a coin from the outside of the housing 102 of the loose-coin depositing and dispensing device 100 to the inside thereof includes a first coin-supplying unit 111 and a second coin-supplying unit 115. The first coin-supplying unit 111 receives coins deposited into a coin depositing opening provided on the top surface of the housing 102, and removes a foreign substance, such as a clip, for example, included in the received coins. The second coin-supplying unit 115 receives the coins sent from the first coin-supplying unit 111. A chute 113 is arranged between the first coin-supplying unit 111 and the second coin-supplying unit 115. The chute 113 constitutes a coin transport path for sending coins received by the first coin-supplying unit 111 to the second coin-supplying unit 115.

The first coin-supplying unit 111 includes a tray including a first tray part 111a and a second tray part 111b. The coins deposited into the coin depositing opening are received in this tray. The second tray part 111b is arranged such that a top surface thereof is parallel to a horizontal plane. In contrast, the first tray part 111a is arranged such that a top surface thereof is inclined to the horizontal plane so that the top surface extends downwardly toward the second tray part 111b. Moreover, as shown in FIG. 7, the second tray part 111b is arranged adjacent to the chute 113. As a result, the coin received by the first tray part 111a is first sent to the second tray part 111b, and then the coin is sent from the second tray part 111b to the chute 113.

As shown in FIGS. 8 and 9, the first tray part 111a and the second tray part 111b are integrally pivotable around a shaft 111d that extends horizontally. More particularly, the first tray part 111a and the second tray part 111b are integrally pivotable between a coin receiving position shown in FIG. 8 and a coin sending position shown in FIG. 9. The coin receiving position is a position in which the first tray part 111a and the second tray part 111b receive the coins deposited into the coin depositing opening. The coin sending position is a position in which the coins received by the first tray part 111a and the second tray part 111b are sent to the chute 113. When no force acts on the first tray part 111a and the second tray part 111b, the first tray part 111a and the second tray part 111b are positioned in the coin receiving position shown in FIG. 8 by their weight. After the coins deposited into the coin depositing opening are received by the first tray part 111a and the second tray part 111b, when the operator manually integrally lifts up the first tray part 111a and the second tray part 111b to pivot the first tray part 111a and the second tray part 111b around the shaft 111d thereby moving the first tray part 111a and the second tray part 111b to the coin sending position shown in FIG. 9, the coins received by the first tray part 111a and the second tray part 111b are sent to the chute 113 by their weight. The present embodiment is not limited to the coin depositing mechanism 110 in which the first tray part 111a and the second tray part 111b are manually pivoted around the shaft 111d. As one variation, the coin depositing mechanism 110 can be provided with a driving motor (not shown) that pivots the first tray part 111a and the second tray part 111b around the shaft 111d. As another variation, the operator may send the coins received by the first tray part 111a and the second tray part 111b to the chute 113 by his hand.

In the present embodiment, a step is secured between the first tray part 111a and the second tray part 111b. That is, an end edge of the first tray part 111a on the side of the second tray part 111b is arranged at a slightly higher level than an end edge of the second tray part 111b on the side of the first tray part 111a. With this configuration, when the first tray part 111a and the second tray part 111b are moved to the coin sending position shown in FIG. 9, at first the coins received by the second tray part 111b are sent to the chute 113, and then, the coins received by the first tray part 111a are sent to the chute 113 via the second tray part 111b. As a result, a situation in which the coins received by both the first tray part 111a and the second tray part 111b rush simultaneously to the chute 113 can be avoided, and troubles such as clogging of the coins and the like can be prevented from occurring.

As shown in FIG. 7, several holes 111c for removing the foreign substance are formed in each of the first tray part 111a and the second tray part 111b. The diameter of the holes 111c is smaller than the diameter of the coins that are processed by the loose-coin depositing and dispensing device 100. As shown in FIGS. 8 and 9, a foreign substance receiving member 112 is arranged below the first tray part 111a and the second tray part 111b. The foreign substance receiving member 112 receives foreign substances that pass through the holes 111c.

As shown in FIGS. 8 and 9, the chute 113 includes a first guide member 113a that constitutes a bottom surface of the coin transport path, and a second guide member 113b that constitutes a top surface of the coin transport path. When sending the coins from the first coin-supplying unit 111 to the chute 113, those coins are transported to pass through a space between the first guide member 113a and the second guide member 113b and sent to the second coin-supplying unit 115. As shown in FIGS. 8 and 9, the first guide member 113a that constitutes the bottom surface of the coin transport path is arranged such that it is inclined to the horizontal plane so that it extends downwardly from the first coin-supplying unit 111 toward the second coin-supplying unit 115. With this configuration, the coins sent from the first coin-supplying unit 111 to the chute 113 are then sent to the second coin-supplying unit 115 by their weight. Moreover, as shown in FIGS. 8 and 9, a coin-roll transportation regulating member 113c is arranged near the second guide member 113b. A distance is secured between the first guide member 113a and the coin-roll transportation regulating member 113c. The distance between the first guide member 113a and the coin-roll transportation regulating member 113c is smaller than the diameter of coins that are processed by the loose-coin depositing and dispensing device 100. The coins sent from the first coin-supplying unit 111 to the chute 113 move toward the second guide member 113b by sliding on the first guide member 113a by their weight in a fallen state and not in a standing state. Because of the presence of the coin-roll transportation regulating member 113c, in case the operator deposits a roll of coins into the coin depositing opening of the loose-coin depositing and dispensing device 100 by mistake, because this roll of coins is caught in the coin-roll transportation regulating member 113c as the roll of coins cannot pass through the gap between the first guide member 113a and the coin-roll transportation regulating member 113c, it can be prevented that the roll of coins is sent to the later-explained second coin-supplying unit 115. When the roll of coins is caught in the coin-roll transportation regulating member 113c in this manner, the operator can insert his hand in the coin depositing opening and take out the roll of coins.

As shown in FIGS. 8 and 9, the chute 113 is provided with an openable and closable shutter 114. The shutter 114 allows or prevents transportation of the coins from the first coin-supplying unit 111 to the second coin-supplying unit 115. The shutter 114 is movable between a closed position shown in FIG. 8 and an open position shown in FIG. 9. The closed position is a position in which the shutter 114 is positioned between the first guide member 113a and the second guide member 113b to block the coin transport path. The open position is a position in which the shutter 114 is not positioned in the coin transport path but positioned above the second guide member 113b. When the shutter 114 is located in the closed position as shown in FIG. 8, the coins sent from the first coin-supplying unit 111 to the chute 113 are blocked by the shutter 114 and are not sent to the second coin-supplying unit 115. The opening and closing operation of the shutter 114 is controlled by the controlling unit 190. A coin passage detecting sensor 113p that detects passage of a coin is arranged near the shutter 114 in the chute 113 (see FIG. 12).

As shown in FIG. 11, the second coin-supplying unit 115 includes a conveyor belt 115a stretched over a plurality of pulleys 115b. The coins sent from the chute 113 to the second coin-supplying unit 115 are received on the conveyor belt 115a. A driving motor (not shown) is connected to one of the pulleys 115b. When the pulley 115b to which the driving motor is connected is rotationally driven by the driving motor, the conveyor belt 115a is caused to perform a cyclic shift in both of the clockwise direction and the counterclockwise direction in FIG. 11. When the conveyor belt 115a is caused to perform the cyclic shift in the clockwise direction in FIG. 11, the coins sent from the chute 113 to the second coin-supplying unit 115 are transported on the conveyor belt 115a on the right side in FIG. 11, and, as shown with an arrow in FIG. 11, fall from an edge of the conveyor belt 115a to be sent to the accumulating and feeding mechanism 130. In this manner, the second coin-supplying unit 115 applies force to the coins sent from the first coin-supplying unit 111 to send the coins further to the accumulating and feeding mechanism 130 that functions as a coin feeding unit. The second coin-supplying unit 115, which sends the coins to the accumulating and feeding mechanism 130 by applying the force to the coins received from the first coin-supplying unit 111, is not limited to the one having the conveyor belt 115a. As long as it is possible to send the coins to the accumulating and feeding mechanism 130 by applying the force to the coins received from the first coin-supplying unit 111, a configuration other than the conveyor belt 115a can be used for the second coin-supplying unit 115.

As shown in FIG. 11, a coin transportation-number limiting member 116 is arranged above an edge of the conveyor belt 115a on the side of the accumulating and feeding mechanism 130 (i.e., the right side in FIG. 11). The coin transportation-number limiting member 116 limits the number of coins that can be transported from the second coin-supplying unit 115 to the accumulating and feeding mechanism 130. The coin transportation-number limiting member 116 is constituted by, for example, a plate-like elastic member (concretely, a flexible material), such as polyurethane rubber. A lower end of the coin transportation-number limiting member 116 is positioned slightly above and separated from a top surface of the conveyor belt 115a. Because of the presence of the coin transportation-number limiting member 116 above the conveyor belt 115a, it can be prevented that a large number of the coins present on the conveyor belt 115a simultaneously slide and fall from the edge of the conveyor belt 115a and are sent to the accumulating and feeding mechanism 130. The coin transportation-number limiting member 116 is swingable, around a shaft 116a, between a position at which the coin transportation-number limiting member 116 is shown with a continuous line in FIG. 11 and a position at which the coin transportation-number limiting member 116 is shown with a two-dot chain line in FIG. 11. With this configuration, when sending the coins received by the conveyor belt 115a on the conveyor belt 115a to the accumulating and feeding mechanism 130, in case a coin is caught between a side wall of the second coin-supplying unit 115 and the coin transportation-number limiting member 116 whereby the coin does not fall from the conveyor belt 115a, by causing the coin transportation-number limiting member 116 to swing, the coin caught between the side wall of the second coin-supplying unit 115 and the coin transportation-number limiting member 116 can be separated and either caused to be received by the conveyor belt 115a or caused to fall in the accumulating and feeding mechanism 130. The swinging of the coin transportation-number limiting member 116 is controlled by the controlling unit 190 of the loose-coin depositing and dispensing device 100.

As shown in FIG. 12, the first coin-supplying unit 111 is provided with a first residual detecting unit 117 that detects a coin received by the first tray part 111a and/or the second tray part 111b of the first coin-supplying unit 111. Moreover, the second coin-supplying unit 115 is provided with a second residual detecting unit 118 that detects a coin received on the conveyor belt 115a of the second coin-supplying unit 115. Because of the presence of the first residual detecting unit 117 and the second residual detecting unit 118, in case a coin among the coins that were deposited into the coin depositing opening remains in the first coin-supplying unit 111 and/or the second coin-supplying unit 115 without being sent to the accumulating and feeding mechanism 130 by the coin depositing mechanism 110, this residual coin can be detected by the first residual detecting unit 117 and the second residual detecting unit 118. Moreover, the second coin-supplying unit 115 is provided with a coin storing state detecting unit 119 that detects whether the conveyor belt 115a of the second coin-supplying unit 115 is full with coins. Moreover, the accumulating and feeding mechanism 130, to which the coins are sent from the second coin-supplying unit 115, is also provided with a coin storing state detecting unit 138 that detects whether the accumulating and feeding mechanism 130 is full with coins.

The controlling unit 190 included in the loose-coin depositing and dispensing device 100 performs the following control on the coin depositing mechanism 110. Specifically, when it is not detected by the coin storing state detecting unit 138 that the accumulating and feeding mechanism 130 is full with coins, the conveyor belt 115a of the second coin-supplying unit 115 is driven to perform the cyclic shift in the clockwise direction in FIG. 11 whereby the coins received on the conveyor belt 115a of the second coin-supplying unit 115 are sent to the accumulating and feeding mechanism 130. On the other hand, when it is detected by the coin storing state detecting unit 138 that the accumulating and feeding mechanism 130 is full with coins, the cyclic shift of the conveyor belt 115a of the second coin-supplying unit 115 is stopped. By controlling the conveyor belt 115a by the controlling unit 190 in this manner, even if a large number of coins are deposited into the coin depositing opening of the loose-coin depositing and dispensing device 100, the conveyor belt 115a is driven intermittently, whereby it is prevented that a large number of coins are simultaneously sent to the accumulating and feeding mechanism 130. With this configuration, because no coin is further sent to the accumulating and feeding mechanism 130 when the accumulating and feeding mechanism 130 is full with coins, troubles that the coins overflow from the accumulating and feeding mechanism 130 and lead to jamming and the like can be prevented from occurring.

The controlling unit 190, after having sent the coins, which were sent from the first coin-supplying unit 111 to the second coin-supplying unit 115, to the accumulating and feeding mechanism 130, controls the driving of the conveyor belt 115a so that the conveyor belt 115a performs the cyclic shift only for a predetermined time in an opposite direction (i.e., the counterclockwise direction in FIG. 11), i.e., opposite of the direction in which the conveyor belt 115a performs the cyclic shift when sending the coins to the accumulating and feeding mechanism 130. Moreover, when causing the conveyor belt 115a to perform the cyclic shift in the opposite direction, i.e., opposite of the direction in which the conveyor belt 115a performs the cyclic shift when sending the coins to the accumulating and feeding mechanism 130, the controlling unit 190 causes the coin transportation-number limiting member 116 to swing around the shaft 116a so that the coins that are in contact with the coin transportation-number limiting member 116 are separated from the coin transportation-number limiting member 116. With this configuration, when sending the coins received by the conveyor belt 115a on the conveyor belt 115a to the accumulating and feeding mechanism 130, even if a coin is caught between the side wall of the second coin-supplying unit 115 and the coin transportation-number limiting member 116 whereby the coin does not fall from the conveyor belt 115a, by causing the coin transportation-number limiting member 116 to swing, the coin caught by the coin transportation-number limiting member 116 can be separated and either caused to be received on the conveyor belt 115a or caused to fall in the accumulating and feeding mechanism 130.

After the conveyor belt 115a is caused to perform the cyclic shift only for the predetermined time in the opposite direction, i.e., opposite of the direction in which the conveyor belt 115a performs the cyclic shift when sending the coins to the accumulating and feeding mechanism 130, the controlling unit 190 causes the conveyor belt 115a to perform the cyclic shift in a normal direction, i.e., the direction in which the conveyor belt 115a performs the cyclic shift when sending the coins to the accumulating and feeding mechanism 130, again. With this configuration, the coins that were received on the conveyor belt 115a after being separated from the coin transportation-number limiting member 116 can be sent to the accumulating and feeding mechanism 130.

When the coin storing state detecting unit 119 detects that the second coin-supplying unit 115 is full with coins, the controlling unit 190 closes the shutter 114 to prevent the transportation of the coins from the first coin-supplying unit 111 to the second coin-supplying unit 115. With this configuration, when the second coin-supplying unit 115 is full with coins, because no coin is further sent to the second coin-supplying unit 115 from the chute 113 as the shutter 114 is moved in the closed position, an error that the coins overflow from the second coin-supplying unit 115 and lead to jamming and the like can be prevented from occurring. Moreover, when the first residual detecting unit 117 detects that the first coin-supplying unit 111 is currently receiving the coins, the controlling unit 190 opens the shutter 114. With this configuration, in case a coin among the coins that were deposited into the coin depositing opening remains in the first tray part 111a and/or the second tray part 111b of the first coin-supplying unit 111 without being sent to the accumulating and feeding mechanism 130 by the coin depositing mechanism 110, this coin can be sent from the first coin-supplying unit 111 to the second coin-supplying unit 115 via the chute 113.

An operation of the coin depositing mechanism 110 having the above-explained configuration is explained below. When the operator inputs into the controlling unit 190 of the loose-coin depositing and dispensing device 100 a command to start a money depositing process of loose coins, the controlling unit 190 opens the shutter 114 provided in the chute 113. Moreover, the controlling unit 190 causes the conveyor belt 115a of the second coin-supplying unit 115 to perform the cyclic shift in the clockwise direction in FIG. 11. Subsequently, when the operator deposits coins into the coin depositing opening arranged on the top surface of the housing 102, the coins are received by the first tray part 111a and/or the second tray part 111b of the first coin-supplying unit 111. If a foreign substance is mixed with the coins, the foreign substance is sent to the foreign substance receiving member 112 via the holes 111c. Then, when the operator manually integrally lifts up the first tray part 111a and the second tray part 111b to pivot the first tray part 111a and the second tray part 111b around the shaft 111d thereby moving the first tray part 111a and the second tray part 111b to the coin sending position shown in FIG. 9, the coins received by the first tray part 111a and the second tray part 111b are sent to the chute 113 by their weight, and thereafter the coins are sent from the chute 113 to the second coin-supplying unit 115. The coins sent to the second coin-supplying unit 115 are received on the conveyor belt 115a. The conveyor belt 115a is caused to perform the cyclic shift in the clockwise direction in FIG. 11, whereby, as shown with the arrow in FIG. 11, the coins received on the conveyor belt 115a fall from the edge of the conveyor belt 115a to be sent to the accumulating and feeding mechanism 130.

When the coin passage detecting sensor 113p arranged in the chute 113 does not detect the passage of a coin for a predetermined time, the controlling unit 190 judges that the coins received by the first tray part 111a and/or the second tray part 111b of the first coin-supplying unit 111 have been sent to the accumulating and feeding mechanism 130. Upon making this determination, the controlling unit 190 closes the shutter 114 to prevent the transportation of the coins from the first coin-supplying unit 111 to the second coin-supplying unit 115. Also, the controlling unit 190 controls the driving of the conveyor belt 115a so that the conveyor belt 115a performs the cyclic shift only for a predetermined time in the opposite direction (i.e., the counterclockwise direction in FIG. 11), i.e., opposite of the direction in which the conveyor belt 115a performs the cyclic shift when sending the coins to the accumulating and feeding mechanism 130. Moreover, the controlling unit 190 causes the coin transportation-number limiting member 116 to swing so that the coins that are in contact with the coin transportation-number limiting member 116 are separated from the coin transportation-number limiting member 116. With this configuration, a coin caught between the side wall of the second coin-supplying unit 115 and the coin transportation-number limiting member 116 can be separated from the coin transportation-number limiting member 116 and caused to be received on the conveyor belt 115a. After the conveyor belt 115a is caused to perform the cyclic shift only for the predetermined time in the opposite direction, i.e., opposite of the direction in which the conveyor belt 115a performs the cyclic shift when sending the coins to the accumulating and feeding mechanism 130, the controlling unit 190 causes the conveyor belt 115a to perform the cyclic shift again in the normal direction (i.e., the clockwise direction in FIG. 11), i.e., the direction in which the conveyor belt 115a performs the cyclic shift when sending the coins to the accumulating and feeding mechanism 130. With this configuration, the coins that were received on the conveyor belt 115a after being separated from the coin transportation-number limiting member 116 can be sent to the accumulating and feeding mechanism 130.

The coin depositing mechanism 110 explained above includes the first coin-supplying unit 111 that receives the coins deposited into the coin depositing opening of the loose-coin depositing and dispensing device 100 and removes the foreign substance mixed with the coin, and the second coin-supplying unit 115 that receives the coins sent from the first coin-supplying unit 111. The second coin-supplying unit 115 applies a force to the coins sent from the first coin-supplying unit 111 to send the coins further to the accumulating and feeding mechanism 130 that functions as the coin feeding unit. With this configuration, the foreign substance included in the coin can be removed and, because the coins are sent to the accumulating and feeding mechanism 130 from two units of the coin-supplying units arranged in tandem, i.e., the first coin-supplying unit 111 and the second coin-supplying unit 115, even if a large number of coins are deposited into the coin depositing opening, the coins can be surely sent to the accumulating and feeding mechanism 130 without the occurrence of troubles such as jamming of the coin.

The loose-coin depositing and dispensing device 100 according to the present embodiment includes the fitness determining unit 122b (see FIG. 12) that determines whether a coin deposited in the loose-coin depositing and dispensing device 100 is a fit coin or an unfit coin. As explained above, an unfit coin is a coin whose surface has been damaged by rust, dirt, and the like, a partially defective coin, a deformed coin, and the like. Moreover, the loose-coin depositing and dispensing device 100 according to the present embodiment includes an unfit money storing unit that stores therein the coin that is determined by the fitness determining unit 122b as being an unfit coin. More particularly, at least one among the plurality of the storing and feeding mechanisms 150, which stores therein coins and feeds the stored coins, is used as the unfit money storing unit. With this configuration, when a coin fed from the accumulating and feeding mechanism 130 is recognized by the recognition unit 122 and the coin is determined to be an unfit coin by the fitness determining unit 122b, the sorting member 124 corresponding to the storing and feeding mechanism 150 that is used as the unfit money storing unit is operated to send the unfit coin from the deposited money transporting unit 120 to the storing and feeding mechanism 150 via the chute 126, and the unfit coin is stored in the storing and feeding mechanism 150. The unfit coin that is stored in the storing and feeding mechanism 150 used as the unfit money storing unit is not fed from the storing and feeding mechanism 150 when dispensing the money thereby preventing reuse of the unfit coin as a dispensing coin. When collecting the unfit coins stored in the storing and feeding mechanism 150 outside of the device, the unfit coins can be fed from the storing and feeding mechanism 150 and collected.

Instead of using at least one among the plurality of the storing and feeding mechanisms 150 as the unfit money storing unit, the overflow coin storing unit 180 can be used as the unfit money storing unit. When the overflow coin storing unit 180 is used as the unfit money storing unit, when a coin fed from the accumulating and feeding mechanism 130 is recognized by the recognition unit 122 and the coin is determined to be an unfit coin by the fitness determining unit 122b, the overflow sorting member 123 is operated to send the unfit coin on the endless belt 170p of the dispensing money transporting unit 170 from the deposited money transporting unit 120 via the overflow chute 125. The unfit coin that has been sent on the endless belt 170p of the dispensing money transporting unit 170 via the overflow chute 125 is sent to the overflow coin storing unit 180 by causing the endless belt 170p to perform the cyclic shift in the clockwise direction in FIG. 4.

Alternatively, at least one among the plurality of the storing and feeding mechanisms 150 can be used as the unfit money storing unit, and those unfit coins that cannot be stored in the unfit money storing unit because the number of the unfit coins stored in the unfit money storing unit has reached a predetermined capacity can be stored in the overflow coin storing unit 180.

Alternatively, when using at least one among the plurality of the storing and feeding mechanisms 150 as the unfit money storing unit, the controlling unit 190 can be caused to output information to prompt the operator to collect the unfit coins from the unfit money storing unit. The operation and displaying unit 40, the light emitting diodes (LED) 90 and 92, a speaker (not shown), and the like can be used as an output device that outputs such information. Specifically, when this information is received by the operation and displaying unit 40, a message such as “please open the door of the housing and collect the unfit coins stored in the unfit money storing unit” can be displayed on the operation and displaying unit 40. Moreover, a pictorial image indicating the internal configuration of the money changer 10 can be displayed on the operation and displaying unit 40, and the storing and feeding mechanism 150 used as the unfit money storing unit is highlighted by a different color and the like in this pictorial image. As shown in FIG. 12, a first setting unit 196 is connected to the controlling unit 190. The first setting unit 196 sets, whether, when the number of the unfit coins stored in the unfit money storing unit has reached the predetermined capacity, to output the information to prompt the operator to collect the unfit coins from the unfit money storing unit or to store the unfit coins that cannot be stored in the unfit money storing unit in the overflow coin storing unit 180. Such setting of the first setting unit 196 can be accomplished by the operator by inputting setting contents into the controlling device 20 by using the operation and displaying unit 40.

Moreover, regardless of the above explained methods, when a predetermined condition is satisfied, the controlling unit 190 can be caused to output the information to prompt the operator to collect the unfit coins from the unfit money storing unit. The predetermined condition includes the following various conditions. For example, the predetermined condition can be a situation that the number of the unfit coins stored in the unfit money storing unit has reached the predetermined capacity. Alternatively, the predetermined condition can be a situation that the total number of banknotes and coins stored in the money changer 10 has reached a predetermined capacity. Alternatively, the predetermined condition can be a situation that an operating time of the money changer 10 has reached a predetermined time.

In the present embodiment, the storing and feeding mechanism 150 or the overflow coin storing unit 180 that is used as the unfit money storing unit can be partitioned into a plurality of coin storing areas, and unfit coins of different denominations can be stored in different coin storing areas. With this configuration, because it is possible to separate the unfit coins depending on their denomination when storing the unfit coins in the unfit money storing unit, it is possible to facilitate the management of the unfit coins. Alternatively, the storing and feeding mechanism 150 or the overflow coin storing unit 180 that is used as the unfit money storing unit can be partitioned into a plurality of coin storing areas; however, whether to store the unfit coins in the partitioned coin storing areas depending on the denomination, or to store the unfit coins in the unfit money storing unit with the denominations mixed, can be set by using a second setting unit 197 (see FIG. 12) connected to the controlling unit 190. With this configuration, because whether to store the unfit coins in the unfit money storing unit in the separate denominations or the mixed denominations can be selected depending on the mode of use, the operation flexibly can be improved.

As shown in FIG. 12, a fitness determination method setting unit 198 is connected to the controlling unit 190. A method used by the fitness determining unit 122b to determine whether a deposited coin is a fit coin or an unfit coin can be changed by using the fitness determination method setting unit 198. Specifically, as explained above, an unfit coin is typically a coin whose surface has been damaged by rust, dirt, and the like, a partially defective coin, a deformed coin, and the like; however, factors used by the fitness determining unit 122b in this determination vary depending on the type of the unfit coins. Specifically, a face-side image of the coin is captured in the recognition unit 122, this captured face-side image of the coin and a face-side image of a reference fit coin previously stored in a memory are compared, a degree of stain, a degree of damage and/or a degree of deformation of the coin is calculated from this comparison, and a determination is made whether the coin is a fit coin or an unfit coin from the calculated degree of stain, the degree of damage and/or the degree of deformation. Moreover, the weight of the coin is detected in the recognition unit 122, and a determination of the damage of the coin can also be made based on comparison of the detected weight of the coin with a weight of the reference fit coin. Furthermore, a thickness of the coin is detected in the recognition unit 122, and a determination of whether the coin is a deformed coin, i.e., whether the coin is a fit coin or an unfit coin, can be made based on the thickness of the coin. In this manner, the fitness determining unit 122b uses various determination methods to determine whether the deposited coin is a fit coin or an unfit coin, and the present embodiment makes it possible to change the determination methods used by the fitness determination method setting unit 198 or to change the threshold between the fit coin and the unfit coin used in the determination.

As explained above, in a configuration in which the returning unit (the reject unit), to which the coin that is determined by the genuineness determining unit 122a of the recognition unit 122 as a counterfeit coin is sent as a reject coin, is arranged near the coin ejection opening 172, the coin that is determined by the fitness determining unit 122b as an unfit coin can also be sent to the same returning unit.

According to the loose-coin depositing and dispensing device 100 explained above, because the unfit coin that is not suitable for circulation in the market can be automatically separated from the fit coin inside the body, and the unfit coin can be stored inside the body of the loose-coin depositing and dispensing device 100 (specifically, in the storing and feeding mechanism 150 or the overflow coin storing unit 180 used as the unfit money storing unit), it can be prevented that the unfit coin is ejected outside the body of the loose-coin depositing and dispensing device 100.

The loose-coin depositing and dispensing device 100 according to the present embodiment includes, as mentioned above, the version determining unit 122c (see FIG. 12) that determines whether the deposited coin is a new version coin, i.e., a coin that is currently in circulation, or an old version coin, i.e., a coin that is currently not in circulation. The loose-coin depositing and dispensing device 100 according to the present embodiment can be provided with an old version money storing unit to stores therein the coin that is determined by the version determining unit 122c as an old version coin. More particularly, at least one among the plurality of the storing and feeding mechanisms 150, which stores therein coins and feeds the stored coins, can be used as the old version money storing unit. With this configuration, when a coin fed from the accumulating and feeding mechanism 130 is recognized by the recognition unit 122 and the coin is determined to be an old version coin by the version determining unit 122c, the sorting member 124 corresponding to the storing and feeding mechanism 150 that is used as the old version money storing unit is operated to send the old version coin from the deposited money transporting unit 120 to the storing and feeding mechanism 150 via the chute 126, and the old version coin is stored in the storing and feeding mechanism 150. The old version coin that is stored in the storing and feeding mechanism 150 used as the old version money storing unit is not fed from the storing and feeding mechanism 150 when dispensing the money thereby preventing reuse of the old version coin as a dispensing coin. When collecting the old version coins stored in the storing and feeding mechanism 150 outside of the device, the old version coins can be fed from the storing and feeding mechanism 150 and collected.

Instead of using at least one among the plurality of the storing and feeding mechanisms 150 as the old version money storing unit, the overflow coin storing unit 180 can be used as the old version money storing unit. In this case, when a coin fed from the accumulating and feeding mechanism 130 is recognized by the recognition unit 122 and the coin is determined to be an old version coin by the version determining unit 122c, the overflow sorting member 123 is operated to send the old version coin on the endless belt 170p of the dispensing money transporting unit 170 from the deposited money transporting unit 120 via the overflow chute 125. The old version coin that has been sent on the endless belt 170p of the dispensing money transporting unit 170 via the overflow chute 125 is sent to the overflow coin storing unit 180 by causing the endless belt 170p to perform the cyclic shift in the clockwise direction in FIG. 4.

According to the loose-coin depositing and dispensing device 100 explained above, because the old version coin that is not suitable for circulation in the market can be automatically separated from the new version coin inside the body, and the old version coin can be stored inside the body of the loose-coin depositing and dispensing device 100 (specifically, in the storing and feeding mechanism 150 or the overflow coin storing unit 180 used as the old version money storing unit), it can be prevented that the old version coin is ejected outside the body of the loose-coin depositing and dispensing device 100.

Instead of using the loose-coin depositing and dispensing device 100 provided with the fitness determining unit 122b and the version determining unit 122c as a component of the money changer 10, the loose-coin depositing and dispensing device 100 can be used as a separate money depositing and dispensing machine. With this configuration, the loose-coin depositing and dispensing device 100 that is used as the money depositing and dispensing machine can be configured to store inside the body a coin that is determined to be a fit coin by the fitness determining unit 122b and use that stored fit coin as a dispensing coin. In contrast, a coin that is determined to be an unfit coin by the fitness determining unit 122b is stored inside the body but this stored unfit coin is not used as a dispensing coin. Moreover, the loose-coin depositing and dispensing device 100 that is used as the money depositing and dispensing machine can be configured to store inside the body a coin that is determined to be a new version coin by the version determining unit 122c and use that stored new version coin as a dispensing coin. In contrast, a coin that is determined to be an old version coin by the version determining unit 122c is stored inside the body but this stored old version coin is not used as a dispensing coin.

### Configuration of Loose-Banknote Depositing and Dispensing Device

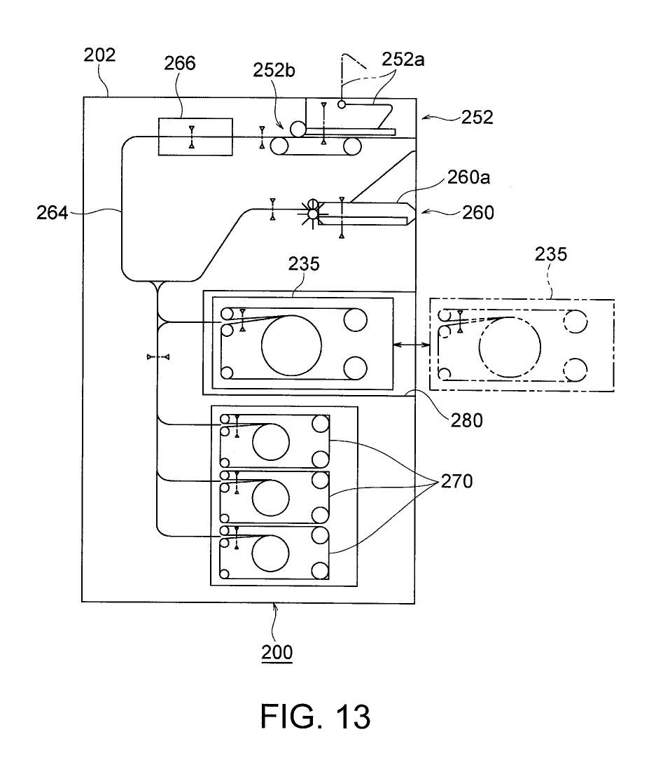

A configuration of the loose-banknote depositing and dispensing device 200 included in the money changer 10 according to the present embodiment is explained below by referring to FIG. 13. FIG. 13 is a side view of an internal configuration of the loose-banknote depositing and dispensing device 200 included in the money changer shown in FIG. 1 and the like.

As shown in FIGS. 1, 2, and 13, the loose-banknote depositing and dispensing device 200 includes a housing 202 having a substantially cuboidal shape. A money depositing unit 252 and a money dispensing unit 260 are arranged on a front surface (the right side in FIG. 13) of the housing 202. The money depositing unit 252 is provided with a money depositing unit cover 252a and a banknote feeding mechanism 252b. When the operator wants to deposit few banknotes in the loose-banknote depositing and dispensing device 200, he places those banknotes in the money depositing unit 252 in a stacked manner. Those banknotes are then fed one by one to the inside of the housing 202 by the banknote feeding mechanism 252b. When the operator wants to deposit a large number of banknotes, he opens the cover 252a and sets those banknotes in the money depositing unit 252. Those banknotes are then fed one by one to the inside of the housing 202 by the banknote feeding mechanism 252b. A transporting unit 264 is arranged inside the housing 202 of the loose-banknote depositing and dispensing device 200. The transporting unit 264 transports one by one the banknotes fed inside the housing 202 by the banknote feeding mechanism 252b. The transporting unit 264 is provided with a recognition unit 266. The recognition unit 266 recognizes a denomination, authentication, fitness, version (new or old), and the like of the banknote fed inside the housing 202 by the banknote feeding mechanism 252b.

Moreover, a plurality of storing and feeding units 270 is arranged inside the housing 202. The storing and feeding units 270 are connected to the transporting unit 264. Each of the storing and feeding units 270 stores therein banknotes of a particular denomination. More particularly, based on a recognition result obtained in the recognition unit 266, the banknote fed inside the housing 202 by the banknote feeding mechanism 252b is sent to one of the storing and feeding units 270 by the transporting unit 264 based on the denomination of the banknote. Moreover, each of the storing and feeding units 270 can feed the banknotes one by one stored in the storing and feeding unit 270 to the transporting unit 264. Each of the storing and feeding units 270 can be a tape-reel style storing and feeding unit shown in FIG. 13 that pinches a banknote between a pair of tapes and winds the banknote pinched by the tapes. Alternatively, each of the storing and feeding units 270 can be a stacker style storing and feeding unit (not shown) that stores the banknotes in a stacked manner.

As shown in FIG. 13, a cassette mounting unit 280, in which a cash transportation cassette 235 can be mounted detachably, is arranged inside the housing 202. The cassette mounting unit 280 is connected to the transporting unit 264. When the cash transportation cassette 235 is mounted in the cassette mounting unit 280, the banknotes can be sent to the cash transportation cassette 235 from the transporting unit 264, and the banknotes stored in the cash transportation cassette 235 can be fed to the transporting unit 264. By pulling out the cash transportation cassette 235 from the housing 202, the banknotes can be collected together with the cash transportation cassette 235.

The money dispensing unit 260 is provided with a money dispensing unit shutter 260a. After the banknotes are sent to the money dispensing unit 260, the operator can open the money dispensing unit shutter 260a and take out the banknotes stacked in the money dispensing unit 260. Alternatively, the money dispensing unit shutter 260a can be opened automatically after the money dispensing is completed.

### Configuration of Coin-Roll Ejecting Device

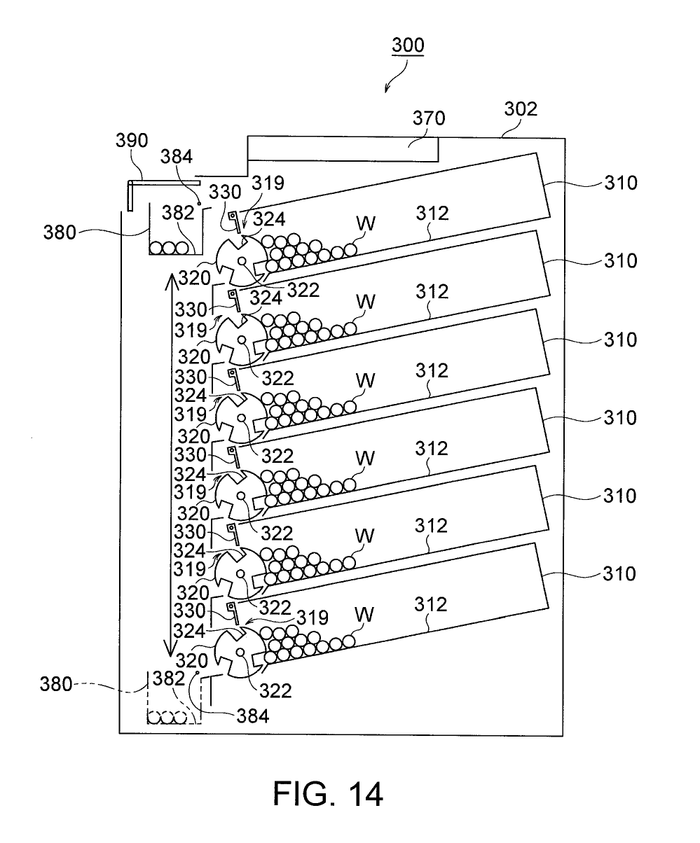

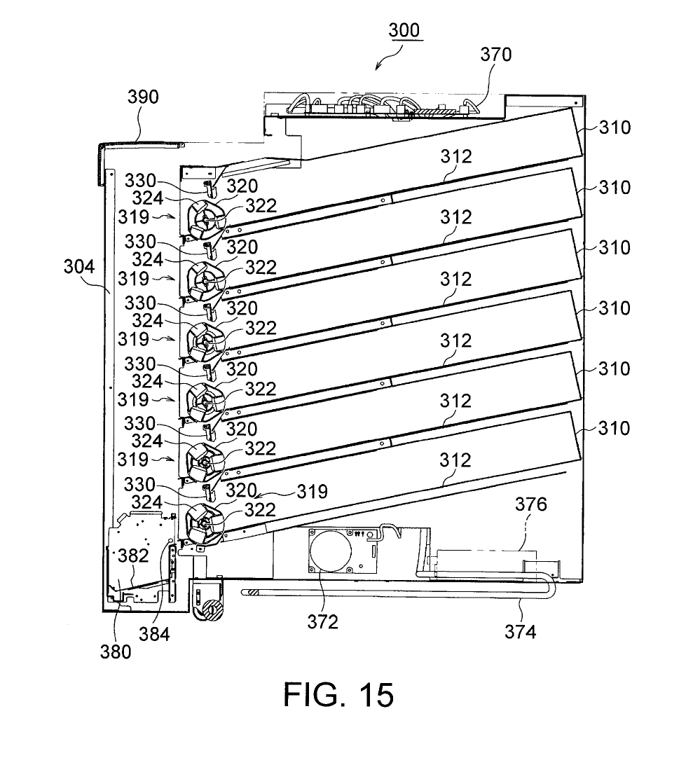

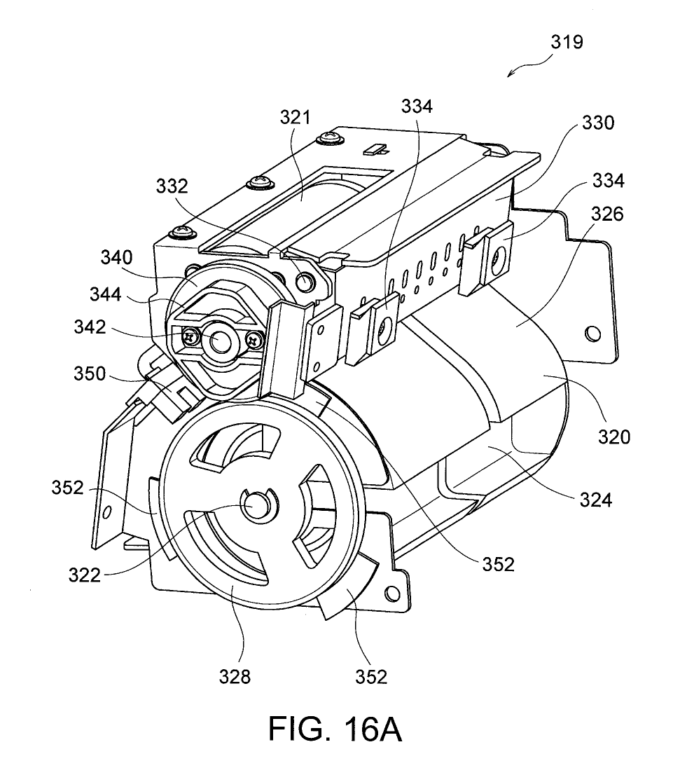

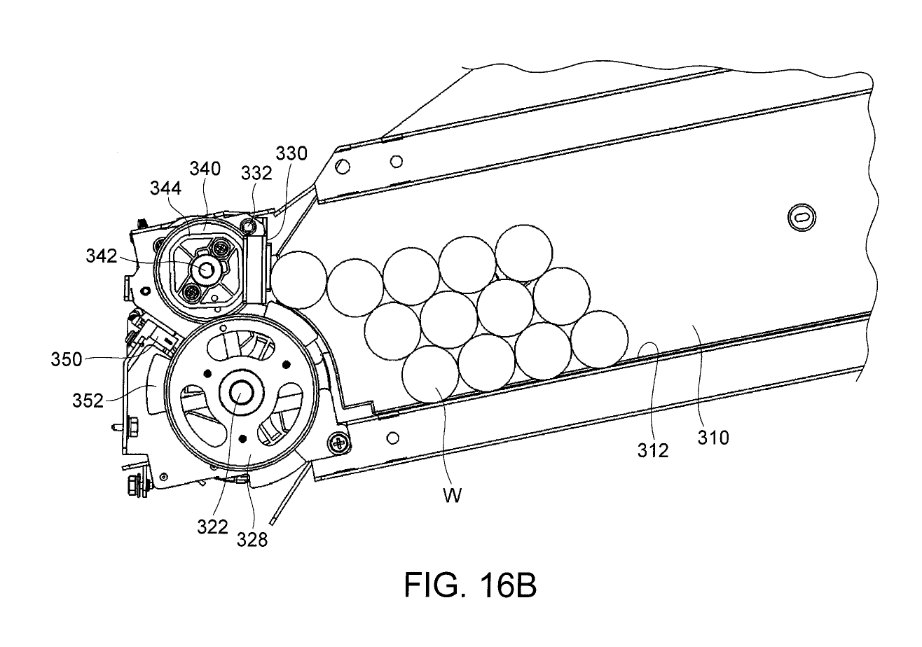

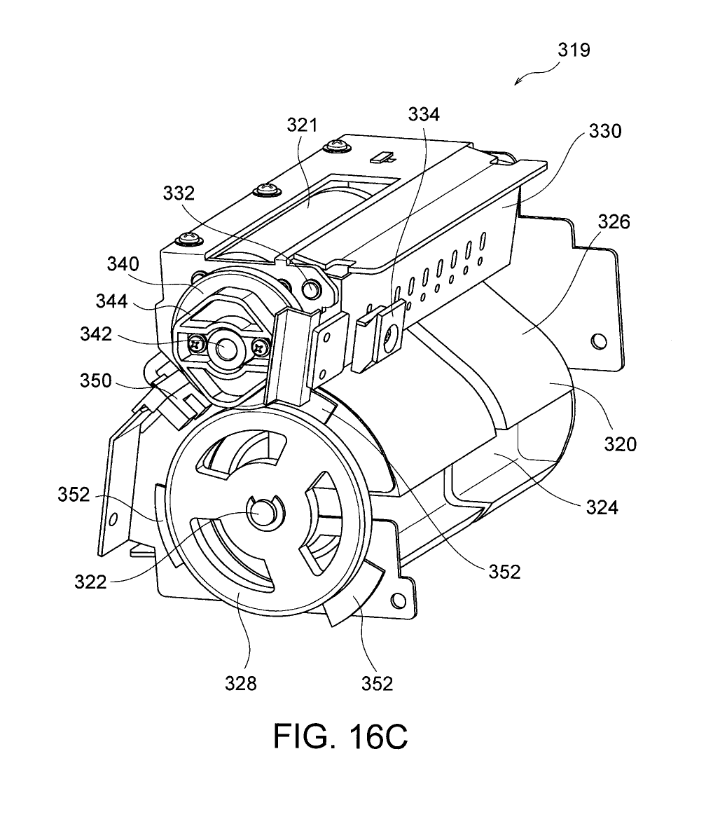

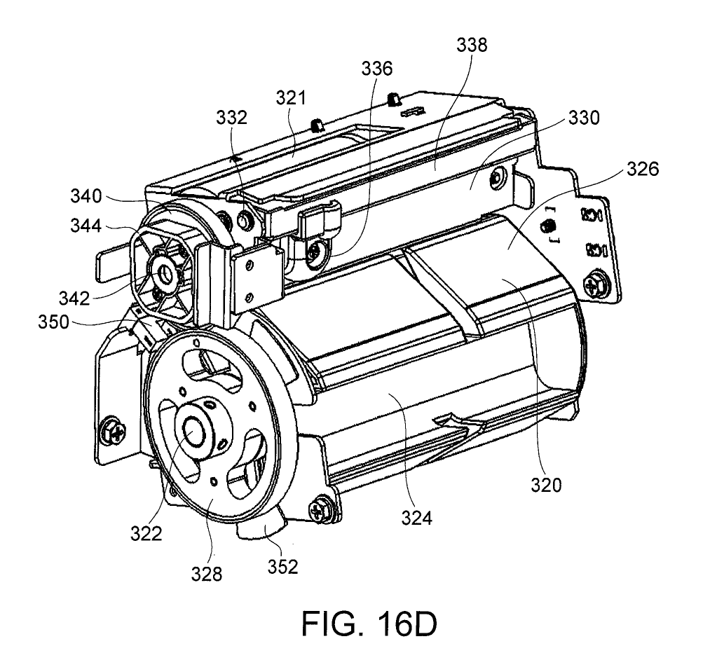

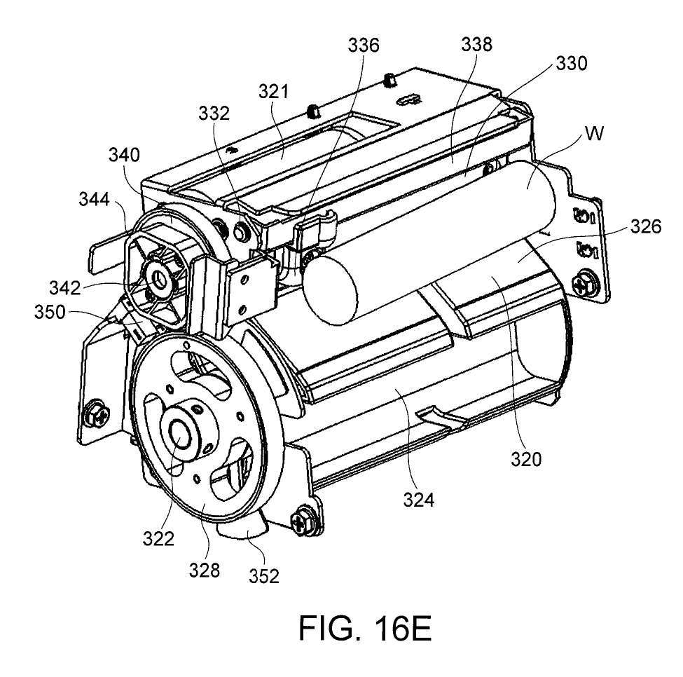

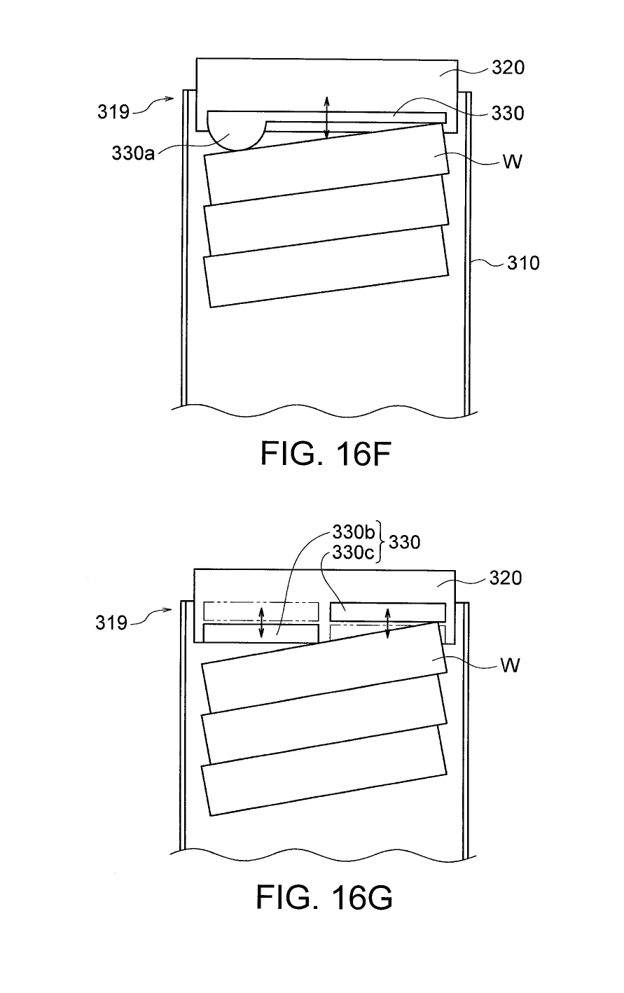

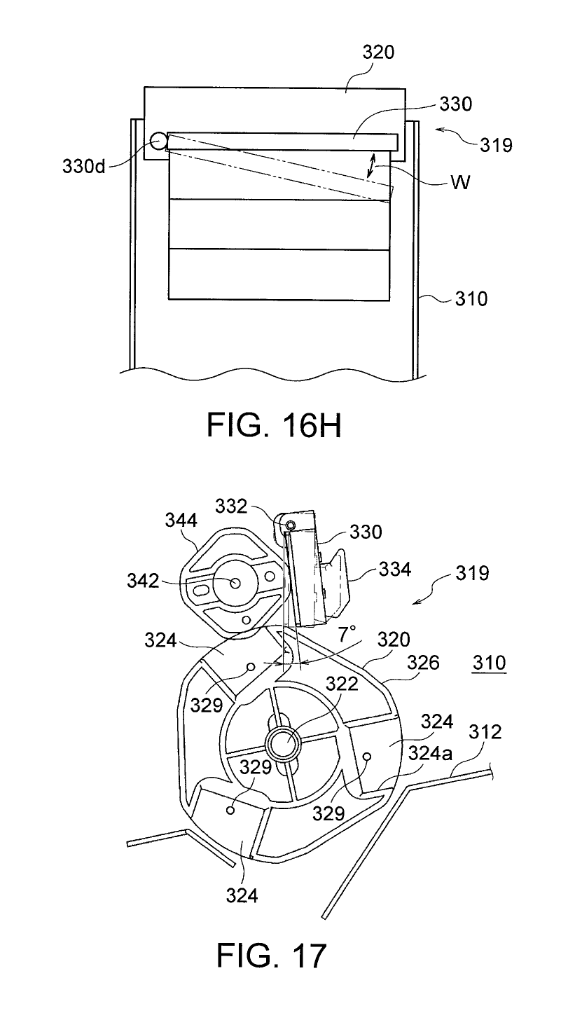

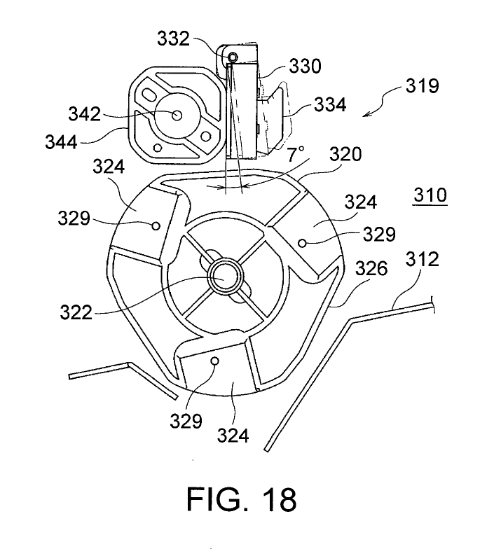

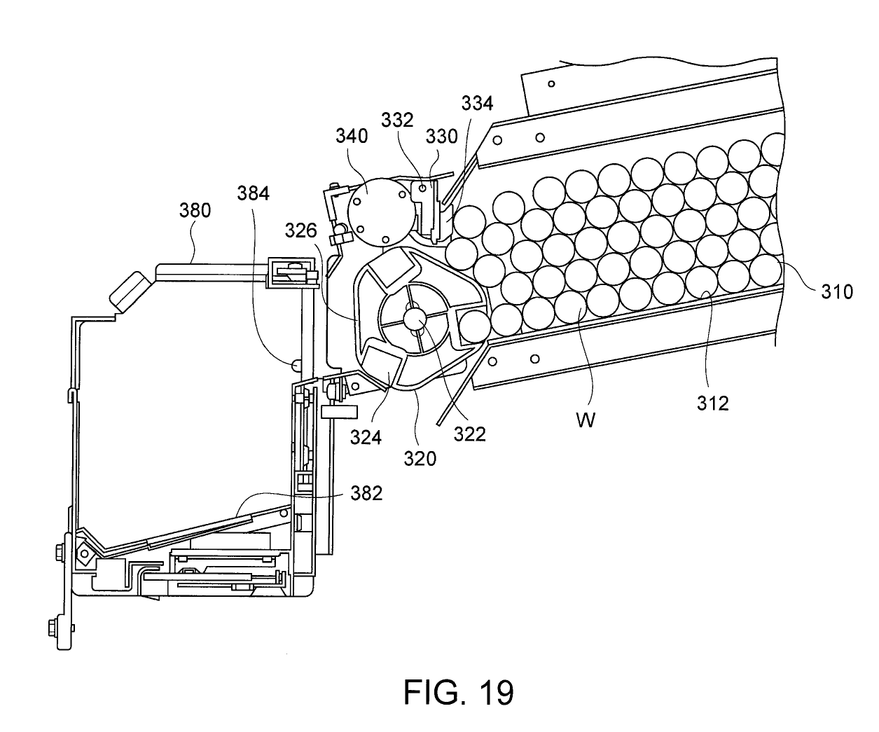

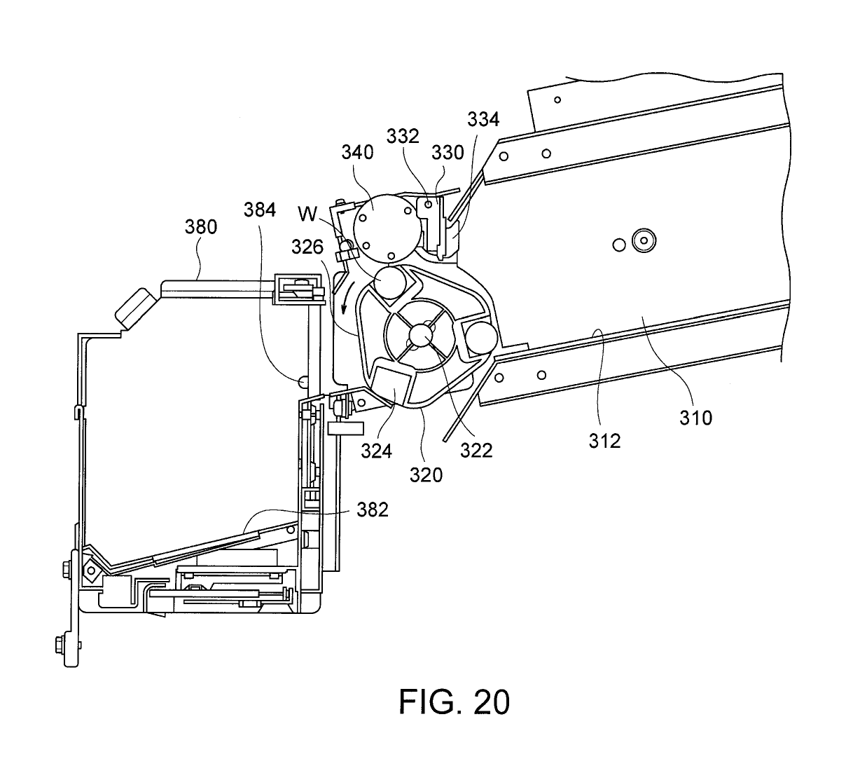

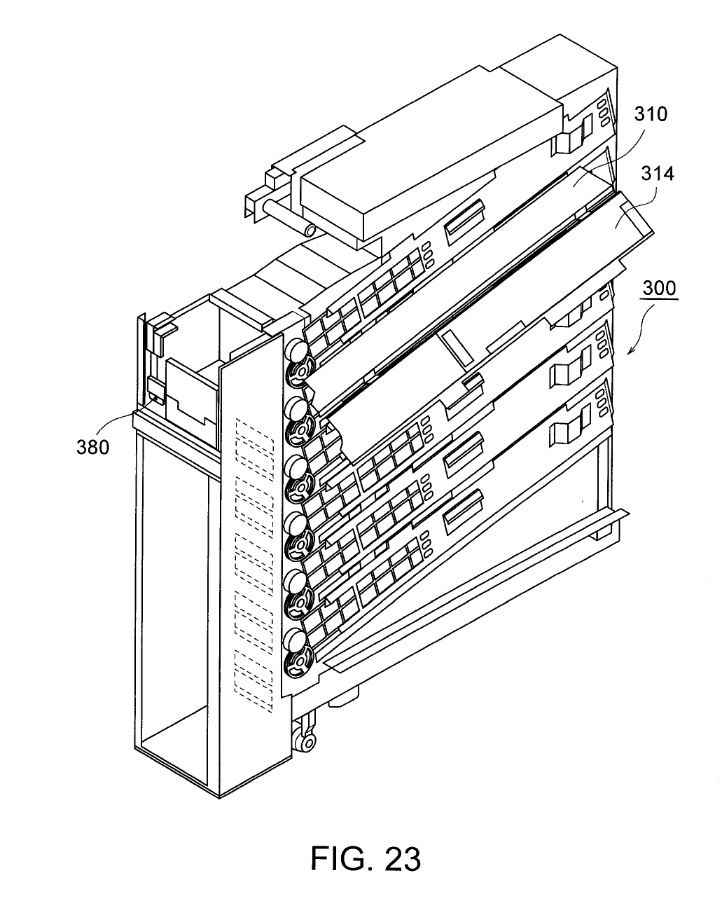

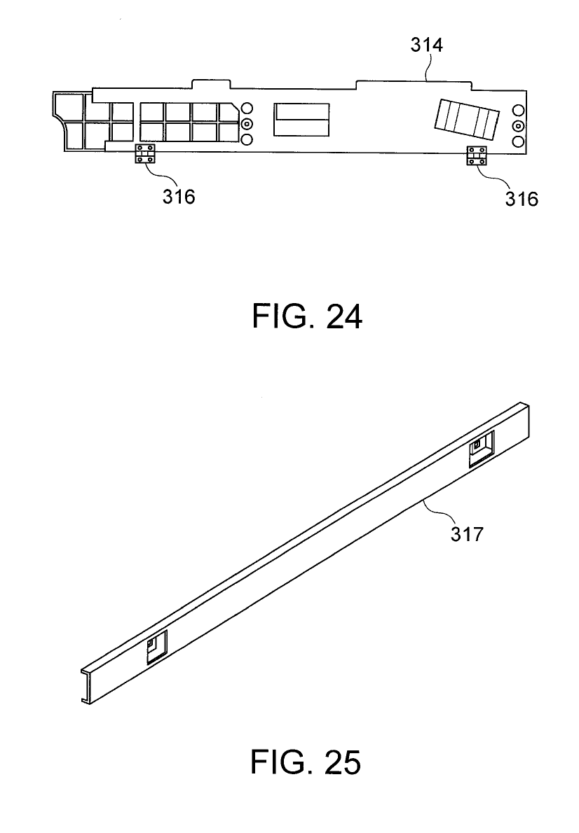

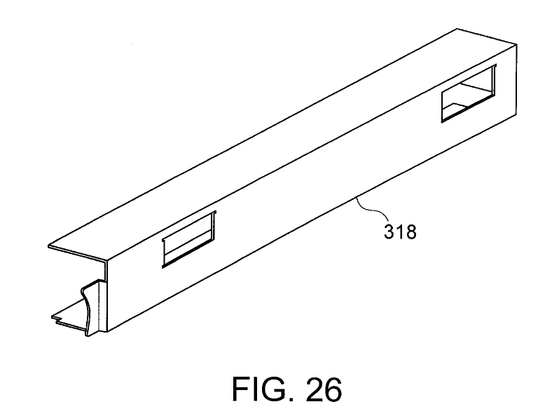

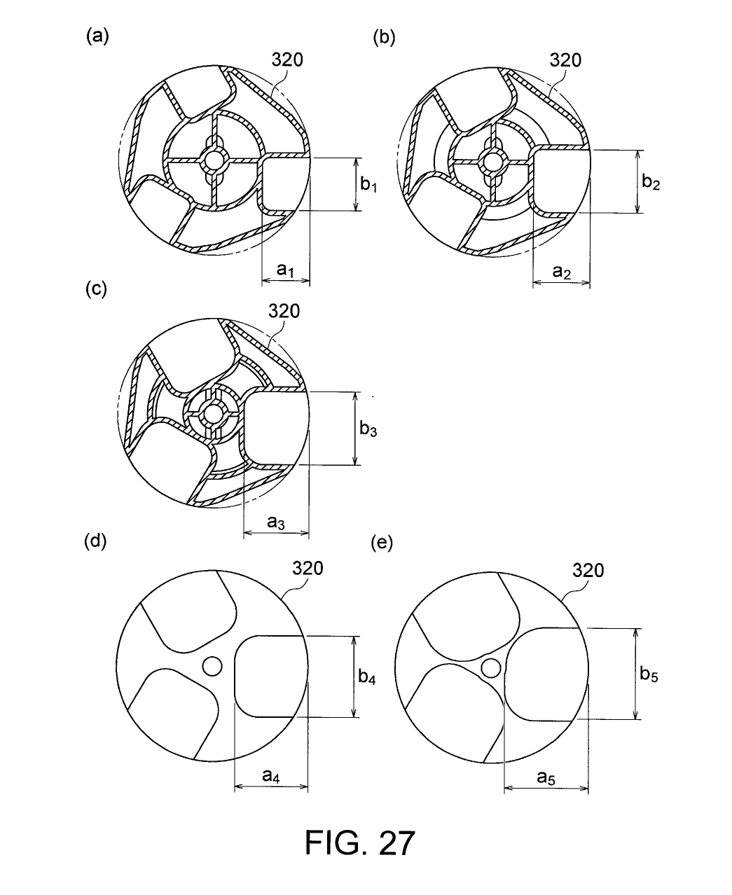

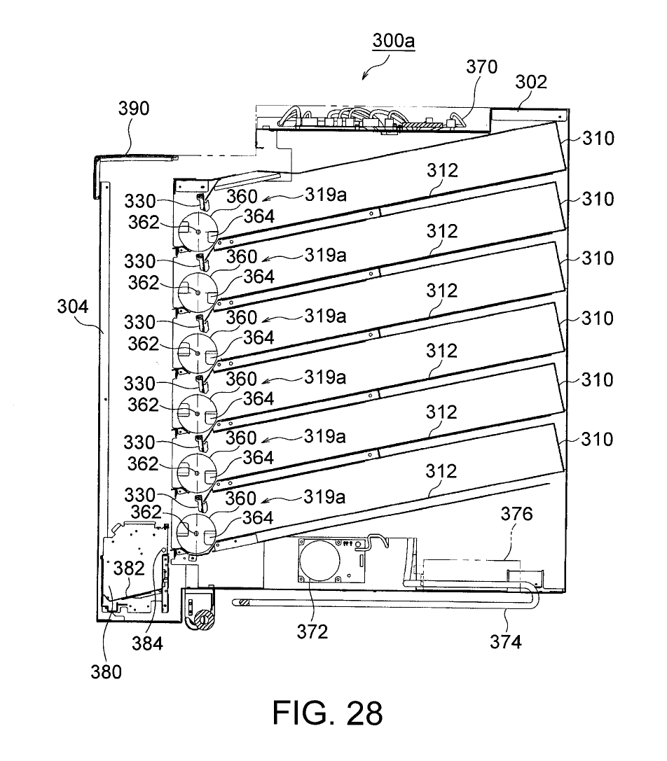

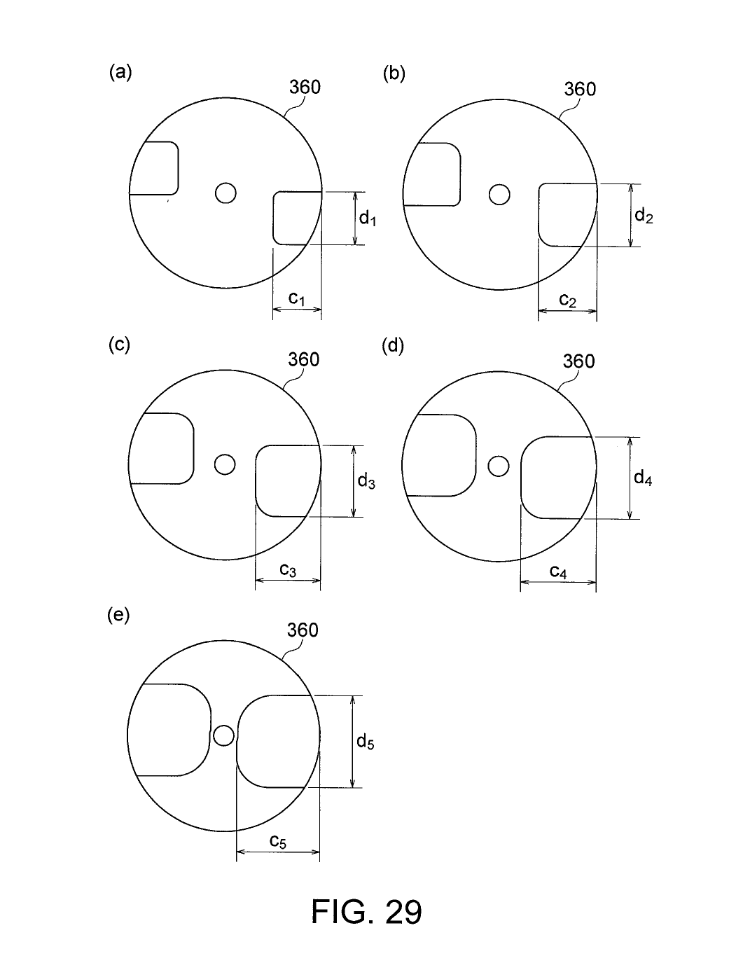

A configuration of the coin-roll ejecting device 300 included in the money changer 10 according to the present embodiment is explained below by referring to FIGS. 14 to 29. FIG. 14 is a side view of an internal configuration of the coin-roll ejecting device 300 included in the money changer 10 shown in FIG. 1 and the like. FIG. 15 is a side view of a detailed configuration of a plurality of storing units 310 and a lifting unit 380 included in the coin-roll ejecting device 300 shown in FIG. 14. FIG. 16A is a perspective view of a configuration of an ejecting mechanism 319 included in each of the storing units 310 of the coin-roll ejecting device 300 shown in FIG. 14 and the like. FIG. 16B is a side view of a situation in which a bridge phenomenon of rolls of coins has occurred near the ejecting mechanism 319 in the storing unit 310 of the coin-roll ejecting device 300 shown in FIG. 14 and the like. FIGS. 16C to 16H are views of various configurations of the ejecting mechanism 319 included in each of the storing units 310 of the coin-roll ejecting device 300 shown in FIG. 14 and the like. FIGS. 17 and 18 are side views of the ejecting mechanism 319 shown in FIG. 16A. FIGS. 19 to 22 are side views of the coin-roll ejecting device 300 shown in FIG. 14 and the like indicating an operation performed by the ejecting mechanism 319 of ejecting a roll of coins stored in the storing unit 310. FIG. 23 is a perspective view of a configuration of the storing units 310 and the lifting unit 380 included in the coin-roll ejecting device 300 shown in FIG. 14 and the like in a state in which a door 314 of one of the storing units 310 is open. FIG. 24 is a structural diagram of a configuration of the door 314 included in the coin-roll ejecting device 300 shown in FIG. 23. FIGS. 25 and 26 are perspective views of configurations of storing area width adjusting members 317 and 318 used to adjust a width of a storing area of each of the storing units 310 in the coin-roll ejecting device 300 shown in FIG. 14 and the like. FIG. 27 are views of configurations of other variations of rotating members 320 usable in the ejecting mechanism 319 included in the storing unit 310 of the coin-roll ejecting device 300 shown in FIG. 14 and the like. FIG. 28 is a side view of an internal configuration of other variation of a coin-roll ejecting device 300a usable in the money changer 10 shown in FIG. 1 and the like. FIG. 29 are views of configurations of other variations of rotating members 360 usable in an ejecting mechanism 319a included in the storing unit 310 of the coin-roll ejecting device 300a shown in FIG. 28. In FIGS. 14 to 29, the rolls of coins processed by the coin-roll ejecting devices 300 and 300a are shown with a reference letter W. Moreover, the roll of coins stored in the storing unit 310 is omitted in FIGS. 20 to 22 and the like, for simplification.

As shown in FIGS. 14 and 15, the coin-roll ejecting device 300 includes a housing 302 having a substantially cuboidal shape, a plurality of (e.g., six) the storing units 310 that are arranged inside the housing 302 one above the other in the vertical direction, and the lifting unit 380 capable of moving in the vertical direction. Each of the storing units 310 includes a bottom surface 312 and the ejecting mechanism 319 that ejects the rolls of coins one by one from near the bottom surface 312 that is at a lower level with respect to the vertical direction. The lifting unit 380 includes a coin-roll storing member 382 in which a roll of coins ejected by the ejecting mechanism 319 of each of the storing units 310 is stored, and an ejected coin-roll detecting unit 384 that detects a roll of coins ejected by the ejecting mechanism 319 of each of the storing units 310. Moreover, a shutter 390 for opening and closing a coin-roll ejection opening is arranged on the top surface of the housing 302. When the lifting unit 380 is at an up position (i.e., when the lifting unit 380 is at a position where it is shown with a continuous line in FIG. 14), the shutter 390 can be opened and the rolls of coins stored in the coin-roll storing member 382 of the lifting unit 380 can be taken out. Moreover, a controlling unit 370 is arranged in an upper part of the coin-roll ejecting device 300. The controlling unit 370 controls the ejecting mechanism 319 of each of the storing units 310 and the lifting unit 380. A detailed explanation of various components of the coin-roll ejecting device 300 is given below.

As shown in FIGS. 14 and 19, in each of the storing units 310, the rolls of coins are stored on the bottom surface 312 in a piled-up manner and along a rolling direction of the inclined bottom surface 312 with respect to a horizontal plane (i.e., a lower left direction in FIGS. 14 and 19). The term “to store the rolls of coins in a piled-up manner” includes, depending on the number of the rolls of coins stored in the storing unit 310, a situation where the rolls of coins are piled-up in several layers on the bottom surface 312, a situation where the rolls of coins are lined-up in one layer (one row) on the bottom surface 312, or a situation where there is only one roll of coins. Moreover, the rolls of coins may be stored in an orderly and properly aligned manner, or the rolls of coins may be stored in a non-orderly manner although their directions may be aligned. That is, what is meant here is that, although the rolls of coins can be piled-up in several layers, it is not necessary that the rolls of coins are piled-up in several layers, and it is not necessary that the rolls of coins are properly aligned.

An angle of inclination of the bottom surface 312 of each of the storing units 310 with respect to the horizontal plane is within a range of 8 degrees to 20 degrees. Moreover, the maximum static friction coefficient of the bottom surface 312 of each of the storing units 310 with respect to the roll of coins is within a range of 0.01 to 0.15. As a result, the rolls of coins that are in contact with the bottom surface 312 among the rolls of coins stored in each of the storing units 310 slide or roll by their weight along the inclined bottom surface 312 toward the ejecting mechanism 319 without being stopped by a frictional force between them and the bottom surface 312.

Each of the storing units 310 includes a pair of side walls that constitutes a storing area for the rolls of coins. As shown in FIG. 23, at least one of the pair of the side walls constitutes the door 314 that is opened when replenishing the rolls of coins in the storing unit 310 or taking out the rolls of coins from the storing unit 310. The side wall of the storing unit 310 that constitutes the door 314 is made from a transparent member or a semi-transparent member, for example, so that the operator can see inside the storing unit 310 through this side wall. Instead of making the door 314 with a transparent member or a semi-transparent member, the door 314 can be provided with a slit, a hole, and the like, to allow the operator to see inside the storing unit 310. As shown in FIG. 24, a lower edge of the door 314 is provided with two hinges 316, for example. The door 314 is attached in an openable and closable manner to a side of the housing 302 of the coin-roll ejecting device 300 with the hinges 316. With this configuration, when the operator wants to replenish rolls of coins in each of the storing units 310, he can open the door 314 and insert the rolls of coins into each of the storing units 310 from a side thereof.

A first storing area width adjusting member 317 and a second storing area width adjusting member 318 (see FIGS. 25 and 26) for adjusting a width of the storing area of the storing unit 310 are detachably attached to at least one of the pair of the side walls of the storing unit 310, specifically, to a side wall opposite to the side wall that constitutes the door 314. Several types of the storing area width adjusting members 317 and 318 are prepared previously depending on the longitudinal length of the roll of coins. The width of the storing area of the storing unit 310 can be changed by attaching an appropriate one of the storing area width adjusting members 317 and 318 to the side wall. The storing area width adjusting member used to adjust the width of the storing area of the storing unit 310 is not limited to the one shown in FIGS. 25 and 26. The storing area width adjusting members of three or more types can be prepared previously. In the present embodiment, the rolls of coins of the various denominations can be stored in the storing units 310 of the coin-roll ejecting device 300. Specifically, by replacing the storing area width adjusting members 317 and 318 attached to the side wall of the storing unit 310 based on the denomination of the roll of coins stored in each of the storing units 310, the width of the storing area of the storing unit 310 can be changed to a width appropriate for the denomination of the rolls of coins to be stored.

Instead of preparing several types of the storing area width adjusting members 317 and 318 depending on the longitudinal length of the roll of coins, one storing area width adjusting member can be provided in a movable manner in the storing unit 310. With this configuration, the width of the storing area of the storing unit 310 can be changed by moving the storing area width adjusting member in the storing unit 310 along the width direction of the storing unit 310 (i.e., in the direction orthogonally to the paper sheet of FIG. 14 and the like). When this configuration is adopted, if the denomination of the rolls of coins to be stored in the storing unit 310 of the coin-roll ejecting device 300 is to be changed, the width of the storing area can be appropriately adjusted by moving the storing area width adjusting member in the storing unit 310 so that the rolls of coins of the changed denomination can be stored in the storing area of the storing unit 310, whereby it is possible to easily handle the change of the denomination of the rolls of coins to be stored in the storing unit 310.

As explained above, each of the storing units 310 includes the ejecting mechanism 319 that ejects the rolls of coins one by one from near the bottom surface 312 that is at a lower level with respect to the vertical direction. A configuration of the ejecting mechanism 319 will be explained below by referring to FIG. 16A to FIG. 18. The ejecting mechanism 319 includes the rotating member 320 that rotates around a rotation axis 322 in the counterclockwise direction in FIGS. 14 and 15. The rotation axis 322 extends horizontally and orthogonally to the direction of inclination of the storing unit 310 (i.e., extends orthogonally to the paper sheet of FIG. 14 or FIG. 15). Each of the rotating members 320 is provided with at least two notches 324 (three notches are shown in the example shown in FIGS. 14 to 27). One notch 324 receives one roll of coins stored in the storing unit 310. Moreover, the ejecting mechanism 319 includes a driving unit 321 (see FIG. 16A) that rotates the rotating member 320 around the rotation axis 322, a rotating position detecting unit 350 that detects a rotating position of the rotating member 320. A gate member 330 is arranged above the rotating member 320. This gate member 330 prevents a situation where the roll of coins stored in the storing unit 310 does not enter into the notches 324 of the rotating member 320 whereby the roll of coins is ejected from above the rotating member 320. In the ejecting mechanism 319, the driving unit 321 can rotate the rotating member 320 in both of a forward direction and a reverse direction. The forward direction (i.e., the counterclockwise direction in FIG. 14 or FIG. 15) is a direction in which the rotating member 320 ejects the roll of coins from the storing unit 310. The reverse direction (i.e., the clockwise direction in FIG. 14 or FIG. 15) is the reverse of the forward direction. Moreover, the driving unit 321 can change a rotating speed of the rotating member 320.

As shown in FIGS. 17 and 18, the rotating member 320 is provided with the three notches 324 at an equal interval in the direction of rotation of the rotating member 320 around the rotation axis 322. When the rotating member 320 is at a rotating position shown in FIG. 17, one roll of coins among the rolls of coins stored in the storing unit 310 but positioned at the lowest point with respect to the vertical direction on the bottom surface 312 is received in one of the notches 324. Moreover, an accommodated coin-roll detecting unit 329 that detects whether the roll of coins is received in the notch 324 can be arranged in each of the notches 324. The accommodated coin-roll detecting unit 329 is constituted by an optical sensor and the like that includes, for example, a light emitting element and a light receiving element. When a roll of coins is received in the notch 324, this roll of coins is detected because an optical axis between the light emitting element and the light receiving element is blocked by this roll of coins.

As shown in FIGS. 17 and 18, in the rotating member 320, an outer surface 326, to which the rolls of coins stored in the storing unit 310 contact, is configured such that a distance between the outer surface 326 and the center of the rotation axis 322 as the rotation center can be changed. Specifically, the rotating member 320 has a substantially polygonal shape (substantially triangular in the example shown in FIGS. 17 and 18) in a side cross-unit, and the notches 324 are formed near the vertices of the polygon. If a large number of the rolls of coins are stored in the storing unit 310 piled-up in several layers, the rolls of coins stored in the storing unit 310 also contact the outer surface 326 of the rotating member 320. Accordingly, depending on a storing state of the rolls of coins in the storing unit 310, the rolls of coins cannot move in the storing unit 310, and although the notch 324 of the rotating member 320 is empty, the roll of coins may not enter the notch 324. To address this issue, the distance between the outer surface 326 of the rotating member 320 and the rotation axis 322 as the rotation center can be changed. When this distance is changed, the position of the rolls of coins that contact the outer surface 326 when the rotating member 320 is rotated around the rotation axis 322 also changes. Accordingly, because the rolls of coins are stirred and caused to move in the storing unit 310, the rolls of coins can be sent to the notches 324 of the rotating member 320.

The notches 324 of the rotating member 320 are formed such that, when one of the notches 324 of the rotating member 320 is positioned at a storing position (i.e., a position shown in FIG. 17), which is a position at which the rotating member 320 is at the rotating position and ready to receive the roll of coins from the storing unit 310, an inner wall (shown with a reference number 324a in FIG. 17) of this notch 324 and the bottom surface 312 of the storing unit 310 are positioned substantially on one line. With this configuration, when the rotating member 320 is at the rotating position as shown in FIG. 17, one roll of coins among the rolls of coins stored in the storing unit 310 but positioned at the lowest point with respect to the vertical direction on the bottom surface 312 is smoothly received in one of the notches 324.

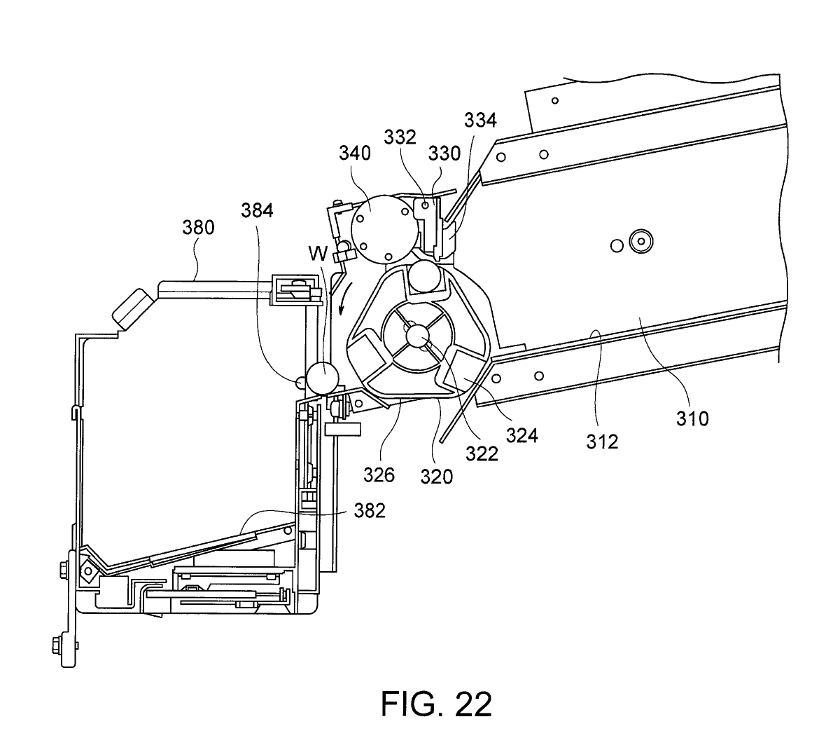

As shown in FIG. 22, a shape and a position of each of the notches 324 in the rotating member 320 are set such that, when one notch 324 of the rotating member 320 is positioned at an ejecting position, which is a position at which the rotating member 320 is at the rotating position and ready to eject the roll of coins, other leading notches 324 of this notch 324 are positioned below the bottom surface 312 of the storing unit 310 so that those other leading notches 324 do not receive the rolls of coins from the storing unit 310.

As shown in FIG. 16A, a length in a longitudinal direction of the rotating member 320 along the rotation axis 322 is larger than ½ of the maximum length in a longitudinal direction of the roll of coins that is to be ejected. With this configuration, even if the rolls of coins stored in the storing unit 310 are long in the longitudinal direction, such rolls of coins can be ejected without losing their balance and stably by the rotating member 320.

As shown in FIG. 16A, a gear 328 is provided with the rotation axis 322 on a side of the rotating member 320. This gear 328 rotates in synchronization with the rotating member 320. Moreover, three to-be-detected members 352 are arranged at an equal interval on a circumference of a rotating member that is provided coaxially with and near the gear 328. The rotating position detecting unit 350 that detects each of the to-be-detected members 352 is arranged in a fixed manner near and outside of the gear 328 in a diametrical direction thereof. The rotating position of the rotating member 320 can be detected by the rotating position detecting unit 350 by detecting each of the to-be-detected members 352. More particularly, the rotating position detecting unit 350 is constituted by an optical sensor and the like that includes, for example, a light emitting element and a light receiving element. When the to-be-detected member 352 is positioned between the light emitting element and the light receiving element, the to-be-detected member 352 is detected because an optical axis between the light emitting element and the light receiving element is blocked by this to-be-detected member 352.

In the present embodiment, several types of the rotating members 320 having the notches 324 of various shapes are prepared previously depending on the diameters of rolls of coins. The rotating member 320 of the ejecting mechanism 319 included in a particular storing unit 310 can be changed depending on the diameter of the rolls of coins that are to be stored in that storing unit 310. More particularly, as shown in FIG. 27, five types of the rotating members 320 having the notches 324 of various shapes and/or dimensions are prepared previously depending on the diameters of the rolls of coins. The outer dimensions of each of the rotating members 320 are the same; however, the depth (shown with reference letters a₁ to a₅ in FIG. 27) and the width (shown with reference letters b₁ to b₅ in FIG. 27) of the notches 324 are different in the rotating members 320. Specifically, the maximum distance (i.e., the radius of a virtual circumscribed circle of the rotating member 320 shown with a two-dot chain line in FIGS. 27(a) to 27(c)) from a center of the rotation axis 322 to the outer surface 326 is the same in each of the rotating members 320 shown in FIGS. 27(a) to 27(e); however, when a diameter of the roll of coins is within a range of 14 mm and 19.5 mm, the rotating member 320 shown in FIG. 27(a) having the notches 324 of a depth a₁=19.7 mm and a width b₁=22 mm is used. Similarly, when a diameter of the roll of coins is within a range of 19.5 mm and 23.5 mm, the rotating member 320 shown in FIG. 27(b) having the notches 324 of a depth a₂=23 mm and a width b₂=26 mm is used. Similarly, when a diameter of the roll of coins is within a range of 23.5 mm and 27.5 mm, the rotating member 320 shown in FIG. 27(c) having the notches 324 of a depth a₃=26.4 mm and a width b₃=30 mm is used. Similarly, when a diameter of the roll of coins is within a range of 27.5 mm and 31 mm, the rotating member 320 shown in FIG. 27(d) having the notches 324 of a depth a₄=29.9 mm and a width b₄=34 mm is used. Similarly, when a diameter of the roll of coins is within a range of 31 mm and 35 mm, the rotating member 320 shown in FIG. 27(e) having the notches 324 of a depth a₅=33.5 mm and a width b₅=38 mm is used. In FIGS. 27(d) and 27(e), only the positions of the notches 324 of the rotating member 320 are shown simply for simplification; however, in reality, the configuration is the same as that of the rotating member 320 shown in FIGS. 27(a) to 27(c).

In FIG. 27 are shown the configurations of the several types of the rotating member 320 having the notches 324 of the various shapes depending on the diameters of rolls of coins. However, in the present embodiment, with respect to the dimensions of the notches 324 of the several types of the rotating members 320, a ratio of a width of the notch 324 (widths shown with reference letters ID, to b₅ in FIG. 27) to the diameter of the roll of coins is set within a range of 1.0 and 1.7. The width of the notch 324 means, as shown in FIG. 27, a distance between an opposing pair of inner walls (a pair of inner walls that are substantially parallel but separated from each other) of the notch 324. Moreover, in the present embodiment, with respect to the dimensions of the notches 324 of the several types, a ratio of a depth of the notch 324 (depths shown with reference letters a₁ to a₅ in FIG. 27) to the diameter of the roll of coins is set within a range of 0.8 and 1.5. The depth of the notch 324 means, as shown in FIG. 27, the maximum distance between an inner contact surface of the notch 324 nearest to the center of the rotation axis 322 of the rotating member 320 and the virtual circumscribed circle (shown with the two-dot chain line in FIG. 27) of the rotating member 320.

In this manner, the several types of the rotating members 320 having the notches 324 of the various shapes are prepared previously depending on the diameters of the rolls of coins, and the rotating member 320 is changed depending on the diameter of the rolls of coins that are to be stored in that storing unit 310. Accordingly, if the denomination of the rolls of coins to be stored in the storing unit 310 of the coin-roll ejecting device 300 is changed, by replacing the rotating member 320 in the ejecting mechanism 319 included in the storing unit 310 having the notches 324 corresponding to the diameter of the new roll of coins, it is possible to easily handle the change of the denomination of the rolls of coins to be stored in the storing unit 310.

In the present embodiment, when replacing the rotating member 320, it is possible to change the entire ejecting mechanism 319 that includes the rotating member 320, the driving unit 321, the later-explained gate member 330, and the like. Alternatively, when replacing the rotating member 320, it is possible to change only the rotating member 320 by independently removing it from the ejecting mechanism 319 that includes the driving unit 321, the later-explained gate member 330, and the like.

Instead of preparing the several types of the rotating members 320 shown in FIGS. 27(a) to 27(e), it is allowable to use one rotating member 320 in which the dimensions of the notches 324 can be changed. Specifically, attachment and detachment members, such as spacers, can be detachably attached to each of the notches 324 of the rotating member 320. The width and/or the depth of the notches 324 can be reduced by attaching the attachment and detachment members to the notches 324. Moreover, alternatively, a contact surface that contacts the rolls of coins can be movable and moved by using screws and the like.

The gate member 330 is arranged above the rotating member 320. This gate member 330 prevents a situation where the roll of coins stored in the storing unit 310 does not enter into the notches 324 of the rotating member 320 whereby the roll of coins is ejected from above the rotating member 320. That is, as shown in FIG. 14, by blocking a gap between a top of the storing unit 310 and the rotating member 320 with the gate member 330, when a large number of the rolls of coins are stored in the storing unit 310, it is prevented that a roll of coins is ejected to the lifting unit 380 side from this gap between the top of the storing unit 310 and the rotating member 320.

As shown in FIGS. 17 and 18, a swing shaft 332 that extends horizontally is arranged above the gate member 330 as a shaft center, and the gate member 330 is swingable around the swing shaft 332. A mechanism to swing the gate member 330 is explained below. As shown in FIG. 16A, a gear 340 that engages with the gear 328 is arranged above the gear 328. The gear 340 is rotated around a rotation axis 342 by the driving unit 321. Because teeth provided on a circumference of the gear 328 are engaged with teeth provided on a circumference of the gear 340, the gear 328 rotates following the rotation of the gear 340. Thus, the rotating member 320 is rotated via the gears 340 and 328 by the driving unit 321. Moreover, a cam 344 is arranged on a side of the gear 340. The cam 344 rotates around the rotation axis 342 in synchronization with the gear 340. As shown in FIGS. 16A to 18, the cam 344 has an approximately quadrangular shape in a cross section. When the cam 344 is rotated around the rotation axis 342, each vertex of the cam 344 intermittently pushes a side of the gate member 330 from the left side in FIGS. 17 and 18 to move the gate member 330. As a result, the gate member 330 swings around the swing shaft 332 between a position at which the gate member 330 is shown with a continuous line and a position at which the gate member 330 is shown with a two-dot chain line in FIGS. 17 and 18. For simplification, the shape of the teeth of the gears 328 and 340 has been omitted from the drawings.

In this manner, the gate member 330 swings around the swing shaft 332 that extends horizontally following the rotation motion of the rotating member 320. Therefore, if a roll of coins stored in the storing unit 310 contacts the gate member 330, that roll of coins is pushed and moved by the gate member 330. As explained above, even if a large number of the rolls of coins have been stored in the storing unit 310 piled-up in several layers, sometimes the rolls of coins cannot move in the storing unit 310 depending on a storing state of the rolls of coins in the storing unit 310, and a roll of coins may not be sent in any of the notches 324 although the notches 324 of the rotating member 320 are empty. In contrast, in the present embodiment, a roll of coins that contacts the gate member 330 is pushed and moved by the gate member 330 whereby the positions of the rolls of coins in the storing unit 310 are also changed. Accordingly, because the rolls of coins are stirred and moved in the storing unit 310, the rolls of coins can be sent to the notches 324 of the rotating member 320. As shown in FIGS. 17 and 18, a swing angle of the gate member 330 around the swing shaft 332 is, for example, 7 degrees.

However, depending on the storing state of the rolls of coins in the storing unit 310, when a roll of coins stored in the storing unit 310 is in contact with the gate member 330, the roll of coins that is pushed and moved by the gate member 330, and the other rolls of coins in the storing unit 310 may not smoothly move inside the storing unit 310 even if the gate member 330 is swung. For example, if the rolls of coins in the storing unit 310 are in a state shown in FIG. 16B, i.e., when a plurality of (four in the example shown in FIG. 16B) the rolls of coins form a bridge between the bottom surface 312 of the storing unit 310 and the gate member 330, the four rolls of coins that form the bridge between the bottom surface 312 of the storing unit 310 and the gate member 330 do not collapse even if the gate member 330 is swung. As a result, a roll of coins cannot be sent to the notch 324 of the rotating member 320. The factors that often govern the occurrence of this phenomenon are a distance between the bottom surface 312 of the storing unit 310 and a side surface of the gate member 330 where the roll of coins contacts the gate member 330, a diameter of the rolls of coins, and the like. To address this issue, one or more mounting members 334 are detachably mounted on the side surface of the gate member 330 where the roll of coins contacts the gate member 330. The mounting members 334 are arranged such that they can contact the rolls of coins stored in the storing unit 310. The mounting members 334 allow changing the distance between the bottom surface 312 of the storing unit 310 and the side surface of the gate member 330 where the roll of coins contacts the gate member 330. More particularly, as shown in FIG. 16A, a plurality of mounting holes are formed in the side surface of the gate member 330 where the roll of coins contacts the gate member 330 but along the direction in which the rotation axis 322 of the rotating member 320 extends. At least one mounting member 334 can be mounted in one of the mounting holes.

In FIG. 16A, an example has been shown in which two mounting members 334 are mounted on the gate member 330 symmetrically along a width direction of the storing unit 310; however, the arrangement of the mounting members 334 is not limited to this example. For example, as shown in FIG. 16C, only one mounting member 334 can be mounted on the gate member 330 to create unevenness in the longitudinal direction of the rolls of coins stored in the storing unit 310. When the mounting member 334 is mounted on the gate member 330 to create unevenness in the longitudinal direction of the rolls of coins stored in the storing unit 310, and when the gate member 330 swings around the swing shaft 332 following the rotation motion of the rotating member 320, the roll of coins that is in contact with the mounting member 334 among the rolls of coins stored in the storing unit 310 is pushed and moved unevenly along the longitudinal direction of the roll of coins. In this configuration, in comparison to the configuration shown in FIG. 16A, in which two mounting members 334 are mounted on the gate member 330 symmetrically along the width direction of the storing unit 310 to evenly push and move the roll of coins in the longitudinal direction of the roll of coins that is in contact with the mounting members 334, because the roll of coins is pushed and moved in a twisted direction with respect to the width direction of the storing unit 310, the rolls of coins that have formed the bridge, as shown in FIG. 16B, between the bottom surface 312 of the storing unit 310 and the gate member 330, can be surely collapsed.

It is not necessary that the mounting member mounted on the gate member 330 has the same shape as that of the mounting member 334 shown in FIGS. 16A and 16C. It is possible to use a mounting member 336 that has a general round shape as shown in FIGS. 16D and 16E. The mounting member 336 is mounted on a guide rail 338 and the mounting member 336 can be freely moved along the width direction of the storing unit 310 along the guide rail 338. As shown in FIG. 16E, the mounting member 336 can be mounted near an end in the width direction of the storing unit 310. In this configuration, when the gate member 330 swings around the swing shaft 332 following the rotation motion of the rotating member 320, the roll of coins that is in contact with the mounting member 336 among the rolls of coins stored in the storing unit 310 is pushed and moved unevenly along the longitudinal direction of the roll of coins. Even with this configuration, because the roll of coins that is in contact with the mounting member 336 is pushed and moved in a twisted direction with respect to the width direction of the storing unit 310, the rolls of coins that have formed the bridge, as shown in FIG. 16B, between the bottom surface 312 of the storing unit 310 and the gate member 330, can be surely collapsed.

The configuration of the ejecting mechanism 319 is not limited to the one in which the mounting member 334 or the mounting member 336 is mounted on the gate member 330. Other configuration is allowable as long as, when the gate member 330 swings around the swing shaft 332 following the rotation motion of the rotating member 320, the roll of coins that is in contact with the gate member 330 among the rolls of coins stored in the storing unit 310 are pushed and moved unevenly along the longitudinal direction of the roll of coins by the gate member 330. Specifically, as shown in FIG. 16F, a protrusion 330a that protrudes toward the storing area of the rolls of coins in the storing unit 310 can be arranged on the side surface of the gate member 330 where the roll of coins contacts the gate member 330 but near an end in the width direction of the storing unit 310. FIG. 16F is a top view of another variation of the ejecting mechanism 319 included in each of the storing units 310 of the coin-roll ejecting device 300 shown in FIG. 14 and the like. In FIG. 16F, only those rolls of coins that have formed the bridge between the bottom surface 312 of the storing unit 310 and the gate member 330 among the rolls of coins stored in the storing unit 310 have been shown. When the gate member 330 having the shape shown in FIG. 16F is used, when the gate member 330 swings around the swing shaft 332 following the rotation motion of the rotating member 320, the roll of coins that is in contact with the gate member 330 among the rolls of coins stored in the storing unit 310 is pushed and moved unevenly along the longitudinal direction of the roll of coins by the protrusion 330a of the gate member 330. Even with this configuration, because the roll of coins that is in contact with the gate member 330 is pushed and moved in a twisted direction with respect to the width direction of the storing unit 310, the rolls of coins that have formed the bridge, as shown in FIG. 16B, between the bottom surface 312 of the storing unit 310 and the gate member 330, can be surely collapsed.

As another variation of the configuration of the ejecting mechanism 319, as shown in FIG. 16G, the gate member 330 can include two gate elements 330b and 330c arranged side-by-side along the width direction of the storing unit 310, and each of the gate elements 330b and 330c can independently move back and forth toward the rolls of coins stored in the storing unit 310. Specifically, the gate elements 330b and 330c independently move back and forth between a position at which the gate elements 330b and 330c are shown with a continuous line and a position at which the gate elements 330b and 330c are shown with a two-dot chain line in FIG. 16G. That is, the two gate elements 330b and 330c alternately go closer to the storing area of the roll of coins in the storing unit 310. FIG. 16G is a top view of still another variation of the ejecting mechanism 319 included in each of the storing units 310 of the coin-roll ejecting device 300 shown in FIG. 14 and the like. In FIG. 16G, only those rolls of coins that have formed the bridge between the bottom surface 312 of the storing unit 310 and the gate member 330 among the rolls of coins stored in the storing unit 310 have been shown. When the gate member 330 that includes the two gate elements 330b and 330c shown in FIG. 16G is used, and when each of the gate elements 330b and 330c independently moves back and forth toward the rolls of coins stored in the storing unit 310, the roll of coins that is in contact with the gate elements 330b and 330c among the rolls of coins stored in the storing unit 310 can be pushed and moved unevenly along the longitudinal direction of the roll of coins. Even with this configuration, because the roll of coins that is in contact with the gate member 330 is pushed and moved in a twisted direction with respect to the width direction of the storing unit 310, the rolls of coins that have formed the bridge, as shown in FIG. 16B, between the bottom surface 312 of the storing unit 310 and the gate member 330, can be surely collapsed.

Another variation of the configuration of the gate member 330 is shown in FIG. 16H. The gate member 330 is configured to swing in a substantially horizontal plane around a swing shaft 330d. The swing shaft 330d is arranged near the end in the width direction of the storing unit 310 and extends substantially vertically. Specifically, the gate member 330 swings around the swing shaft 330d between a position at which the gate member 330 is shown with a continuous line and a position at which the gate member 330 is shown with a two-dot chain line in FIG. 16H. FIG. 16H is a top view of still another variation of the ejecting mechanism 319 included in each of the storing units 310 of the coin-roll ejecting device 300 shown in FIG. 14 and the like. In FIG. 16H, only those rolls of coins that have formed the bridge between the bottom surface 312 of the storing unit 310 and the gate member 330 among the rolls of coins stored in the storing unit 310 have been shown. When the gate member 330 shown in FIG. 16H is used, and when the gate member 330 swings in the substantially horizontal plane around the swing shaft 330d that extends substantially vertically, the roll of coins that is in contact with the gate member 330 among the rolls of coins stored in the storing unit 310 can be pushed and moved unevenly along the longitudinal direction of the roll of coins. Even with this configuration, because the roll of coins that is in contact with the gate member 330 is pushed and moved in a twisted direction with respect to the width direction of the storing unit 310, the rolls of coins that have formed the bridge, as shown in FIG. 16B, between the bottom surface 312 of the storing unit 310 and the gate member 330, can be surely collapsed. In the case of the gate member 330 shown in FIG. 16H, a protrusion similar to the protrusion 330a shown in FIG. 16F may be arranged near an end of the gate member 330 on the far side from the swing shaft 330d on a surface of the gate member 330 where the roll of coins contacts the gate member 330. With this configuration, the roll of coins that is in contact with the gate member 330 among the rolls of coins stored in the storing unit 310 can be pushed and moved further unevenly along the longitudinal direction of the roll of coins.

The configuration of the gate member 330 is not limited to those explained above. Any other configuration can be employed as long as the rolls of coins stored in the storing unit 310 can be pushed and moved unevenly along the longitudinal direction of the rolls of coins. Moreover, the structure to collapse the rolls of coins that have formed the bridge between the bottom surface 312 of the storing unit 310 and the gate member 330 by unevenly pushing and moving the rolls of coins stored in the storing unit 310 along the longitudinal direction of the rolls of coins is not limited to the gate member 330. It is allowable to unevenly push and move the rolls of coins stored in the storing unit 310 along the longitudinal direction of the rolls of coins with a structure other than the gate member 330.

Moreover, the gate member 330 of the various variation explained above unevenly pushes and moves the rolls of coins stored in the storing unit 310 along the longitudinal direction of the rolls of coins with a structure other than the gate member 330 with an object to collapse the rolls of coins that have formed the bridge between the bottom surface 312 of the storing unit 310 and the gate member 330. However, when the gate member 330 performs this operation, an effect is achieved that it is possible to prevent that the rolls of coins form a bridge between the bottom surface 312 of the storing unit 310 and the gate member 330.

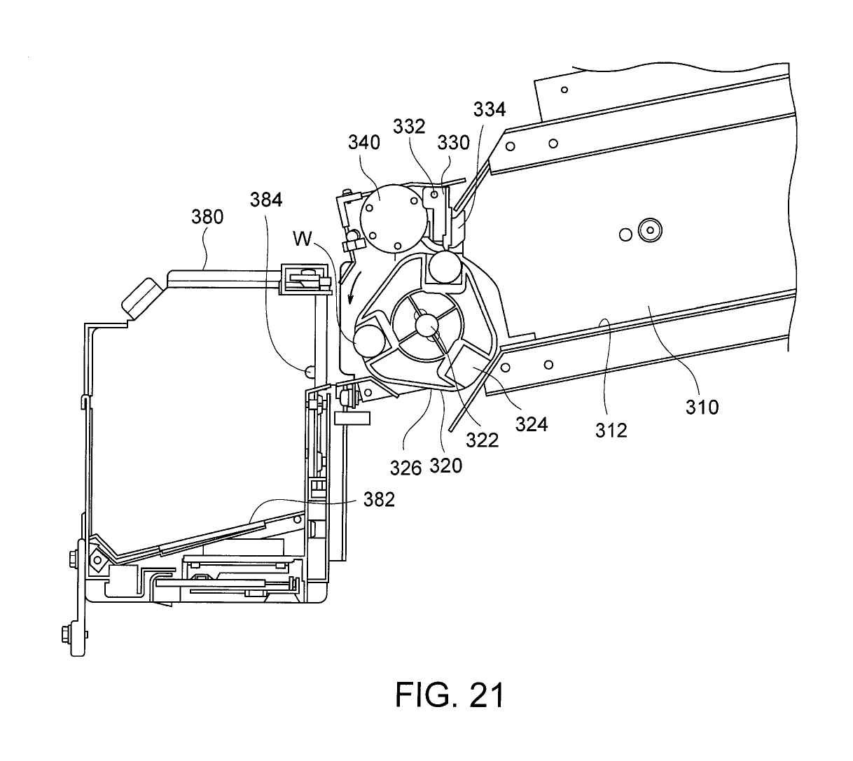

An operation performed by the ejecting mechanism 319, having the configuration shown in FIG. 16A and the like, when ejecting a roll of coins stored in the storing unit 310 is explained below by referring to FIGS. 19 to 22. When, as shown in FIG. 19, one of the notches 324 of the rotating member 320 is positioned at a storing position, which is a position at which the rotating member 320 is at the rotating position and ready to receive the roll of coins from the storing unit 310, one roll of coins among the rolls of coins stored in the storing unit 310 but positioned at the lowest point with respect to the vertical direction on the bottom surface 312 is smoothly received in this notch 324. In this state, as shown in FIG. 19, when the rotating member 320 is rotated by the driving unit 321 in the counterclockwise direction in FIG. 19 from the rotating position of the rotating member 320, the rotating member 320 rotates to an ejecting position shown in FIG. 22 after passing through positions shown in FIGS. 20 and 21. When the rotating member 320 is in this ejecting position, the roll of coins is ejected from the notch 324 of the rotating member 320 to be sent to the coin-roll storing member 382 of the lifting unit 380.

The lifting unit 380 is movable up and down, as shown with an arrow in FIG. 14, between a position at which the lifting unit 380 faces the ejecting mechanism 319 of each of the storing units 310 and a position that is above and near the shutter 390. When the roll of coins stored in the storing unit 310 is to be ejected by the ejecting mechanism 319 of this storing unit 310, the lifting unit 380 is moved to the position facing this ejecting mechanism 319. As explained above, the lifting unit 380 includes the coin-roll storing member 382 in which the roll of coins ejected by the ejecting mechanism 319 of each of the storing units 310 is stored, and the ejected coin-roll detecting unit 384 that detects the roll of coins ejected by the ejecting mechanism 319 of each of the storing units 310. When the roll of coins stored in the storing unit 310 is ejected by the ejecting mechanism 319, this roll of coins is detected by the ejected coin-roll detecting unit 384 and then stored in the coin-roll storing member 382. The ejected coin-roll detecting unit 384 is constituted by an optical sensor and the like that includes, for example, a light emitting element and a light receiving element. When the roll of coins ejected by the ejecting mechanism 319 is sent to the lifting unit 380, this roll of coins is detected because an optical axis between the light emitting element and the light receiving element is blocked by this roll of coins.

A driving unit 372 that drives the lifting unit 380 up and down is arranged below the coin-roll ejecting device 300. A power source harness 374 is connected to the driving unit 372. Electric power is supplied to the driving unit 372 of the coin-roll ejecting device 300 from other devices in the money changer 10 via the power source harness 374. When the coin-roll ejecting device 300 is to be operated as a separate device, instead of connecting the power source harness 374 to the driving unit 372, a power source 376 shown with a two-dot chain line in FIG. 15 can be provided.

In the present embodiment, a housing door 304 (see FIG. 15) is arranged on a front surface of the housing 302 of the coin-roll ejecting device 300. The storing units 310 and the lifting unit 380 can be pulled integrally and horizontally from the housing 302 after opening the housing door 304. The housing door 304 can be arranged on a back surface instead of arranging on the front surface of the housing 302.

In another alternative of the coin-roll ejecting device 300, instead of pulling the storing units 310 and the lifting unit 380 from the housing 302 integrally after opening the housing door 304, the storing units 310 can be pulled from the housing 302 separately from the lifting unit 380. In this configuration, when pulling the storing units 310 from the housing 302 after opening the housing door 304, the lifting unit 380 is configured to be evacuated to a position in which the lifting unit 380 does not hinder the pulling operation of the storing units 310 in the vertical direction.

The housing door 304 can be arranged on a side surface instead of the front surface or the back surface of the housing 302. In this configuration, when replenishing the rolls of coins in the storing unit 310 or taking out the rolls of coins from the storing unit 310, the housing door 304 is opened first, and then the side wall constituting the door 314 (see FIG. 23) in the storing unit 310 is opened.

How the rotation of the rotating member 320 of the ejecting mechanisms 319 by the driving unit 321 and the like is controlled by the controlling unit 370 included in the coin-roll ejecting device 300 is explained below.

In the present embodiment, as explained above, in each of the ejecting mechanism 319, the driving unit 321 can rotate the rotating member 320 in both of the forward direction and the reverse direction. The forward direction (i.e., the counterclockwise direction in FIG. 14 or FIG. 15) is a direction in which the rotating member 320 ejects the roll of coins from the storing unit 310. The reverse direction (i.e., the clockwise direction in FIG. 14 or FIG. 15) is the reverse of the forward direction. The controlling unit 370 controls a direction of rotation of the rotating member 320 based on the rotating position of the rotating member 320 detected by the rotating position detecting unit 350 and detection information obtained in the ejected coin-roll detecting unit 384.

More specifically, when causing the ejecting mechanism 319 to eject the roll of coins from the storing unit 310 by rotating the rotating member 320 in the forward direction, if the ejected coin-roll detecting unit 384 detects that the rolls of coins of a predetermined number have been ejected by the rotating member 320 and if the rotating position detecting unit 350 detects that the rotating member 320 is positioned in a first predetermined position, the controlling unit 370 rotates the rotating member 320 in the reverse direction. The first predetermined position refers to a position at which, after the rolls of coins of the predetermined number are ejected from the rotating member 320, a roll of coins remains in one of the notches 324 of the rotating member 320, and specifically, it is the position shown in FIG. 22. Thereafter, when the rotating position detecting unit 350 detects that the rotating member 320 is positioned in a second predetermined position, the controlling unit 370 stops the rotation of the rotating member 320. The second predetermined position, as shown in FIG. 19, refers to a position in which the notch 324 with the roll of coins received therein faces the storing unit 310. By controlling the driving unit 321 with the controlling unit 370 in this manner, when a roll of coins remains, as shown in FIG. 22, in the notch 324 of the rotating member 320 when the predetermined number of the rolls of coins have been ejected by the rotating member 320 from the storing unit 310, the roll of coins remaining in the notch 324 can be returned to the storing unit 310 by rotating the rotating member 320 in the reverse direction. That is, when collecting the rolls of coins present in the storing unit 310 by controlling in this manner, all the rolls of coins that should be collected from the storing unit 310, including those that had once left the storing unit 310 by being received in the notches 324 of the rotating member 320, can be collected.

When causing the ejecting mechanism 319 to eject the roll of coins from the storing unit 310 by rotating the rotating member 320 in the forward direction, if the rotating position detecting unit 350 detects that the rotating member 320 is not positioned in the first predetermined position (see FIG. 22) for a predetermined time, the controlling unit 370 rotates the rotating member 320 in the reverse direction. Thereafter, when the rotating position detecting unit 350 detects that the rotating member 320 is positioned in the second predetermined position (see FIG. 19), the controlling unit 370 stops the rotation of the rotating member 320. The reason why such a control is performed by the controlling unit 370 is explained below. When ejecting a roll of coins from the storing unit 310 by the rotating member 320 of the ejecting mechanism 319, sometimes the roll of coins is pinched by the rotating member 320 and the like resulting in clogging of the roll of coins whereby the rotating member 320 cannot rotate. When this happens, i.e., when the rotating position detecting unit 350 detects that the rotating member 320 is not positioned in the first predetermined position for the predetermined time, the controlling unit 370 judges that the clogging of the roll of coins has occurred in the rotating member 320, and therefore rotates the rotating member 320 in the reverse direction to position the rotating member 320 in the second predetermined position shown in FIG. 19. As a result, the clogging of the roll of coins in the rotating member 320 can be fixed.

The controlling unit 370 judges, based on the rotating position of the rotating member 320 detected by the rotating position detecting unit 350 and the detection information obtained in the ejected coin-roll detecting unit 384, whether an ejection defect that a roll of coins cannot be ejected normally from the storing unit 310 has occurred. When number of times that the ejection defect occurred in one of a predetermined time, predetermined ejection cycles, a predetermined ejection number exceeds a predetermined number, the controlling unit 370 causes the driving unit 321 to adjust the rotating speed of the rotating member 320 to reduce the rotating speed of the rotating member 320. In this manner, if the ejection defect occurs frequently in the ejecting mechanism 319, the controlling unit 370 performs a management to decrease the frequency of occurrence of the ejection defect in the ejecting mechanism 319 by reducing the rotating speed of the rotating member 320.

As explained above, the coin-roll ejecting device 300 according to the present embodiment includes the storing units 310 having the bottom surface 312 that is inclined with respect to the horizontal plane to store thereon a plurality of the rolls of coins in a piled-up manner that accumulate by rolling in the direction of inclination of the bottom surface 312, the storing unit 310 having the ejecting mechanism 319 that ejects the rolls of coins one by one from near the side of the bottom surface 312 that is at the lower level with respect to the vertical direction; and the lifting unit 380 that includes the coin-roll storing member 382 that accommodates therein the roll of coins ejected by the ejecting mechanism 319 from the storing unit 310 and that is movable in the vertical direction. In this manner, because a plurality of the rolls of coins is stored in the storing unit 310 in a piled-up manner, and the rolls of coins stored in the storing unit 310 are ejected from the storing unit 310 by the ejecting mechanism 319 and accommodated in the coin-roll storing member 382 of the lifting unit 380, the coin-roll ejecting device 300 can have a large capacity, a compact configuration, good operability, and improved stability of the operation to eject a roll of coins from the storing unit 310.

In the coin-roll ejecting device 300 according to the present embodiment, the ejected coin-roll detecting unit 384 that detects the roll of coins ejected from the storing unit 310 is provided. Moreover, the ejecting mechanism 319 includes the rotating member 320 that rotates around the rotation axis 322 that extends horizontally and orthogonally to the direction of inclination of the storing unit 310 and having at least two notches 324 each receiving one roll of coins stored in the storing unit 310, the driving unit 321 that rotates the rotating member 310 around the rotation axis 322, and the rotating position detecting unit 350 that detects the rotating position of the rotating member 320. Because the rotating position detecting unit 350 that detects the rotating position of the rotating member 320 is provided, when a roll of coins remains in the notch 324 of the rotating member 320 when the predetermined number of the rolls of coins are ejected by the rotating member 320 from the storing unit 310, the roll of coins in the notch 324 of the rotating member 320 can be returned to the storing unit 310 by rotating the rotating member 320 by the driving unit 321 based on the rotating position of the rotating member 320 detected by the rotating position detecting unit 350.

Moreover, according to the coin-roll ejecting device 300 of the present embodiment having the above configuration, several types of the rotating members 320 having the notches 324 of various shapes are prepared previously depending on diameters of the rolls of coins, and the rotating member 320 is replaced depending on a diameter of the roll of coins stored in the storing unit 310. Accordingly, even if the denomination of the rolls of coins to be stored in the storing unit 310 of the coin-roll ejecting device 300 is changed, by replacing the rotating member 320 of the ejecting mechanism 319 included in the storing unit 310 having the notches 324 corresponding to the diameter of the new rolls of coins, it is possible to easily cope with the change of the denomination of the rolls of coins to be stored in the storing unit 310.

The storing unit 310 has a pair of side walls that constitute a storing area for rolls of coins therebetween. The first storing area width adjusting member 317 and the second storing area width adjusting member 318 for adjusting a width of the storing area of the storing unit 310 are detachably attached to at least one of the pair of the side walls of the storing unit 310. Several types of the storing area width adjusting members 317 and 318 are prepared beforehand depending on the longitudinal length of the roll of coins. The width of the storing area of the storing unit 310 can be changed by attaching an appropriate one of the storing area width adjusting members 317 and 318 to the side wall. With this configuration, if the denomination of the rolls of coins to be stored in the storing unit 310 of the coin-roll ejecting device 300 is changed, the width of the storing area can be appropriately adjusted by replacing the storing area width adjusting members 317 and 318 attached to the side wall of the storing unit 310 so that the rolls of coins of the changed denomination can be stored in the storing area of the storing unit 310. Accordingly, it is possible to easily cope with the change of the denomination of the rolls of coins to be stored in the storing unit 310.

In the coin-roll ejecting device 300 shown in FIGS. 14 to 27, the ejecting mechanism 319 including the rotating member 320 provided with three notches 324 is installed in each of the storing units 310; however, the present invention is not limited to this configuration. As a variation of the coin-roll ejecting device according to present invention, it is allowable to use the coin-roll ejecting device 300a having installed therein the ejecting mechanism 319a including the rotating member 360 provided with two notches 364 installed in each of the storing units 310. The coin-roll ejecting device 300a is explained below by referring to FIGS. 28 and 29. In the coin-roll ejecting device 300a shown in FIG. 28, the same or the similar components as those in the coin-roll ejecting device 300 shown in FIGS. 14 to 27 are provided with the same reference signs and the explanation thereof is omitted.

In the coin-roll ejecting device 300a shown in FIG. 28, each of the storing units 310 includes the bottom surface 312 and the ejecting mechanism 319a that ejects the stored rolls of coins one by one from near the bottom surface 312 that is at a lower level with respect to the vertical direction. The ejecting mechanism 319a includes the rotating member 360 that rotates around a rotation axis 362 in the counterclockwise direction in FIG. 28. The rotation axis 362 extends horizontally and orthogonally to the direction of inclination of the storing unit 310 (i.e., extends orthogonally to the paper sheet of FIG. 28). Each of the rotating members 360 is provided with two notches 364. One notch 364 receives one roll of coins stored in the storing unit 310. Moreover, the ejecting mechanism 319a includes a driving unit (not shown) that rotates the rotating member 360 around the rotation axis 362, a rotating position detecting unit (not shown) that detects a rotating position of the rotating member 360, and the gate member 330 arranged above the rotating member 360. This gate member 330 prevents a situation where the roll of coins stored in the storing unit 310 does not enter into the notch 364 of the rotating member 360 whereby the roll of coins is ejected from above the rotating member 360.

Even in the coin-roll ejecting device 300a shown in FIG. 28, similar to the coin-roll ejecting device 300 shown in FIGS. 14 to 27, several types of the rotating members 360 having the notches 364 of various shapes are prepared previously depending on the diameters of rolls of coins. The rotating member 360 of the ejecting mechanism 319a included in a particular storing unit 310 can be replaced depending on the diameter of the rolls of coins that are stored in that storing unit 310. More particularly, as shown in FIG. 29, five types of the rotating members 360 having the notches 364 of various shapes are prepared previously depending on the diameters of the rolls of coins. The outer dimensions of each of the rotating members 360 are the same; however, depths (shown with reference letters c₁ to c₅ in FIG. 29) and widths (shown with reference letters d₁ to d₅ in FIG. 29) of the notches 364 are different in the rotating members 360. Specifically, a maximum distance from a center of the rotation axis 362 to an outer surface is the same in each of the rotating members 360 shown in FIGS. 29(a) to 29(e); however, when a diameter of the roll of coins is within a range of 14 mm and 19.5 mm, the rotating member 360 shown in FIG. 29(a) having the notches 364 of a depth c₁=19.7 mm and a width d₁=22 mm is used. Similarly, when a diameter of the roll of coins is within a range of 19.5 mm and 23.5 mm, the rotating member 360 shown in FIG. 29(b) having the notches 364 of a depth c₂=23 mm and a width d₂=26 mm is used. Similarly, when a diameter of the roll of coins is within a range of 23.5 mm and 27.5 mm, the rotating member 360 shown in FIG. 29(c) having the notches 364 of a depth c₃=26.4 mm and a width d₃=30 mm is used. Similarly, when a diameter of the roll of coins is within a range of 27.5 mm and 31 mm, the rotating member 360 shown in FIG. 29(d) having the notches 364 of a depth c₄=29.9 mm and a width d₄=34 mm is used. Similarly, when a diameter of the roll of coins is within a range of 31 mm and 35 mm, the rotating member 360 shown in FIG. 29(e) having the notches 364 of a depth c₅=33.5 mm and a width d₅=38 mm is used. In FIGS. 29(a) to 29(e), only the positions of the notches 364 of the rotating member 360 are shown simply for simplification.

In FIG. 29 are shown the configurations of the several types of the rotating member 360 having the notches 364 of the various shapes depending on the diameters of rolls of coins. However, in the present embodiment, with respect to the dimensions of the notches 364 of the several types of the rotating members 360, a ratio of a width of the notch 364 (widths shown with reference letters d₁ to d₅ in FIG. 29) to the diameter of the roll of coins is set in a range of 1.0 and 1.7. Moreover, in the present embodiment, with respect to the dimensions of the notches 364 of the several types, a ratio of a depth of the notch 364 (depths shown with reference letters c₁ to c₅ in FIG. 29) to the diameter of the roll of coins is set within a range of 0.8 and 1.5.

In this manner, the several types of the rotating members 360 having the notches 364 of the various shapes are prepared previously depending on the diameters of the rolls of coins, and the rotating member 360 is replaced depending on the diameter of the rolls of coins that are stored in that storing unit 310. Accordingly, even if the denomination of the rolls of coins to be stored in the storing unit 310 of the coin-roll ejecting device 300a is changed, by replacing the rotating member 360 in the ejecting mechanism 319a included in the storing unit 310 having the notches 364 corresponding to the diameter of the new rolls of coins, it is possible to easily handle the change of the denomination of the rolls of coins to be stored in the storing unit 310.

In the coin-roll ejecting devices 300 and 300a shown in FIGS. 14 to 29, the plurality of the storing units 310 are arranged one above the other in the vertical direction in one row; however, the coin-roll ejecting device according to the present invention is not limited to this configuration. That is, two or more rows of a storing unit combination body, including a plurality of the storing units 310 arranged one above the other in the vertical direction, can be installed in a width direction of the coin-roll ejecting device. With this configuration, the lifting unit 380 extends to cover the two or more rows of the storing unit combination bodies, and the lifting unit 380 can receive the rolls of coins ejected from each of the storing unit 310 of all the storing unit combinations bodies. Alternatively, a plurality of the coin-roll storing members 382 and a plurality of the lifting units 380 can be provided, and the roll of coins ejected from each of the storing units 310 of the particular storing unit combination body can be received by a corresponding one of the coin-roll storing member 382.

### Money Change Process Performed by Money Changer

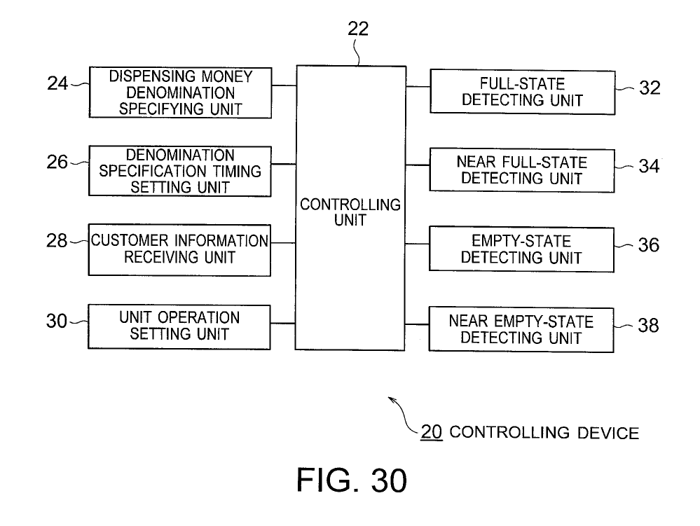

A money change process performed by the money changer 10 having the above configuration is explained below. At first, a detailed configuration of the controlling device 20 that performs the money change process is explained by referring to FIG. 30.

As shown in FIG. 30, the controlling device 20 of the money changer 10 includes a controlling unit 22 that controls various components of the money changer 10. A dispensing money denomination specifying unit 24 for specifying a denomination of the money to be dispensed is connected to the controlling unit 22. When the operator, who may be a customer and the like, who wants to perform the money change process by using the money changer 10, inputs a denomination of the money to be dispensed by using the operation and displaying unit 40, this leads to specification of the denomination of the money to be dispensed by the dispensing money denomination specifying unit 24.

In the money changer 10 according to the present embodiment, the controlling unit 22 can switch between whether to specify the denomination by the dispensing money denomination specifying unit 24 before depositing money or to specify the denomination by the dispensing money denomination specifying unit 24 after depositing money. Moreover, as shown in FIG. 30, a denomination specification timing setting unit 26 is connected to the controlling unit 22. The denomination specification timing setting unit 26 performs the setting relating to whether to specify the denomination by the dispensing money denomination specifying unit 24 before depositing money or to specify the denomination by the dispensing money denomination specifying unit 24 after depositing money. Moreover, the denomination specification timing setting unit 26 performs, other than the above settings, setting relating to whether to specify the denomination by the dispensing money denomination specifying unit 24 before depositing money or to specify the denomination by the dispensing money denomination specifying unit 24 after depositing money for each of the money change process. These settings by the denomination specification timing setting unit 26 are performed by the operator, such as a shop clerk of the financial institution, by inputting the setting contents into the controlling unit 22 of the controlling device 20 by using the operation and displaying unit 40 at the time of installing and the like the money changer 10.

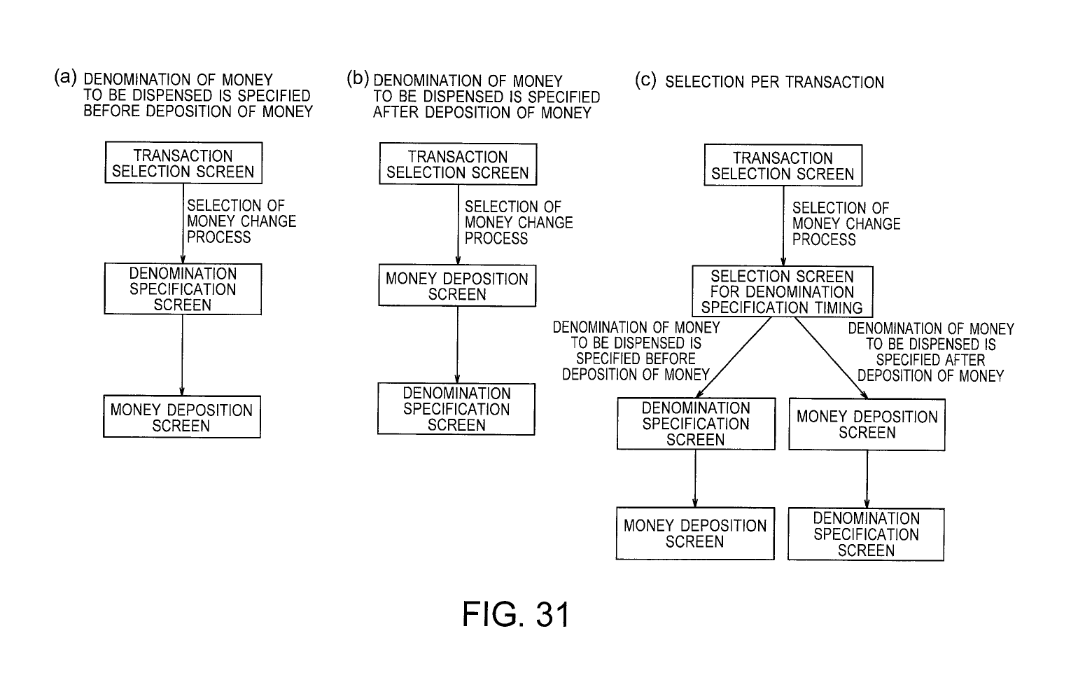

A process procedure in a situation in which the setting specified by the denomination specification timing setting unit 26 is to specify the denomination by the dispensing money denomination specifying unit 24 before depositing money is explained by using a flowchart shown in FIG. 31(a). A transaction selection screen is displayed on the operation and displaying unit 40 while the money changer 10 is in a standby state. When the operator, who may be a customer and the like, who wants to perform the money change process by using the money changer 10, selects the money change process on the transaction selection screen, a denomination specification screen for specifying the denomination of the money to be dispensed is displayed on the operation and displaying unit 40. When the operator inputs the denomination of the money to be dispensed from the operation and displaying unit 40 while the denomination specification screen has been displayed on the operation and displaying unit 40, this leads to specification of the denomination of the money to be dispensed by the dispensing money denomination specifying unit 24. Subsequently, a money deposition screen is displayed on the operation and displaying unit 40. When the operator performs a money deposition process while the money deposition screen has been displayed on the operation and displaying unit 40, the money of the denomination specified by the dispensing money denomination specifying unit 24 is dispensed from the money changer 10. With this configuration, a series of steps of the money change process is completed. The above explained money change process is suitable when the operator previously knows the denomination of money to be deposited and the denomination of money to be dispensed.

Next, a process procedure in a situation in which the setting specified by the denomination specification timing setting unit 26 is to specify the denomination by the dispensing money denomination specifying unit 24 after depositing money is explained by using a flowchart shown in FIG. 31(b). A transaction selection screen is displayed on the operation and displaying unit 40 in a standby state of the money changer 10. When the operator, who may be a customer and the like, who wants to perform the money change process by using the money changer 10, selects the money change process on the transaction selection screen, a money deposition screen is displayed on the operation and displaying unit 40. When the operator performs the money deposition process while the money deposition screen has been displayed on the operation and displaying unit 40, a denomination specification screen for specifying the denomination of the money to be dispensed is displayed on the operation and displaying unit 40. The total amount of deposited money is also displayed on the denomination specification screen. When the operator inputs the denomination of the money to be dispensed from the operation and displaying unit 40 while the denomination specification screen has been displayed on the operation and displaying unit 40, this leads to specification of the denomination of the money to be dispensed by the dispensing money denomination specifying unit 24, and the money of the denomination specified by the dispensing money denomination specifying unit 24 is dispensed from the money changer 10. With this configuration, a series of steps of the money change process is completed. The above explained money change process is suitable when the operator previously does not know the denomination of money to be deposited and the denomination of money to be dispensed. Specifically, when, for example, the operator wants to perform the reverse money change of a large number of coins owned by him into banknotes, it is possible that the operator does not know the total amount of the large number of coins that he is going to deposit. In such a case, before specifying the denomination of the banknotes to be dispensed, it may be desirable for the operator to deposit the large number of coins in the money changer 10 and ensure the total amount of the coins, and then specify the denomination of the banknotes that is appropriate to the total amount of the coins.

Next, a process procedure in a situation in which the denomination specification timing setting unit 26 performs the setting relating to whether to specify the denomination by the dispensing money denomination specifying unit 24 before depositing money or to specify the denomination by the dispensing money denomination specifying unit 24 after depositing money for each of the money change process is explained by using a flowchart shown in FIG. 31(c). A transaction selection screen is displayed on the operation and displaying unit 40 in a standby state of the money changer 10. When the operator, who may be a customer and the like, who wants to perform the money change process by using the money changer 10, selects the money change process on the transaction selection screen, a selection screen for the denomination specification timing is displayed on the operation and displaying unit 40. When the operator selects that the denomination of the money to be dispensed is to be specified before the deposition of the money while the selection screen for the denomination specification timing has been displayed on the operation and displaying unit 40, a denomination specification screen for specifying the denomination of the money to be dispensed is displayed on the operation and displaying unit 40. When the operator inputs the denomination of the money to be dispensed from the operation and displaying unit 40 while the denomination specification screen has been displayed on the operation and displaying unit 40, this leads to specification of the denomination of the money to be dispensed by the dispensing money denomination specifying unit 24. Subsequently, a money deposition screen is displayed on the operation and displaying unit 40. When the operator performs the money deposition process while the money deposition screen has been displayed on the operation and displaying unit 40, the money of the denomination specified by the dispensing money denomination specifying unit 24 is dispensed from the money changer 10. Alternatively, when the operator selects that the denomination of the money to be dispensed is to be specified after the deposition of the money while the selection screen for the denomination specification timing has been displayed on the operation and displaying unit 40, a money deposition screen is displayed on the operation and displaying unit 40. When the operator performs the money deposition process while the money deposition screen has been displayed on the operation and displaying unit 40, a denomination specification screen for specifying the denomination of the money to be dispensed is displayed on the operation and displaying unit 40. When the operator inputs the denomination of the money to be dispensed from the operation and displaying unit 40 while the denomination specification screen has been displayed on the operation and displaying unit 40, this leads to specification of the denomination of the money to be dispensed by the dispensing money denomination specifying unit 24, and the money of the denomination specified by the dispensing money denomination specifying unit 24 is dispensed from the money changer 10. With this, a series of steps of the money change process is completed.

In this manner, in the money changer 10 according to the present embodiment, the controlling unit 22 can switch between whether to specify the denomination by the dispensing money denomination specifying unit 24 before depositing money or to specify the denomination by the dispensing money denomination specifying unit 24 after depositing money. As a result, in comparison with the conventional money changer in which a timing for specifying the denomination of the money to be dispensed is fixed to either before or after the deposition of money, because it is possible to adapt to sudden changes in circumstances depending on the requirement of the customer without altering a program of the controlling device 20 of the money changer 10, the convenience of the operator is improved as this offers great flexibility.

When performing the money change process in the money changer 10, the operator can be allowed to select, by using the operation and displaying unit 40, whether to perform the ordinary money change process or the reverse money change process. In the ordinary money change process, a denomination of the dispensed money has a lower value than a denomination of the deposited money. In the reverse money change process, a denomination of the dispensed money has a higher value than a denomination of the deposited money. In this case, for each of the ordinary money change process and the reverse money change process selected as the type of the money change process by the operator by using the operation and displaying unit 40, the denomination specification timing setting unit 26 can perform the setting of whether to specify the denomination by the dispensing money denomination specifying unit 24 before depositing money or to specify the denomination by the dispensing money denomination specifying unit 24 after depositing money.

Moreover, as another variation of the money changer 10 according to the present embodiment, based on the type of the money change process (the ordinary money change process or the reverse money change process) selected by the operator by using the operation and displaying unit 40, the controlling unit 22 can automatically perform the setting of whether to specify the denomination by the dispensing money denomination specifying unit 24 before depositing money or to specify the denomination by the dispensing money denomination specifying unit 24 after depositing money. Specifically, for example, when the type of the money change process selected by the operator by using the operation and displaying unit 40 is the ordinary money change process, the controlling unit 22 provides a control to specify the denomination by the dispensing money denomination specifying unit 24 before depositing money. In contrast, when the type of the money change process selected by the operator by using the operation and displaying unit 40 is the reverse money change process, the controlling unit 22 provides a control to specify the denomination by the dispensing money denomination specifying unit 24 after depositing money. As an example of a situation in which the operator may select the ordinary money change process as the type of the money change process by using the operation and displaying unit 40, a situation in which the operator knows the amount of the money to be deposited or the denomination of the money to be dispensed can be considered. In this case, because the operator can earlier specify the denomination of the money to be dispensed, for example, the money changer 10 can automatically calculate the amount of money to be deposited so that the money change process can be simplify as the operator need not perform the calculation by himself. On the other hand, as an example of a situation in which the operator may select the reverse money change process as the type of the money change process by using the operation and displaying unit 40, a situation in which the operator would like to change a large number of coins owned by him into banknotes can be considered. In such an instance, the operator often does not know the total amount of the large number of coins owned by him. Therefore, before specifying the denomination of the banknotes to be dispensed, it may be desirable for the operator to deposit the large number of coins in the money changer 10 and ensure the total amount of the coins, and then specify the denomination of the banknotes that is appropriate to the total amount of the coins. Accordingly, by changing the timing of specifying the denomination of the money to be dispensed depending on whether it is the ordinary money change process or the reverse money change process, the convenience of the operator of the money changer 10 can be improved.

As another variation of the money changer 10 according to the present embodiment, while the money changer 10 is in a standby state, or when beginning the money change process, it may be allowable to accept both of an operation of depositing money and an operation of specifying a denomination by the dispensing money denomination specifying unit 24. In this case, when the operation of depositing money is accepted earlier, the controlling unit 22 performs the control of specifying the denomination by the dispensing money denomination specifying unit 24 after the money is deposited. On the other hand, when the operation of specifying a denomination of the money by the dispensing money denomination specifying unit 24 is accepted earlier, the controlling unit 22 performs the control of specifying the denomination by the dispensing money denomination specifying unit 24 before the money is deposited. In this manner, depending on whether it is the operation of depositing money or the operation of specifying a denomination of the money to be dispensed, because whether to specify the denomination by the dispensing money denomination specifying unit 24 before depositing money or to specify the denomination by the dispensing money denomination specifying unit 24 after depositing money can be changed automatically, the convenience of the operator is improved. Moreover, because it is not necessary to select the timing of specifying the denomination of the money to be dispensed, the money change processing steps performed by the operator can be reduced.

In the above embodiments, it is allowable to provide a dispensing money-number specifying unit that specifies, when changing the total amount of the deposited money into the money of the denomination specified by the dispensing money denomination specifying unit 24, the number of money to be dispensed as the changed money. Moreover, it is allowable to specify a plurality of denominations by the dispensing money denomination specifying unit 24, and for each of the denominations, specify the number of money to be dispensed by the dispensing money-number specifying unit.

When the denomination is not specified by the dispensing money denomination specifying unit 24, it is allowable to form a denomination combination that minimizes the number of money to be dispensed, or to dispense the money of a previously set denomination combination. In the money change process, when money is dispensed in the denomination combination that minimizes the number of money that should be dispensed, because the number of dispensed banknotes, coins, and rolls of coins can be minimized, effective use of the cash in the money changer 10 is enabled, and the convenience of the operator is improved.

Moreover, it is allowable to set the precedence of the denomination of the money to be dispensed when the denomination is not specified by the dispensing money denomination specifying unit 24. In this case, by increasing the priority of the denomination of money having less frequency of dispensing in the money change process in the money changer 10, the time before a money quantity in the money storing units in the money changer 10 that store therein the money to be dispensed per denomination becomes empty (empty state) or near empty can be lengthened, the cash in the money changer 10 can be managed effectively depending on the practical use, and the frequency of replenishing the money to the money changer 10 can be reduced.

As shown in FIG. 30, it is allowable to connect to the controlling unit 22 a customer information receiving unit 28 that receives customer information. Specifically, the customer information receiving unit 28 receives the customer information when the operator, who may be a customer and the like, who wants to perform the money change process in the money changer 10, inputs the customer information by using the operation and displaying unit 40 or when the ID card possessed by the operator is read by the card reader 42. When the customer information receiving unit 28 is provided, based on the customer information received by the customer information receiving unit 28, the controlling unit 22 can perform the setting of whether to specify the denomination by the dispensing money denomination specifying unit 24 before depositing money or to specify the denomination by the dispensing money denomination specifying unit 24 after depositing money. In this manner, because whether to specify the denomination by the dispensing money denomination specifying unit 24 before depositing money or to specify the denomination by the dispensing money denomination specifying unit 24 after depositing money can be changed automatically based on the customer information, the convenience of the operator is improved. Moreover, because it is not necessary to select the timing of specifying the denomination of the money to be dispensed, the money change processing steps performed by the operator can be reduced.

As another variation of the money changer 10 in the present embodiment, in the dispensing money denomination specifying unit 24, it is allowable to configure so that the denomination can be specified each of before depositing money and after having depositing the money. In this case, because it is possible to specify the denomination each of before depositing money and after having deposited the money, the convenience of the operator is improved as this offers great flexibility on the money changer 10.

In the money changer 10 according to the present embodiment, when performing the reverse money change process, when the denomination is not specified by the dispensing money denomination specifying unit 24, it is allowable to form a denomination combination that minimizes the number of money to be dispensed. Specifically, when performing the reverse money change process in the money changer 10, as shown in the flowchart of FIG. 31(b), money is deposited in the money changer 10 before specifying a denomination of the money to be dispensed. When money is deposited in the money changer 10, the total amount of money deposited in the coins and a denomination combination (specifically, a denomination and number that will minimize the number of money to be dispensed) of the money to be dispensed recommended by the money changer 10 are displayed on the operation and displaying unit 40. The money is dispensed in the above denomination combination from the money changer 10 when the operator operates an accept button on the operation and displaying unit 40. On the other hand, when the customer desires to specify the denomination of the money to be dispensed, the denomination of the money to be dispensed can be specified by the operation and displaying unit 40. According to the money changer 10, convenience in performing the reverse money change process can be improved.

In the money changer 10 according to the present embodiment, when a denomination of the money deposited in the money change process is a previously set denomination, it is allowable to perform management that makes it possible to return the deposited money outside of the body without performing the money change process. With this configuration, it can be prevented that the storing and feeding unit 270 of the loose-banknote depositing and dispensing device 200 soon becomes full when, for example, the banknotes of a denomination of a small amount are deposited in a large number in the money change process. Moreover, when a denomination of the money deposited in the money change process is a previously set denomination, it is allowable to limit the amount and the number of the money of that denomination to be deposited in the money change process. With this configuration, it can be prevented that the storing and feeding unit 270 of the loose-banknote depositing and dispensing device 200 soon becomes full when, for example, the banknotes of a denomination of a large amount are deposited in a large number in the money change process.

In the present invention, it is allowable that the money changer accepts deposition of valuable media, such as a check and a gift coupon, apart from the money. In this case, the money changer can be provided with a valuable media storing unit that stores therein the deposited valuable media. Moreover, the controlling unit 22 can switch between whether to specify the denomination by the dispensing money denomination specifying unit 24 before depositing the valuable media or to specify the denomination by the dispensing money denomination specifying unit 24 after depositing the valuable media.

### Configuration of Light Emitting Diode as State Notifying Unit

As shown in FIG. 1 and the like, as the state notifying unit, the light emitting diodes (LED) 90 and 92 are arranged in the left and right sides on the upper part of the upper door 14 arranged on the front surface of the outer housing 12 of the money changer 10. The state notifying unit notifies to the outside of a state in which the money changer 10 is among a plurality of preset states with a light display. More particularly, a combination of a light color and a light display pattern of at least one among light off, light on, and blinking is mapped with each of the preset states of the money changer 10. The light emitting diodes 90 and 92 as the state notifying unit display a state in which the money changer 10 is among the plurality of the preset states by displaying the light color and the light display pattern corresponding to that state. When the light display pattern is blinking, it is allowable to set a blinking rate.

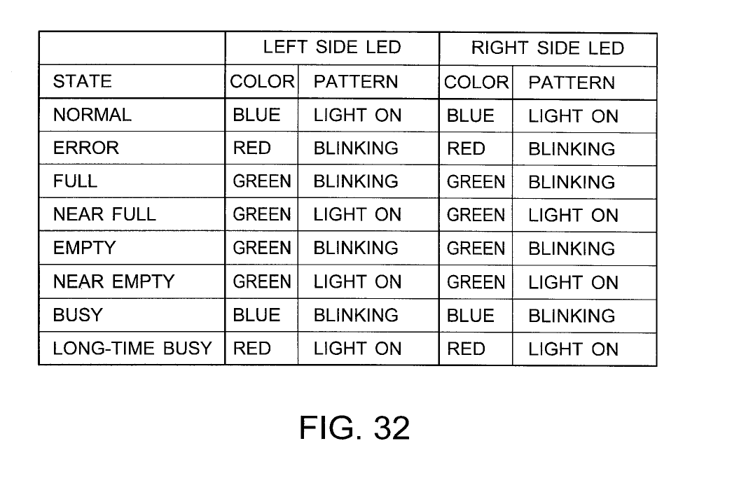

An example of the relation between the light colors and the light display patterns of the light emitting diodes 90 and 92 and the states of the money changer 10 is shown in a table shown in FIG. 32. As shown in FIG. 32, the following states can be exemplified as the states of the money changer 10: a normal state; an abnormal state (error); a full state in which a money quantity in a money storing unit that stores therein the money deposited in the money changer 10 according to the denomination, a money quantity in a money storing unit that stores therein overflow money of mixed denominations, and the like is full; a near full state in which a money quantity in a money storing unit is less by a predetermined quantity for the same for the full state; an empty state in which a money quantity in a money storing unit that stores therein the money to be dispensed from the money changer 10 according to the denomination is empty (nil state); a near empty state in which a money quantity in a money storing unit is more by a predetermined quantity for the same for the empty state; a busy state in which the money changer 10 is in use; and a long-time busy state in which the money changer 10 is in use for a longer time than a previously set time for completing one money change process in the money changer 10. Although not shown in the table shown in FIG. 32, the following states can also be exemplified as the states of the money changer 10: a state in which the money changer 10 is out of business because the current time is outside of the business hours, a state in which a counterfeit banknote or coin is included in the money deposited in the money change process, and the like. As shown in FIG. 32, a combination of the light color and the light display pattern of the light emitting diodes 90 and 92 are previously mapped with the various states of the money changer 10.

The various means for detecting the state of the money changer 10 are explained below. As shown in FIG. 30, as the means for detecting the state of the money changer 10, a full-state detecting unit 32, a near full-state detecting unit 34, an empty-state detecting unit 36, and a near empty-state detecting unit 38 are connected to the controlling unit 22. The full-state detecting unit 32 detects whether a money storing unit, such as the storing and feeding mechanism 150 or the storing and feeding unit 270, that stores therein the deposited money according to the denomination is in the full state, and whether a money storing unit that stores therein overflow money of mixed denominations is in the full state. The state of the money changer 10 that should be notified of by the light emitting diodes 90 and 92 as the state notifying unit includes the state in which at least one of the money storing units is detected to be in the full state by the full-state detecting unit 32. Moreover, the near full-state detecting unit 34 detects whether the money storing units are in the near full state in which the money quantity in each of the money storing units is less by the predetermined quantity for the same for the full state. The state of the money changer 10 that should be notified of by the light emitting diodes 90 and 92 as the state notifying unit includes a state in which at least one of the money storing units is detected to be in the near full state by the near full-state detecting unit 34.

The empty-state detecting unit 36 detects whether the money quantity of the money storing unit, such as the storing and feeding mechanism 150, the storing and feeding unit 270, the storing unit 310, and the like, that stores therein the money that should be dispensed according to a denomination is in the empty state. The state of the money changer 10 that should be notified of by the light emitting diodes 90 and 92 as the state notifying unit includes a state in which at least one of the money storing units is detected to be in the empty state by the empty-state detecting unit 36. Moreover, the near empty-state detecting unit 38 detects whether the money storing unit is in the near empty state in which the money quantity in the money storing unit is more by the predetermined quantity for the same for the empty state. The state of the money changer 10 that should be notified of by the light emitting diodes 90 and 92 as the state notifying unit includes a state in which at least one of the money storing units is detected to be in the near empty state by the near empty-state detecting unit 38.

In the money changer 10 having the above configuration, because the attendant and the like of the financial institution can watch from a place separated from the money changer 10 the light color and the light display pattern of the light emitting diodes 90 and 92 as the state notifying unit provided to the money changer 10, the state of the money changer 10 can be recognized easily, and it becomes possible to cope immediately when errors such as an abnormality occurs in the money changer 10.

In the present embodiment, when the full-state detecting unit 32 detects that the money storing unit that stores therein the deposited money according to the denomination is in the full state, when the empty-state detecting unit 36 detects the money quantity of the money storing unit that stores therein the money that should be dispensed according to the denomination is in the empty state, and the like, it is allowable to perform management so that one of the ordinary money change process and the reverse money change process cannot be performed in the money changer 10. With this configuration, because it is prevented that the money changer 10 stops completely, the convenience of the operator is improved, and the operation availability of the money changer 10 can be increased.

The present embodiment is not limited to a configuration in which a combination of the light color and the light display pattern of the light emitting diodes 90 and 92 are previously mapped with the various states of the money changer 10. As a variation of the present embodiment, it is allowable that only the light colors of the light emitting diodes 90 and 92 are mapped with the various states of the money changer 10, and the light emitting diodes 90 and 92 display a state in which the money changer 10 is among the plurality of the preset states by displaying only the light color corresponding to that state. As another variation of the present embodiment, it is allowable that only the light display patterns from among light off, light on, and blinking of the light emitting diodes 90 and 92 are mapped with the various states of the money changer 10, and the light emitting diodes 90 and 92 display a state in which the money changer 10 is among the plurality of the preset states by displaying only the light display pattern corresponding to that state.

As the state notifying unit that notifies the state of the money changer 10 to the outside, it is allowable to use a structure in which a plurality of light emitting diodes is arranged in a series. With this configuration, as a light display pattern emitted by the state notifying unit, in addition to light off, light on, and blinking, it is allowable to set a wavy blinking pattern in which a plurality of the light emitting diodes are turned on sequentially only for a predetermined time.

In the example shown in the table shown in FIG. 32, the light emitting diodes 90 and 92 arranged on both of the left and right sides of the money changer 10 have the same light colors and the same light display patterns; however, it is allowable to set different display forms for each of the light emitting diodes 90 and 92 arranged on both of the right and left sides of the money changer 10.

The light emitting diodes as the state notifying unit are not limited to the light emitting diodes that are arranged on the left and right sides on the upper part of the upper door 14 arranged on the front surface of the outer housing 12 of the money changer 10. As another example, as the state notifying unit, only one light emitting diode can be arranged in the upper part of the outer housing 12 of the money changer 10.

The state notifying unit can include, in addition to the light emitting diodes, a light emitting device other than a light emitting diode. Specifically, such a light emitting device can be, for example, a fluorescent light panel and the like. This light emitting device can be used to notify to the outside of a state in which the money changer 10 is among the plurality of the preset states by a light display. Alternatively, the state notifying unit can be a light emitting device other than a light emitting diode. This light emitting device can be used to notify to the outside of a state in which the money changer 10 is among the plurality of the preset states by a light display.

The state notifying unit can use sound in addition to using a light display to notify of a state in which the money changer 10 is among the plurality of the preset states.

One state notifying unit can be provided corresponding to each of the loose-coin depositing and dispensing device 100, the loose-banknote depositing and dispensing device 200, and the coin-roll ejecting device 300 of the money changer 10. Each of the state notifying units can be used to notify of a state in which the corresponding one of the devices 100, 200, 300 is among the plurality of the preset states by a light display.

### Management of Banknote Processing System and Coin Processing System of Money Changer

As explained above, the money changer 10 includes the outer housing 12 of a substantially cuboidal shape, and inside the outer housing 12 are provided, side-by-side in a lateral direction, the loose-coin depositing and dispensing device 100, the loose-banknote depositing and dispensing device 200, and the coin-roll ejecting device 300. The loose-banknote depositing and dispensing device 200 constitutes the banknote processing system 50 that performs the money deposition process and the money dispensing process of banknotes. Moreover, the loose-coin depositing and dispensing device 100 and the coin-roll ejecting device 300 constitute the coin processing system 60 that performs the money deposition process and the money dispensing process of coins. Furthermore, each of the loose-coin depositing and dispensing device 100, the loose-banknote depositing and dispensing device 200, and the coin-roll ejecting device 300 can be pulled horizontally and away from the outer housing 12 to remove them independently from the inside of the outer housing 12.

In the money changer 10 according to the present embodiment, even if one between the banknote processing system 50 and the coin processing system 60 does not exist, or even if one between the banknote processing system 50 and the coin processing system 60 does not function, it is possible to perform the money change process. More specifically, in the money changer 10 according to the present embodiment, even if one between the banknote processing system 50 and the coin processing system 60 does not exist, or even if one between the banknote processing system 50 and the coin processing system 60 does not function, it is possible to perform the ordinary money change process or the reverse money change process. In the ordinary money change process, a denomination of the dispensed money has a lower value than a denomination of the deposited money. In the reverse money change process, a denomination of the dispensed money has a higher value than a denomination of the deposited money.

“One between the banknote processing system 50 and the coin processing system 60 does not exist” refers to a state in which the banknote processing system 50 or the coin processing system 60 is not accommodated in the outer housing 12. “One between the banknote processing system 50 and the coin processing system 60 does not function” refers to a state in which the banknote processing system 50 and the coin processing system 60 are accommodated in the outer housing 12 but one of them is not working. In the above states, to prevent an operator from depositing money by mistake, it is desirable to close a depositing opening or a dispensing opening, or both of the depositing opening and the dispensing opening, by using respective covers so that they do not function. Moreover, as shown in FIG. 30, the controlling device 20 of the money changer 10 is provided with a system operation setting unit 30 that can set per system whether to operate the banknote processing system 50 and the coin processing system 60. When the banknote processing system 50 and the coin processing system 60 are accommodated in the outer housing 12 of the money changer 10, the banknote processing system 50 and/or the coin processing system 60 can be caused not to function depending on the setting of not operating (in other words, degraded operation setting) made by the system operation setting unit 30.

According to the money changer 10 having such a configuration, at the time of installing the money changer 10 (i.e., setting the money changer 10 in the lobby of the financial institution and the like), it is possible to accommodate in the outer housing 12 only a minimum number of systems between the banknote processing system 50 and the coin processing system 60, and to allow only a minimum number of systems to function. Moreover, depending on the requirement of the financial institution and the like in which the money changer 10 has been installed, it is possible to add other system or cause the existing system to function. With this configuration, the management that improves the convenience of the money changer 10 can be performed, and the initial costs and the like at the time of installing the money changer 10 can be reduced.

The money changer 10 in which, even if one between the banknote processing system 50 and the coin processing system 60 does not exist, or even if one between the banknote processing system 50 and the coin processing system 60 does not function, it is possible to perform the money change process is explained above; however, the present embodiment is not limited to this money changer 10. As a variation of the money changer 10 according to the present embodiment, even if one between the loose-coin depositing and dispensing device 100, the loose-banknote depositing and dispensing device 200, and the coin-roll ejecting device 300 does not exist, or even if one between the loose-coin depositing and dispensing device 100, the loose-banknote depositing and dispensing device 200, and the coin-roll ejecting device 300 does not function, it is allowable to configure so that a money change process can be performed. Furthermore, even if one between the loose-coin depositing and dispensing device 100 and the loose-banknote depositing and dispensing device 200 does not exist, or even if one between the loose-coin depositing and dispensing device 100 and the loose-banknote depositing and dispensing device 200 does not function, it is allowable to configure so that a money change process can be performed.

In doing so, at the time of installing and the like of the money changer 10, it is particularly preferable that the loose-coin depositing and dispensing device 100 and the loose-banknote depositing and dispensing device 200 among the three devices 100, 200, 300 are accommodated in the outer housing 12 and that the loose-coin depositing and dispensing device 100 and the loose-banknote depositing and dispensing device 200 are functioning, or the loose-banknote depositing and dispensing device 200 and the coin-roll ejecting device 300 among the three devices 100, 200, 300 are accommodated in the outer housing 12 and that the loose-banknote depositing and dispensing device 200 and the coin-roll ejecting device 300 are functioning. In other words, it is preferable that the loose-banknote depositing and dispensing device 200 that constitutes the banknote processing system 50 is always accommodated in the outer housing 12 and that the banknote processing system 50 is functioning. In this case, it is possible to remove the loose-coin depositing and dispensing device 100 or the coin-roll ejecting device 300 from the outer housing 12 or to cause them not to function. Moreover, in this case, the money change process can be performed between banknotes and coins in the money changer 10. That is, even if the loose-coin depositing and dispensing device 100 does not exist or does not function in the money changer 10, but if the coin-roll ejecting device 300 exists and functions, a money change process in which loose banknotes are deposited in the loose-banknote depositing and dispensing device 200 and a roll of coins having a different denomination but the same total amount as the deposited loose banknotes is dispensed from the coin-roll ejecting device 300 can be performed. Moreover, even if the coin-roll ejecting device 300 does not exist or does not function, but if the loose-coin depositing and dispensing device 100 exists and functions, a money change process in which loose banknotes are deposited in the loose-banknote depositing and dispensing device 200 and loose coins having a different denomination but the same total amount as the deposited loose banknotes are dispensed from the loose-coin depositing and dispensing device 100, or a money change process in which loose coins are deposited in the loose-coin depositing and dispensing device 100 and loose banknotes having a different denomination but the same total amount as the deposited loose coins are dispensed from the loose-banknote depositing and dispensing device 200 can be performed.

In the money changer 10, it is allowable to configure so that the loose-coin depositing and dispensing device 100 performs only the money dispensing process of the loose coins, and the loose-banknote depositing and dispensing device 200 performs only the money deposition process of the loose banknotes. Even in this case, at least a money change process in which loose banknotes are deposited in the loose-banknote depositing and dispensing device 200 and loose coins or a roll of coins having a different denomination but the same total amount as the deposited loose banknotes are dispensed from the loose-coin depositing and dispensing device 100 or the coin-roll ejecting device 300 can be performed.

As a variation of the money changer 10, it is possible to configure so that the money change process can be performed even if the loose-banknote depositing and dispensing device 200 does not exist, or the loose-banknote depositing and dispensing device 200 does not function. That is, even if the loose-banknote depositing and dispensing device 200 does not exist or does not function, but if the coin-roll ejecting device 300 exists and functions, a money change process in which loose coins are deposited in the loose-coin depositing and dispensing device 100 and a roll of coins having a different denomination but the same total amount as the deposited loose coins is dispensed from the coin-roll ejecting device 300 can be performed.

In the money changer 10 it is allowable to configure so that the loose-coin depositing and dispensing device 100 performs only the money deposition process of the loose coins, and the loose-banknote depositing and dispensing device 200 performs only the money dispensing process of the loose banknotes. Even in this case, at least a money change process in which loose coins are deposited in the loose-coin depositing and dispensing device 100 and loose banknotes or a roll of coins having a different denomination but the same total amount as the deposited loose coins are dispensed from the loose-banknote depositing and dispensing device 200 or the coin-roll ejecting device 300 can be performed.

At the time of installing and the like of the money changer 10, it is possible to configure so that only the loose-banknote depositing and dispensing device 200 among the three devices 100, 200, 300 is accommodated in the outer housing 12 and that the loose-banknote depositing and dispensing device 200 is functioning, and to remove the loose-coin depositing and dispensing device 100 and the coin-roll ejecting device 300 from the outer housing 12 or to cause them not to function. Even in this money changer 10, it is possible to perform the money change process between the banknotes by the loose-banknote depositing and dispensing device 200. Moreover, in this case, depending on the requirement of the financial institution and the like in which the money changer 10 has been installed, it is possible to add the loose-coin depositing and dispensing device 100 or the coin-roll ejecting device 300 or to cause them to function. Furthermore, at the time of installing and the like of the money changer 10, it is possible to configure so that only the loose-coin depositing and dispensing device 100 among the three devices 100, 200, 300 is accommodated in the outer housing 12 and that the loose-coin depositing and dispensing device 100 is functioning, and to remove the loose-banknote depositing and dispensing device 200 and the coin-roll ejecting device 300 from the outer housing 12 or to cause them not to function. Even in this money changer 10, it is possible to perform the money change process between the coins by the loose-coin depositing and dispensing device 100. Moreover, in this case, depending on the requirement of the financial institution and the like in which the money changer 10 has been installed, it is possible to add the loose-banknote depositing and dispensing device 200 or the coin-roll ejecting device 300 or to cause them to function.

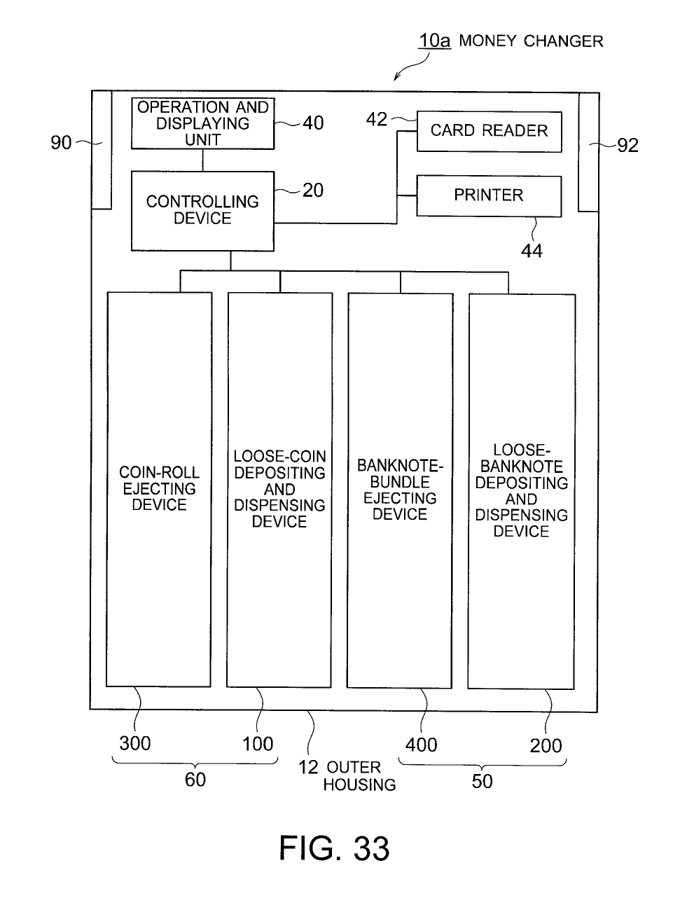

As another variation, as shown in FIG. 33, a money changer 10a can include a banknote-bundle ejecting device 400 in addition to the loose-coin depositing and dispensing device 100, the loose-banknote depositing and dispensing device 200, and the coin-roll ejecting device 300. The banknote-bundle ejecting device 400 ejects a banknote bundle that is obtained by bundling a predetermined number of banknotes (e.g., 100 pieces) with a tape. In this case, the loose-coin depositing and dispensing device 100, the loose-banknote depositing and dispensing device 200, the coin-roll ejecting device 300, and the banknote-bundle ejecting device 400 can be provided side-by-side in a lateral direction in the outer housing 12. Moreover, in the money changer 10a shown in FIG. 33, the banknote processing system 50 is constituted by the loose-banknote depositing and dispensing device 200 and the banknote-bundle ejecting device 400.

Even in the money changer 10a shown in FIG. 33, in the same manner as in the money changer 10 shown in FIG. 3, even if one between the banknote processing system 50 and the coin processing system 60 does not exist, or even if one between the banknote processing system 50 and the coin processing system 60 does not function, it is possible to perform the ordinary money change process or the reverse money change process.

Alternatively, in the money changer 10a shown in FIG. 33, even if one or more devices among the loose-coin depositing and dispensing device 100, the loose-banknote depositing and dispensing device 200, the coin-roll ejecting device 300, and the banknote-bundle ejecting device 400 does not exist, or even if one or more devices among the loose-coin depositing and dispensing device 100, the loose-banknote depositing and dispensing device 200, the coin-roll ejecting device 300, and the banknote-bundle ejecting device 400 does not function, it is allowable to configure so that a money change process can be performed. First, at the time of installing and the like of the money changer 10a shown in FIG. 33, a money change process similar to that performed by the money changer 10 shown in FIG. 3 can be performed when the banknote-bundle ejecting device 400 does not exist or when the banknote-bundle ejecting device 400 is not functioning. Moreover, in addition to the banknote-bundle ejecting device 400, even if one or more devices among the loose-coin depositing and dispensing device 100, the loose-banknote depositing and dispensing device 200, and the coin-roll ejecting device 300 does not exist, or even if one or more devices among the loose-coin depositing and dispensing device 100, the loose-banknote depositing and dispensing device 200, and the coin-roll ejecting device 300 does not function, a money change process can be performed as already explained above.

At the time of installing and the like of the money changer 10a shown in FIG. 33, even if the loose-banknote depositing and dispensing device 200 does not exist or the loose-banknote depositing and dispensing device 200 is not functioning, a money change process can be performed in the money changer 10a. That is, in the money changer 10a, even if the loose-banknote depositing and dispensing device 200 does not exist or does not function, because the banknote-bundle ejecting device 400 exists and functions, a money change process in which loose coins are deposited in the loose-coin depositing and dispensing device 100 and a roll of coins or a banknote bundle having a different denomination but the same total amount as the deposited loose coins is dispensed from the coin-roll ejecting device 300 or the banknote-bundle ejecting device 400 can be performed.

As a variation of the money changer 10a, it is possible to configure so that even if the loose-coin depositing and dispensing device 100 does not exist or the loose-coin depositing and dispensing device 100 is not functioning, a money change process can be performed in the money changer 10a. That is, in the money changer 10a, even if the loose-coin depositing and dispensing device 100 does not exist or does not function, a money change process in which loose banknotes are deposited in the loose-banknote depositing and dispensing device 200 and a roll of coins or a banknote bundle having a different denomination but the same total amount as the deposited loose banknotes are dispensed from the coin-roll ejecting device 300 or the banknote-bundle ejecting device 400 can be performed.

As a variation of the money changer 10a, it is possible to configure so that even if the coin-roll ejecting device 300 does not exist or the coin-roll ejecting device 300 is not functioning, a money change process can be performed in the money changer 10a. That is, in the money changer 10a, even if the coin-roll ejecting device 300 does not exist or does not function, a money change process in which loose coins or loose banknotes are deposited in the loose-coin depositing and dispensing device 100 or the loose-banknote depositing and dispensing device 200 and a banknote bundle having a different denomination but the same total amount as the deposited loose coins or loose banknotes is dispensed from the banknote-bundle ejecting device 400 can be performed.

As a variation of the money changer 10a, it is possible to configure so that even if the loose-coin depositing and dispensing device 100 and the coin-roll ejecting device 300 do not exist or the loose-coin depositing and dispensing device 100 and the coin-roll ejecting device 300 are not functioning, a money change process can be performed in the money changer 10a. That is, in the money changer 10a, even if the loose-coin depositing and dispensing device 100 and the coin-roll ejecting device 300 do not exist or do not function, a money change process in which loose banknotes are deposited in the loose-banknote depositing and dispensing device 200 and a banknote bundle having a different denomination but the same total amount as the deposited loose banknotes is dispensed from the banknote-bundle ejecting device 400 can be performed.

As a variation of the money changer 10a, it is possible to configure so that even if the loose-banknote depositing and dispensing device 200 and the coin-roll ejecting device 300 do not exist or the loose-banknote depositing and dispensing device 200 and the coin-roll ejecting device 300 are not functioning, a money change process can be performed in the money changer 10a. That is, in the money changer 10a, even if the loose-banknote depositing and dispensing device 200 and the coin-roll ejecting device 300 do not exist or do not function, a money change process in which loose coins are deposited in the loose-coin depositing and dispensing device 100 and a banknote bundle having a different denomination but the same total amount as the deposited loose coins is dispensed from the banknote-bundle ejecting device 400 can be performed.

In the money changer 10a, it is possible to configure so that the loose-coin depositing and dispensing device 100 can perform only one of the money deposition process and the money dispensing process with respect to the loose coins, or to configure so that the loose-banknote depositing and dispensing device 200 can perform only one of the money deposition process and the money dispensing process with respect to the loose banknotes. Even in this case, for example, a money change process in which loose banknotes are deposited in the loose-banknote depositing and dispensing device 200 and loose coins or a banknote bundle having a different denomination but the same total amount as the deposited loose banknotes are dispensed from the loose-coin depositing and dispensing device 100 or the banknote-bundle ejecting device 400 can be performed.

In the above explanation, with respect to the money changer 10 provided with three devices of the loose-coin depositing and dispensing device 100, the loose-banknote depositing and dispensing device 200, and the coin-roll ejecting device 300, or with respect to the money changer 10a provided with four devices of the loose-coin depositing and dispensing device 100, the loose-banknote depositing and dispensing device 200, the coin-roll ejecting device 300, and the banknote-bundle ejecting device 400, various variations in which a money change process can be performed even if one of the processing systems 50 and 60 or some of the devices 100, 200, 300, and 400 do not exist or do not function are explained. However, these variations are only exemplary. That is, in the present embodiment, various variations of the money changer that incorporate the configuration of the money changer described in the claim of the present patent application can be used.

What is claimed is:

1. A coin-roll ejecting device comprising:
a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction;
a first detecting unit that detects the roll of coins ejected from the storing unit; and
a controlling unit that controls the ejecting mechanism, wherein
the ejecting mechanism includes
a rotating member that rotates around a rotation axis that extends horizontally and orthogonally to the direction of inclination of the storing unit and has at least two notches each receiving one roll of coins stored in the storing unit,
a driving unit that rotates the rotating member around the rotation axis, and
a rotating position detecting unit that detects a rotating position of the rotating member.

2. The coin-roll ejecting device according to claim 1, wherein the rotating member includes at least three notches.

3. The coin-roll ejecting device according to claim 1, wherein
in the ejecting mechanism, the driving unit is capable of rotating the rotating member in both of a forward direction and a reverse direction, the forward direction being a direction in which the rotating member ejects the roll of coins from the storing unit, and the reverse direction being the reverse of the forward direction, and
the controlling unit controls a direction of rotation of the rotating member based on the rotating position of the rotating member detected by the rotating position detecting unit and detection information obtained in the first detecting unit.

4. The coin-roll ejecting device according to claim 3, wherein
the controlling unit rotates the rotating member in the reverse direction, when the first detecting unit detects that the rolls of coins of a predetermined number are ejected by the rotating member and when the rotating position detecting unit detects that the rotating member is positioned in a first predetermined position during ejecting the roll of coins from the storing unit by the ejecting mechanism in such a manner that the rotating member is rotated in the forward direction, and
the controlling unit stops the rotation of the rotating member when the rotating position detecting unit detects that the rotating member is positioned in a second predetermined position.

5. The coin-roll ejecting device according to claim 4, wherein
the controlling unit rotates the rotating member in the reverse direction, when the rotating position detecting unit does not detect that the rotating member is positioned in the first predetermined position for a predetermined time during ejecting the roll of coins from the storing unit by the ejecting mechanism in such a manner that the rotating member is rotated in the forward direction, and
the controlling unit stops the rotation of the rotating member when the rotating position detecting unit detects that the rotating member is positioned in a second predetermined position.

6. The coin-roll ejecting device according to claim 1, further comprising a second detecting unit that detects whether a roll of coins is received in the notch of the rotating member in the ejecting mechanism.

7. The coin-roll ejecting device according to claim 1, wherein a shape and a position of each of the notches on the rotating member are set such that, when one of the notches of the rotating member is positioned at an ejecting position of the rotating position, which is a position at which the rotating member is ready to eject the roll of coins, other leading notch of this notch is positioned at a position at which it is not able to receive the roll of coins from the storing unit.

8. The coin-roll ejecting device according to claim 1, wherein the driving unit is capable of changing a rotating speed of the rotating member.

9. The coin-roll ejecting device according to claim 8, wherein
the controlling unit judges, based on the rotating position of the rotating member detected by the rotating position detecting unit and the detection information obtained in the first detecting unit, whether an ejection defect that the roll of coins are not able to be ejected normally from the storing unit has occurred, and
the controlling unit causes the driving unit to adjust the rotating speed of the rotating member to reduce the rotating speed of the rotating member, when the number of times of ejection defect exceeds a predetermined number in one of:
a predetermined time;
predetermined ejection cycles; and,
a predetermined ejection number.

10. The coin-roll ejecting device according to claim 1, wherein a gate member is arranged above the rotating member to prevent a situation where the roll of coins stored in the storing unit does not enter into the notches of the rotating member whereby the roll of coins is ejected from above the rotating member.

11. The coin-roll ejecting device according to claim 10, wherein the gate member is freely movable so as to unevenly push and move the rolls of coins stored in the storing unit along the longitudinal direction of the roll of coins.

12. The coin-roll ejecting device according to claim 1, wherein the storing unit includes a pair of side walls that constitutes a storing area for the rolls of coins, and at least one of the pair of the side walls constitutes a door that is opened when replenishing the rolls of coins in the storing unit or taking out the rolls of coins from the storing unit.

13. The coin-roll ejecting device according to claim 12, wherein the side wall that constitutes the door has a configuration that allows an operator to see inside the storing unit.

14. The coin-roll ejecting device according to claim 12, wherein
a storing area width adjusting member that allows adjusting a width of the storing area of the storing unit is detachably attached to at least one of the pair of the side walls,
several types of the storing area width adjusting members are prepared corresponding to a longitudinal length of the roll of coins, and
the width of the storing area of the storing unit is adjustable by attaching an appropriate one of the storing area width adjusting members to the side wall.

15. The coin-roll ejecting device according to claim 1, wherein
several types of the rotating members having the notches of various shapes are prepared corresponding to diameters of the rolls of coins, and
the rotating member is changed depending on a diameter of the rolls of coins that are to be stored in that storing unit.

16. A coin-roll ejecting device comprising:
a storing unit having a bottom surface that is inclined with respect to a horizontal plane to store thereon a plurality of rolls of coins in a piled-up manner and along a rolling direction parallel to the inclined bottom surface, the storing unit having an ejecting mechanism that ejects the rolls of coins one by one from near the bottom surface that is at a lower level with respect to a vertical direction; and
a lifting unit that includes a coin-roll accommodating member that accommodates the roll of coins ejected by the ejecting mechanism from the storing unit and that is movable in the vertical direction.

17. A money changer for performing a money change process comprising:
a dispensing money denomination specifying unit that specifies a denomination of money to be dispensed; and
a controlling unit that switches between whether to specify the denomination by the dispensing money denomination specifying unit before depositing the money or to specify the denomination by the dispensing money denomination specifying unit after depositing the money.
